(19) United States
(12) Patent Application Publication
(10) Pub. No.: US 2014/0327759 A1
(43) Pub. Date: Nov. 6, 2014

(54) Image Processing, Frequency Estimation, Mechanical Control and Illumination for an Automatic IV Monitoring and Controlling system

(71) Applicant: Kai Tao, Yizheng (CN)

(72) Inventor: Kai Tao, Yizheng (CN)

(21) Appl. No.: 13/356,632

(22) Filed: Jan. 23, 2012

(51) Int. Cl. H04N 7/18

(52) U.S. Cl. CPC H04N 7/188
USPC 348/135

(57) ABSTRACT

This invention covers all aspects of an automatic IV monitoring and controlling system. It expands and completes the inventor's three earlier applications: U.S. application Ser. Nos. 12/825,368, 12/804,163 and 13/019,698. The monitoring is done by video/image processing. We give details on enhancing and processing the image. Frequency estimation can be done by a variety of techniques and we covered each class by giving at least one example. Then we discussed the mechanical system for speed control in detail covering topics such as actuator, motion guide and tube presser/supporter. In the last we discussed ways of illumination so that clear image can be obtained. A variety of techniques are given but most can be subsumed into the two principles discussed in §4.2.

### CROSS-REFERENCE TO RELATED APPLICATIONS

Application Ser. No. 12/825,368: IV Monitoring by Digital Image Processing, by the same inventor

Application Ser. No. 12/804,163: IV Monitoring by Video and Image Processing, by the same inventor

Application Ser. No. 13/019,698: Electromechanical system for IV control, by the same inventor

### FEDERALLY SPONSORED RESEARCH

Not Applicable

### THE NAMES OF THE PARTIES TO A JOINT RESEARCH AGREEMENT

Not Applicable

### SEQUENCE LISTING OR PROGRAM

Not Applicable

### BACKGROUND

1. Field of Intention

This invention relates to an IV monitoring and control system whose monitoring is done by video and image processing, whose dripping speed is measured using frequency estimation techniques, whose dripping rate is controlled using mechanical component and whose illumination is done with optical components.

2. Prior Art

First, infusion pumps are widely used as an automatic IV controlling device. Most infusion pumps does not monitor IV speed but controls the speed using mechanical devices, most commonly peristaltic pump.

Second, there are also many attempts to monitor IV speed via optical (most commonly infrared or other sensors), image processing or other ways.

| | Issued | Title | Description |
|---|---|---|---|
| U.S. Pat. No. | May 10, | Intravenous Drip | Combination of a diode and phototransistor to |
| 4,383,252 | 1983 | Feed Monitor | detect drips |
| U.S. Pat. No. | May 18, | Method and | Infrared or other types of emitter and a sensor |
| 6,736,801 | 2004 | Apparatus for | combined to count the drips |
| | | Monitoring | |
| | | Intravenous Drips | |
| U.S. Pat. No. | Jul. 19, | Drip detecting | This patent does use an image capturing device |
| 5,331,309 | 1994 | device and drip | to detect drip, but there are no processing steps. |
| | | alarming device and | There are “electronic eye” IV monitoring |
| | | drip rate control | devices in the market looks very like |
| | | device | embodiments of this patent. |
| U.S. Pat. No. | Dec. 31, | Method for liquid | This patent uses image capturing device and |
| 5,588,963 | 1996 | flow measuring and | purports to have used image processing |
| | | apparatus to | techniques, but no steps are actually given. In |
| | | practice this method | addition, it requires knowing the density of the |
| | | | liquid to transform from drip of liquid volume |
| | | | into liquid mass. |
| U.S. Pat. No. | Dec.12, | Infusion delivery | Use both image system and infrared to count |
| 6,159,186 | 2000 | system | drips, as well as a controlling system. The |
| | | | description is brief and contains no detail on |
| | | | how images are processed. |

### SUMMARY

We describe the further methods and apparatus in this disclosure:

Image processing techniques to process the video/image for extracting periodic measurement of the IV dripping process, disclosed methods include:
1. Image enhancement techniques, which further includes gray-level transformation, frequency-domain processing and wavelet techniques.
2. Thresholding techniques, which further includes iterative method, arbitrary/constant or manually assigned/determined threshold level, and mean/median or other simple thresholding method.

Frequency estimation would estimate dripping frequency from periodic signal extracted from image sequence, disclosed methods include:
1. Non-parametric methods, which further includes naïve time-domain methods, time-domain statistical methods, Fourier and Fourier-related methods, and wavelet transform.
2. Parametric methods, which further includes auto-regressive or auto-regressive mean-average spectrum estimation methods and eigenvector/subspace methods.

Mechanical system controls the dripping speed by pressing the tube. Apparatus include tube presser and supporter, use of leadscrew, use of lever, use of linear motion guide, rotational presser and cam embodiment.

Illumination system ensures the quality of captured video/image(s). Principles, methods and apparatus include principles of reflection/brightness contrast reduction, multiple light sources, multiple sources from secondary light source, light source from mirror reflection, magnified light source from lens, use reflective surface of any level of smoothness, avoid shooting the reflection/brightness contrast and the use of light director/blocker.

Please refer to each method/apparatus' respective section for discussion.

### DRAWINGS

### Figures

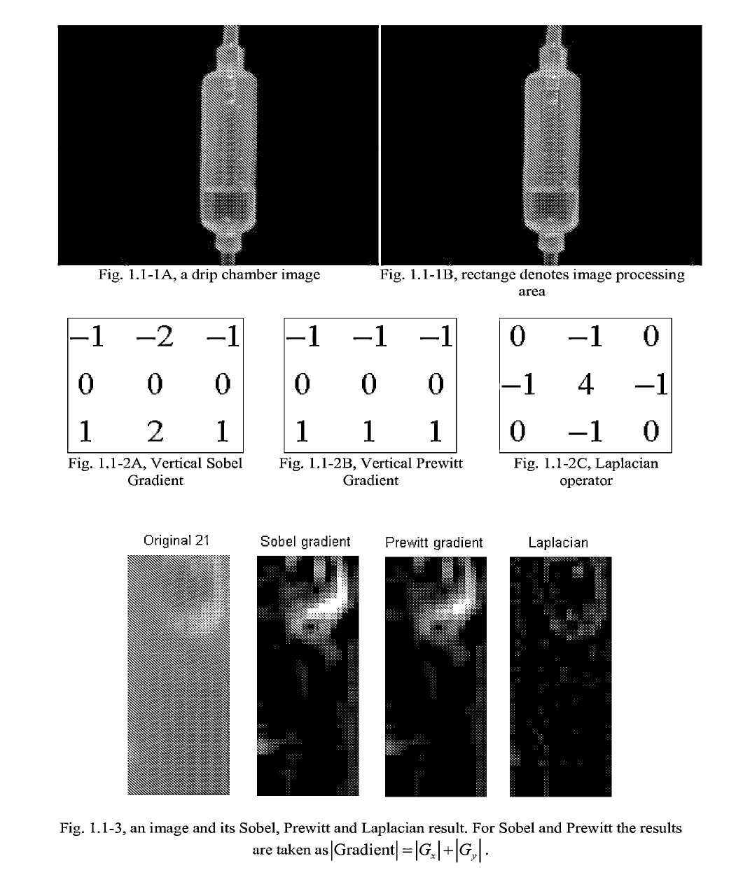

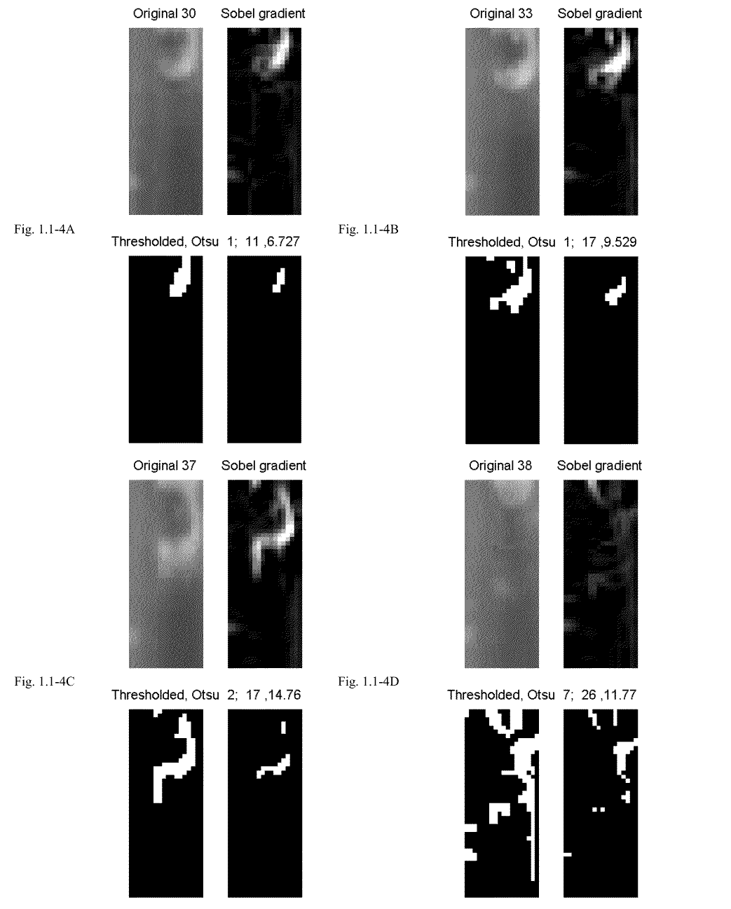

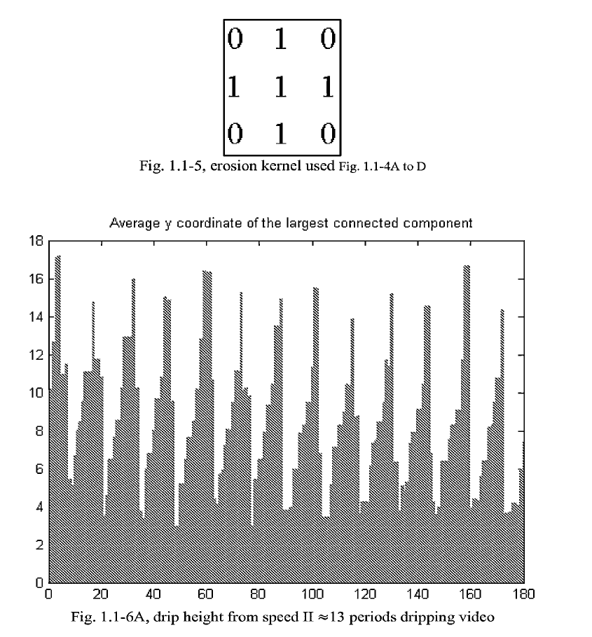

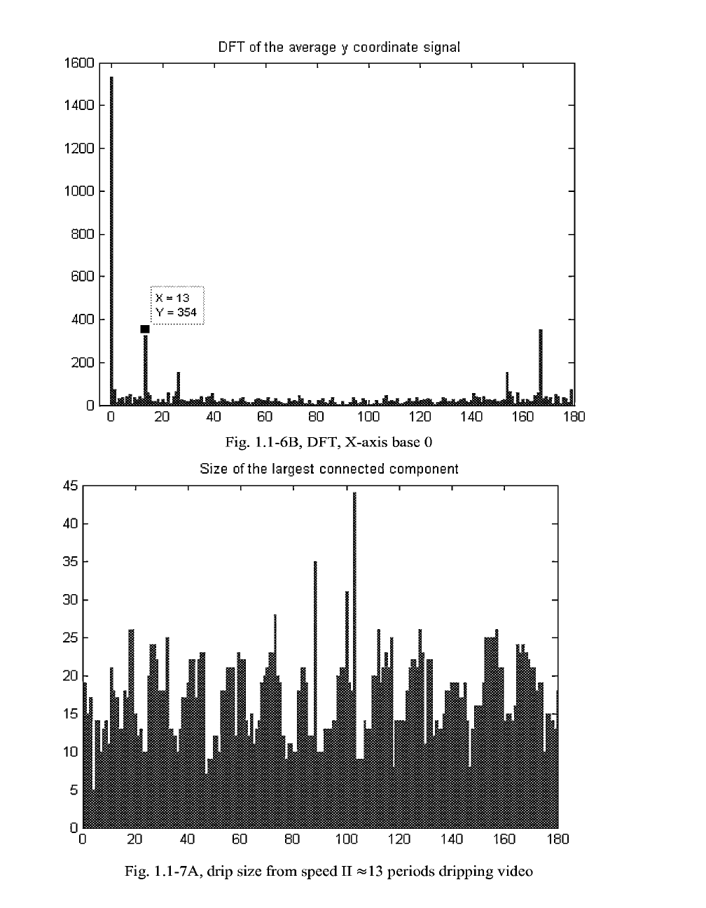

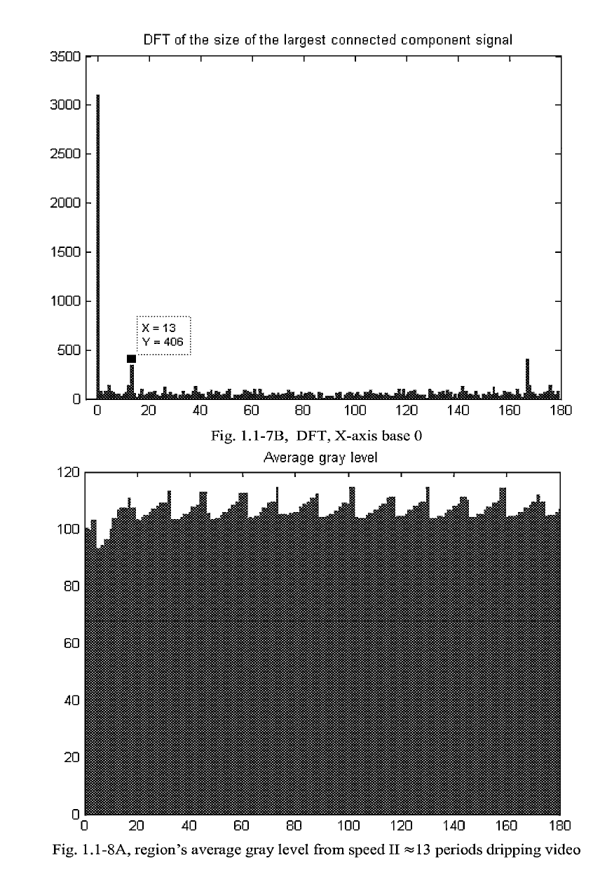

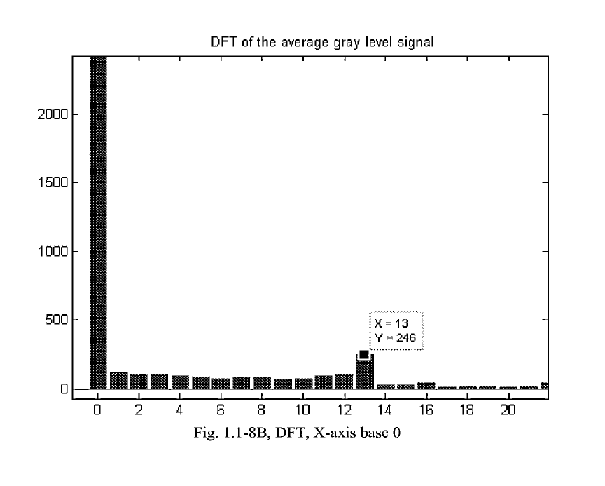

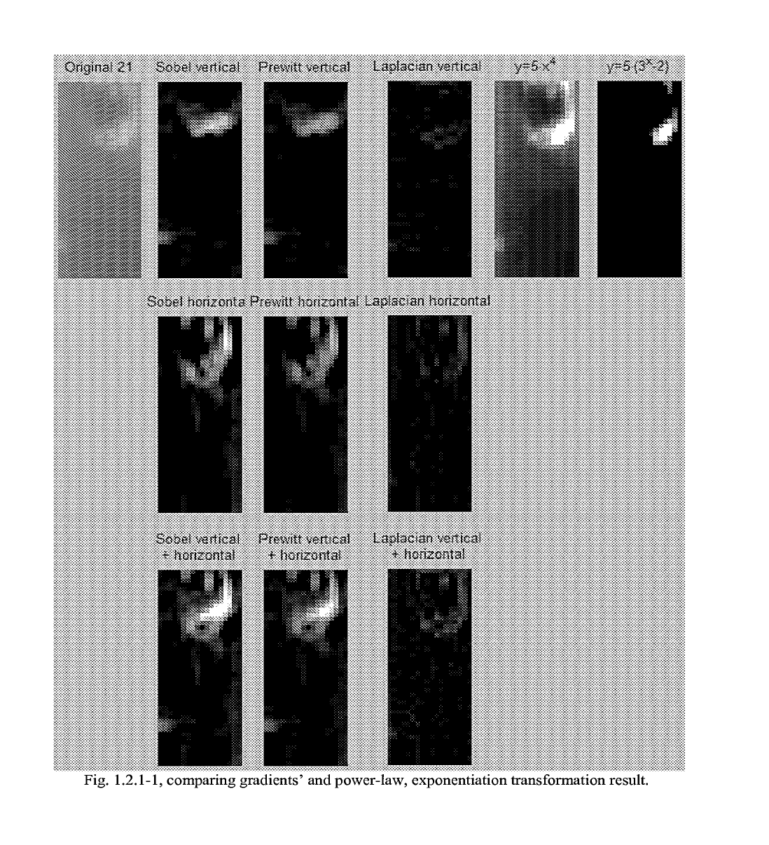

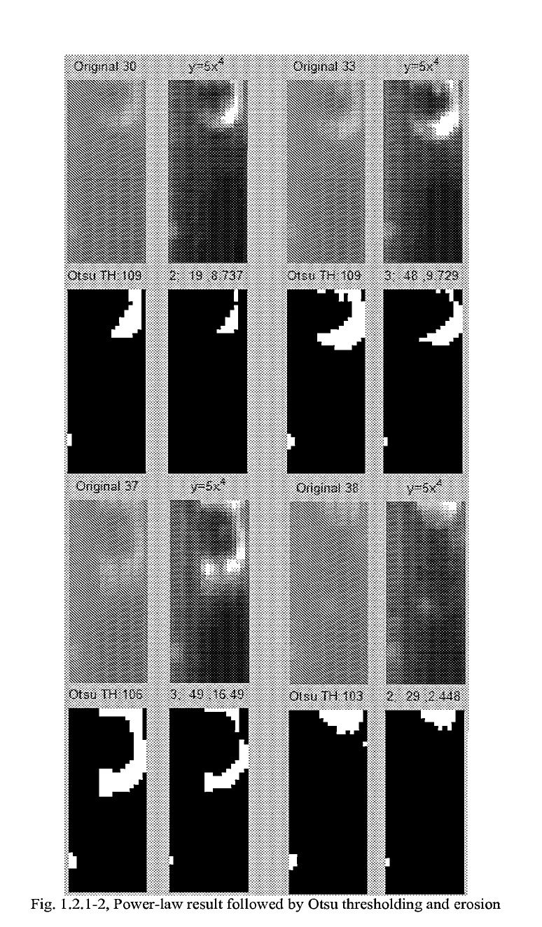

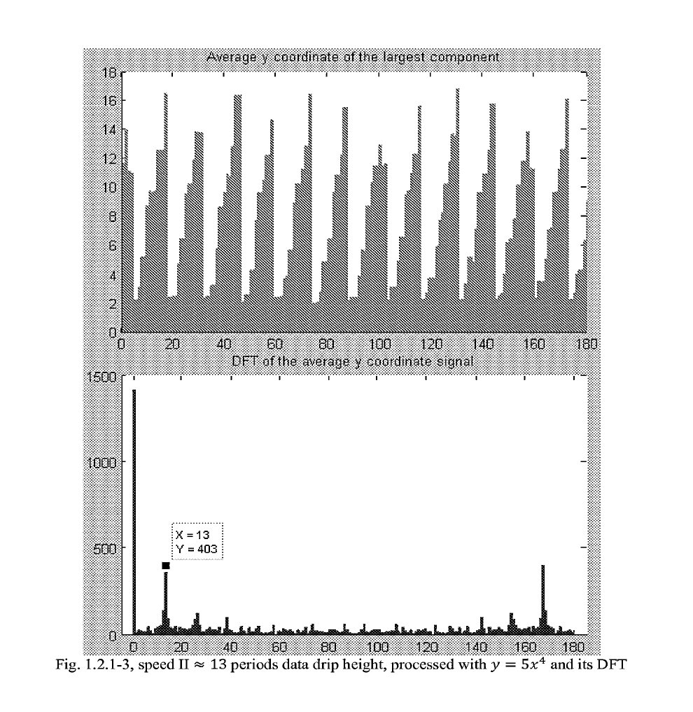

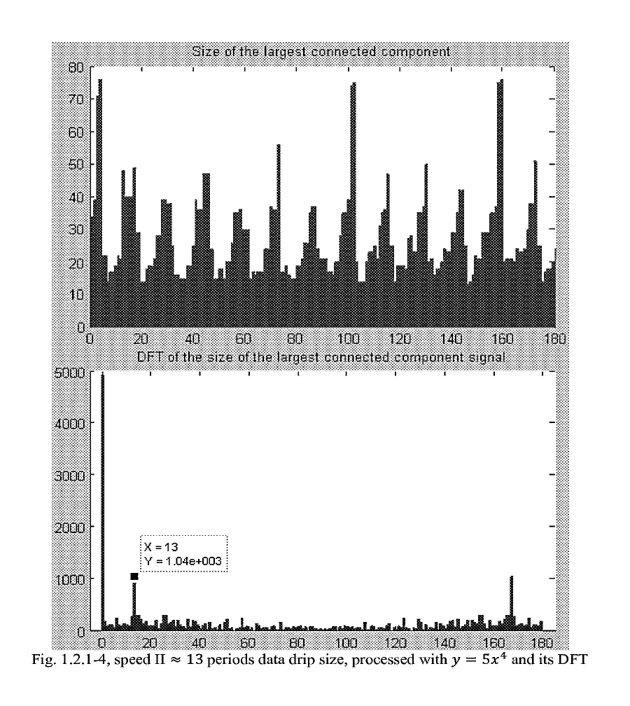

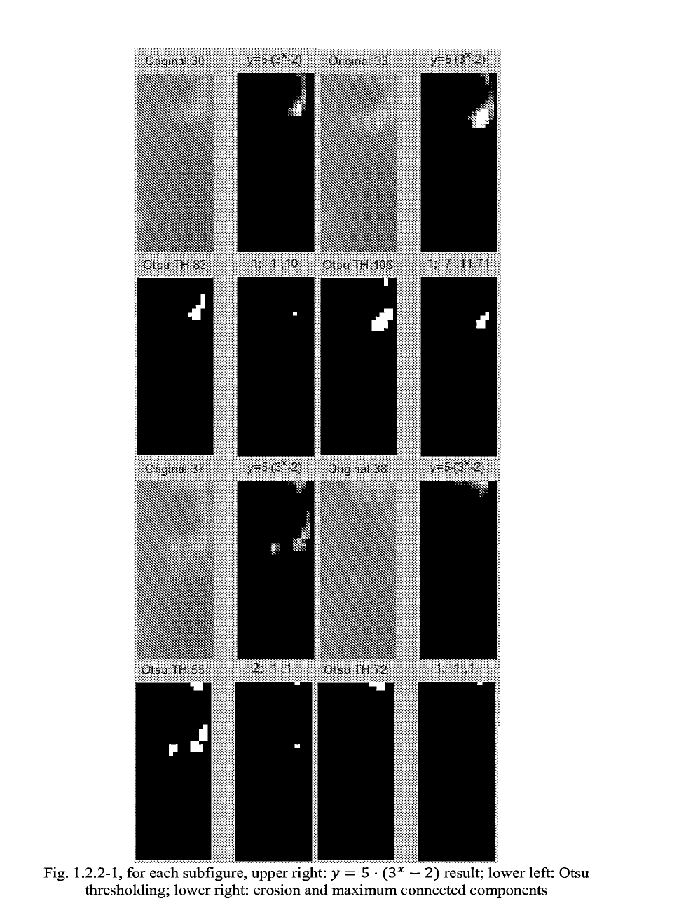

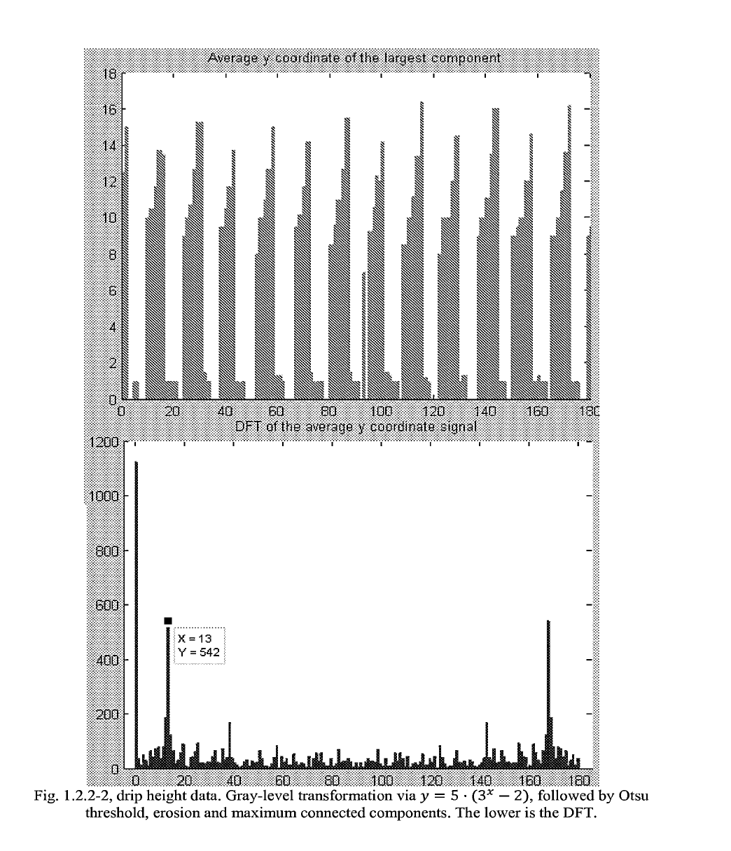

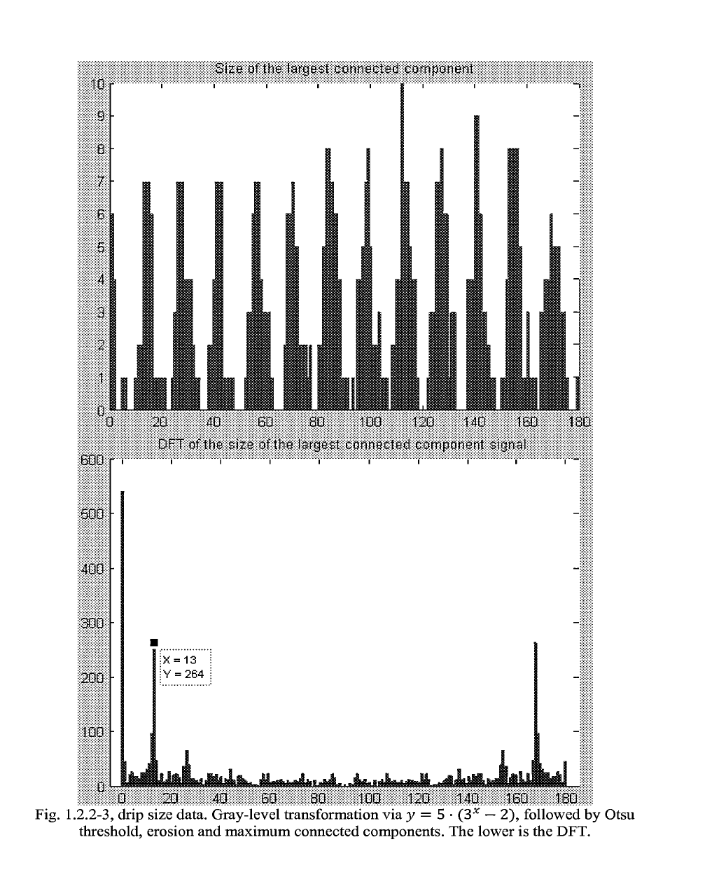

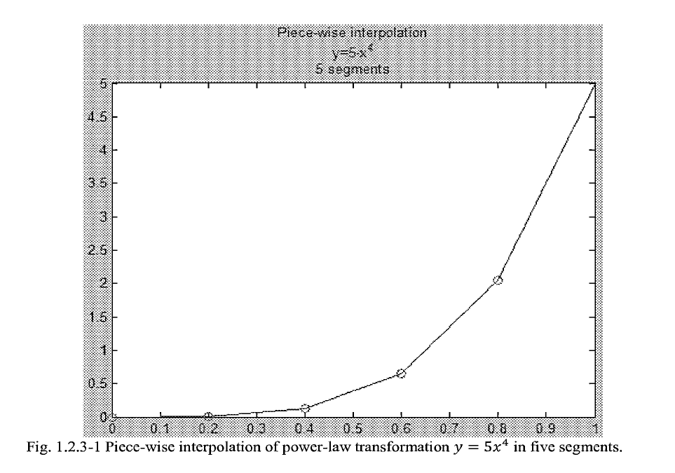

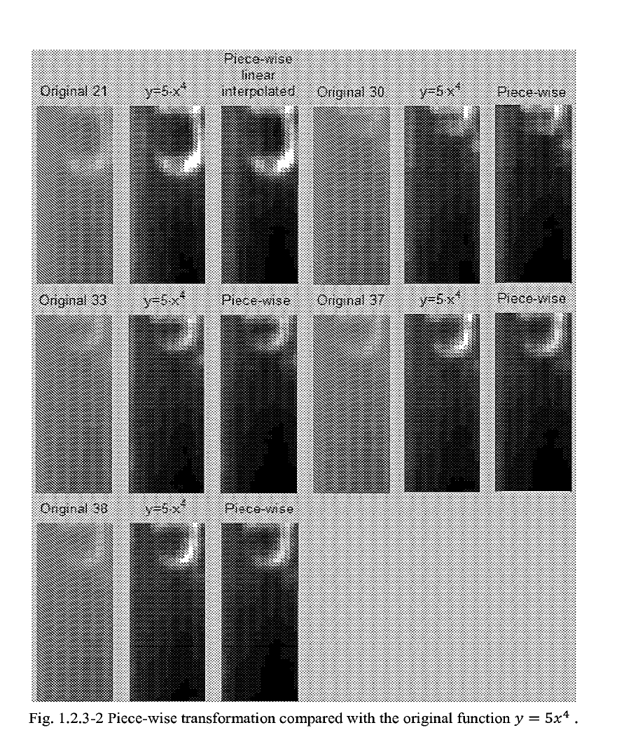

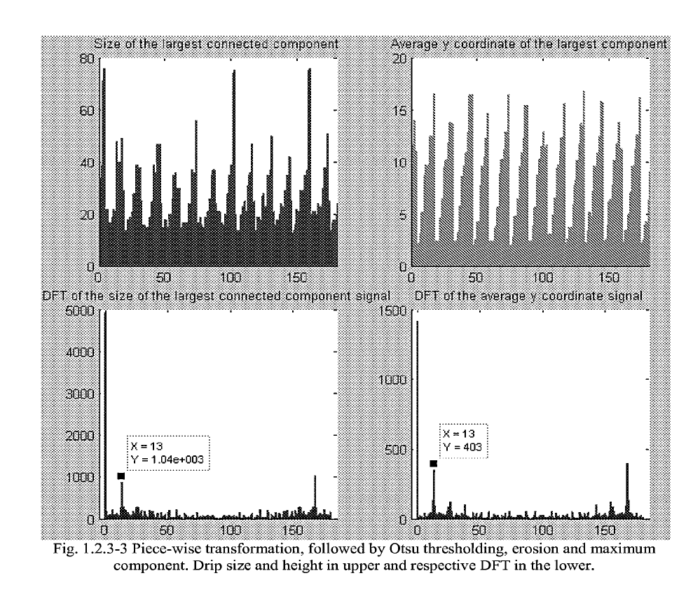

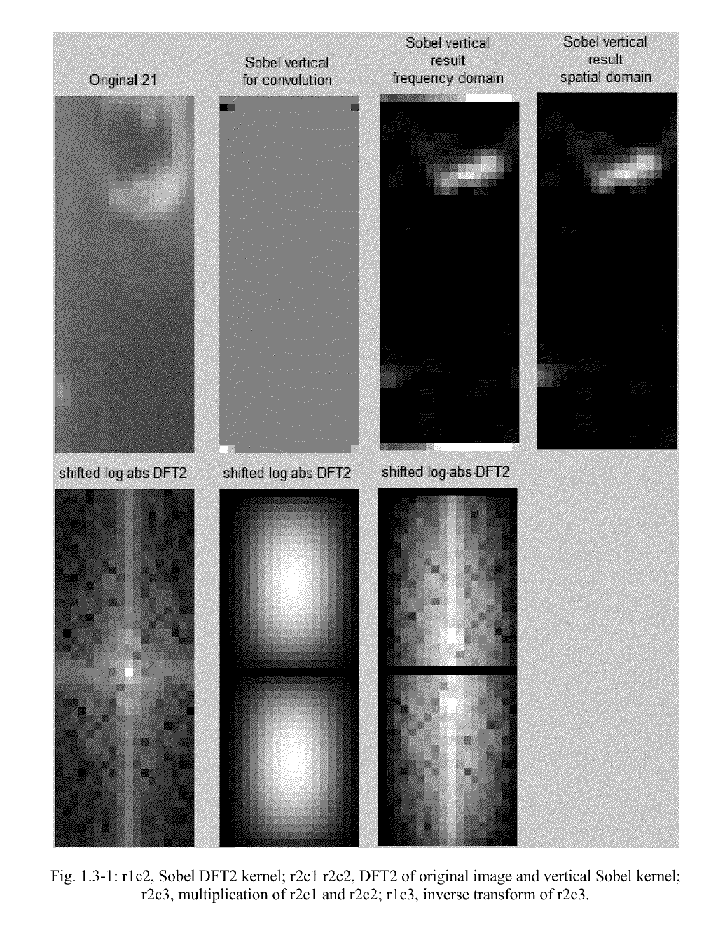

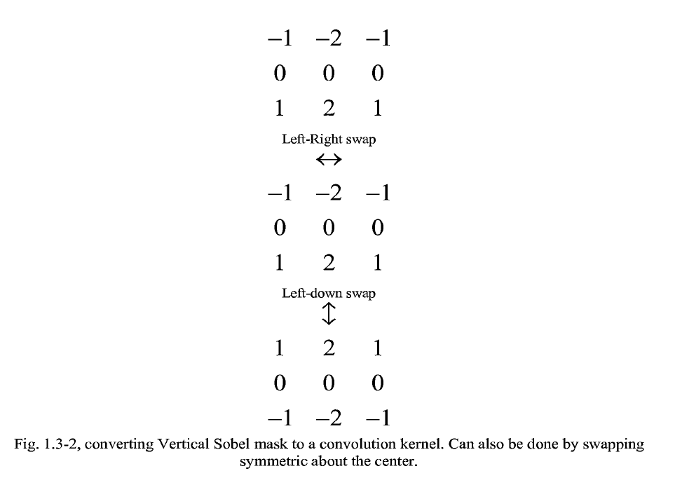

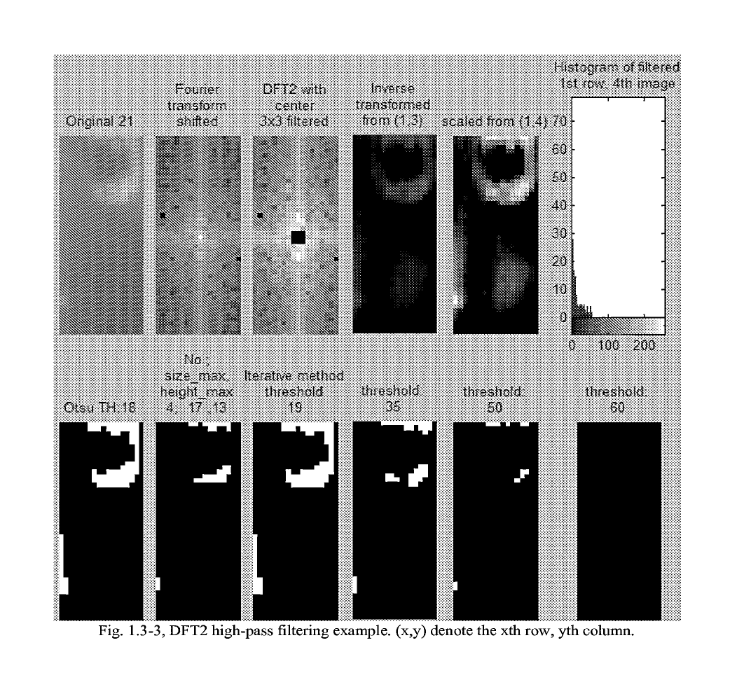

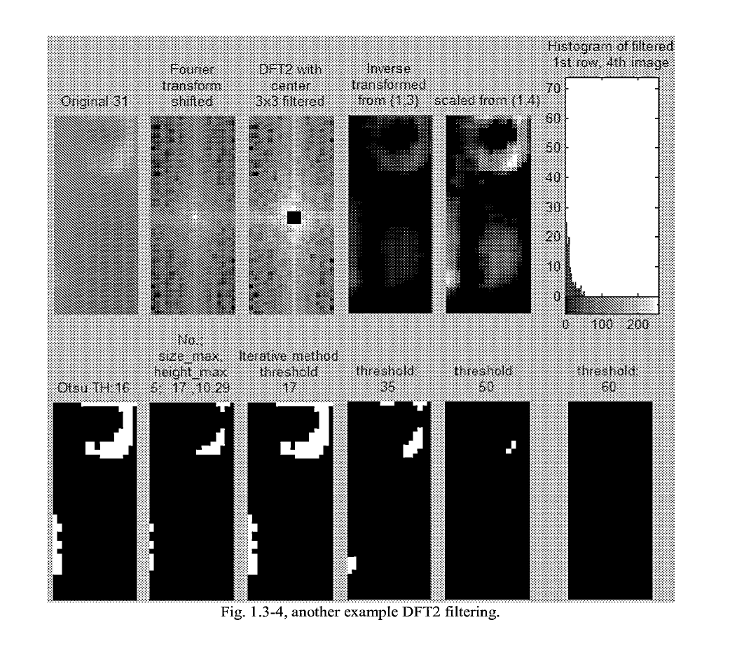

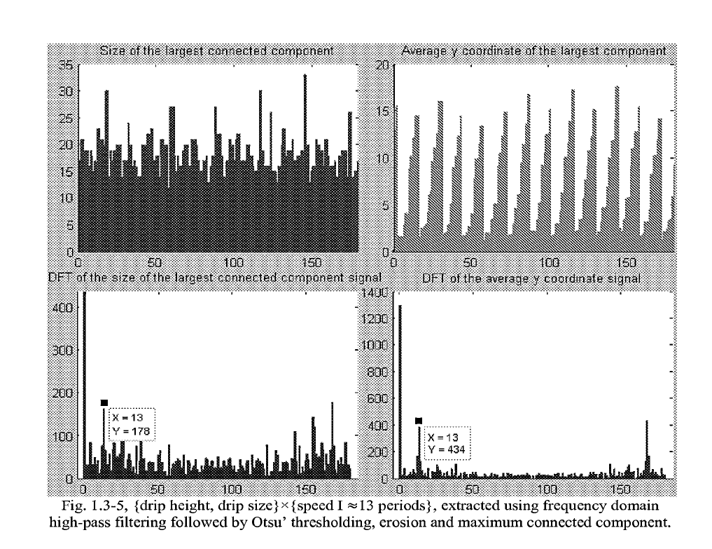

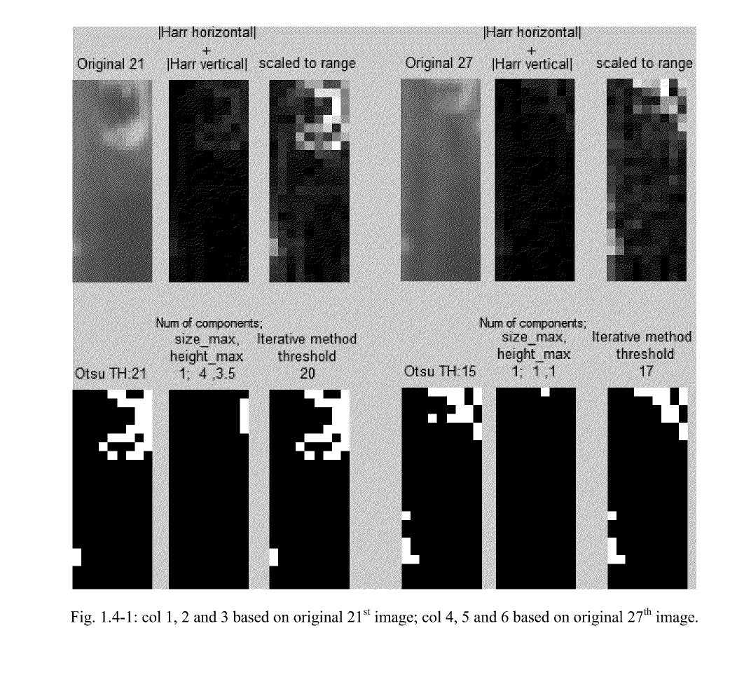

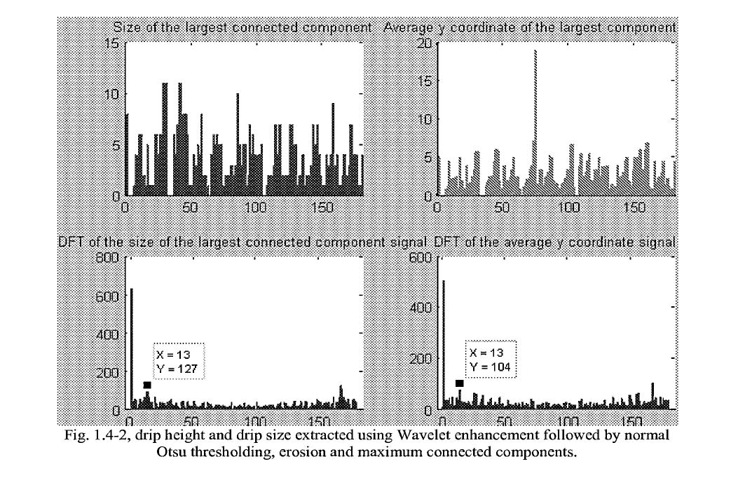

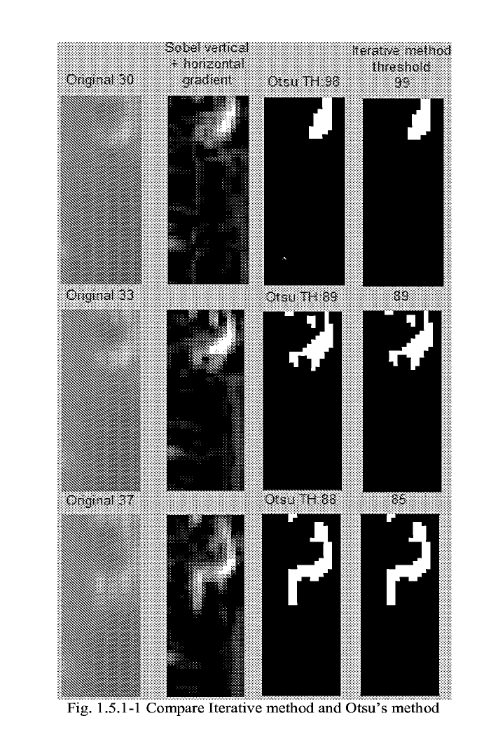

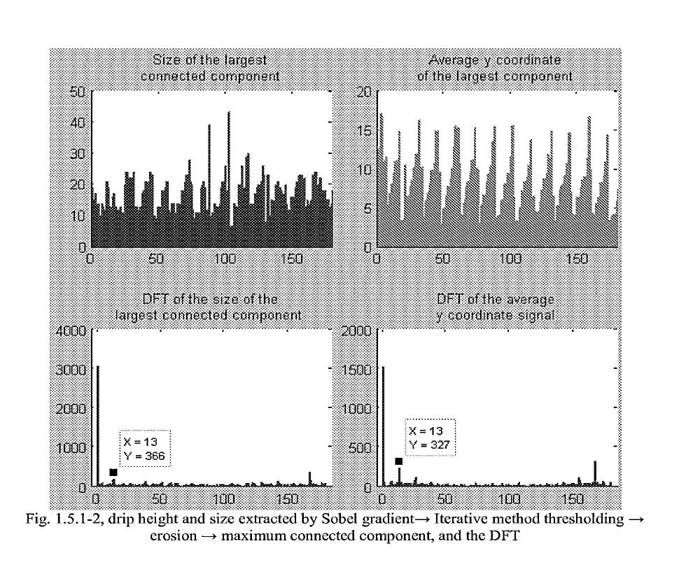

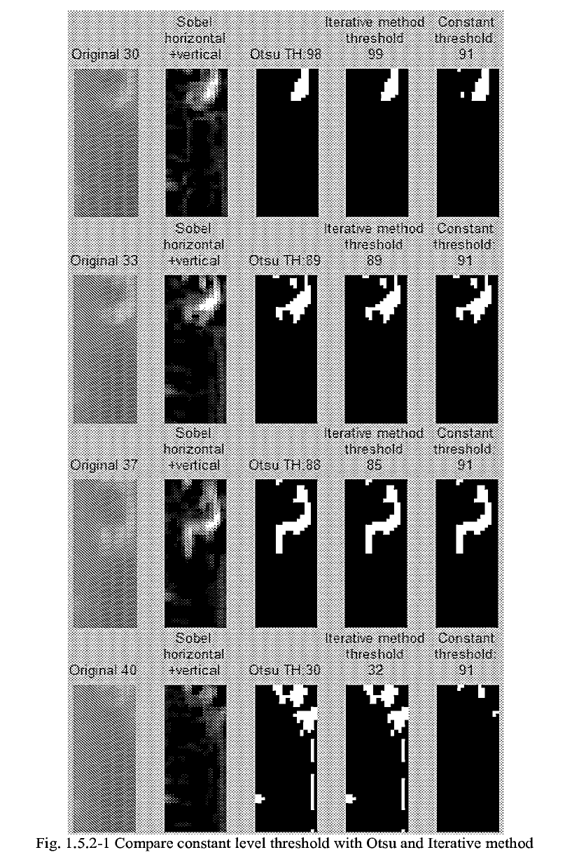

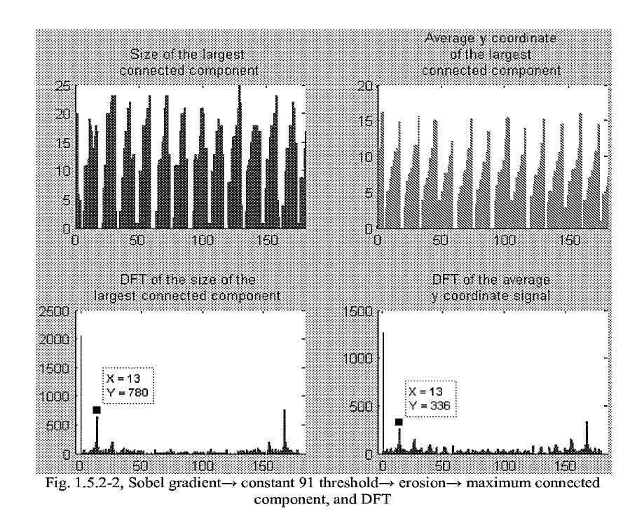

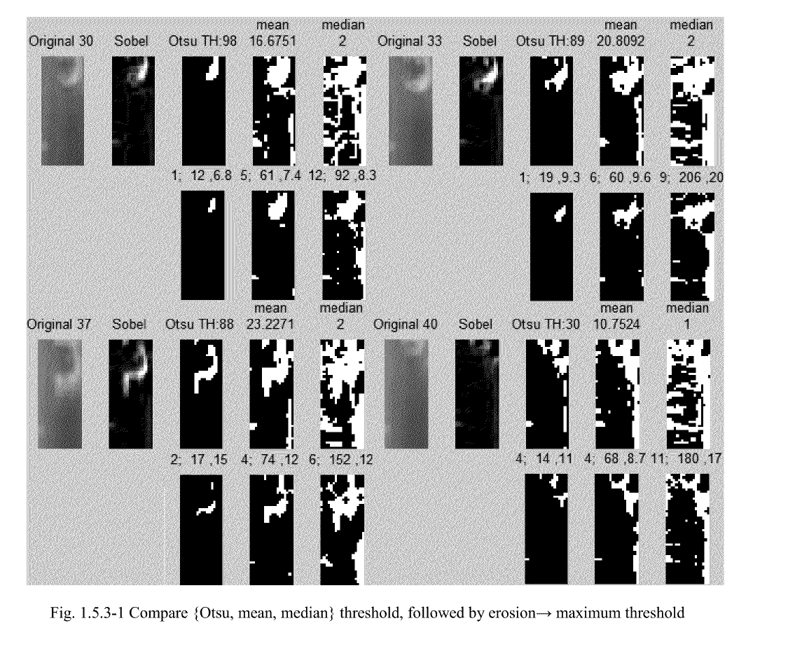

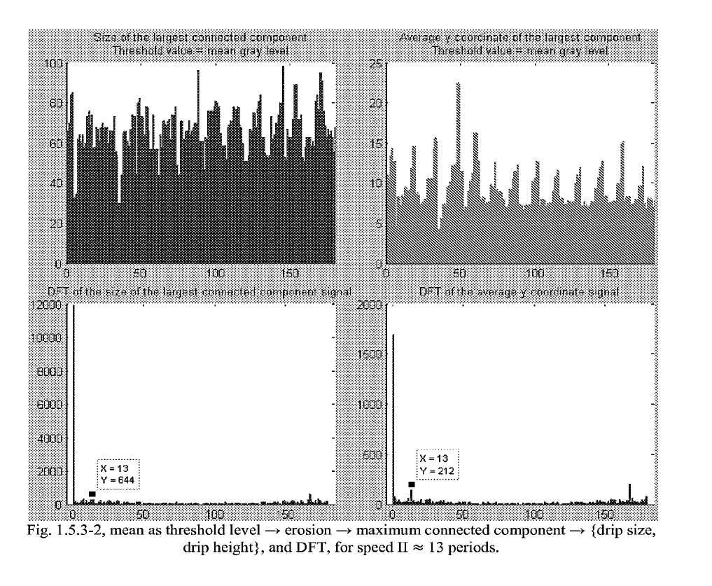

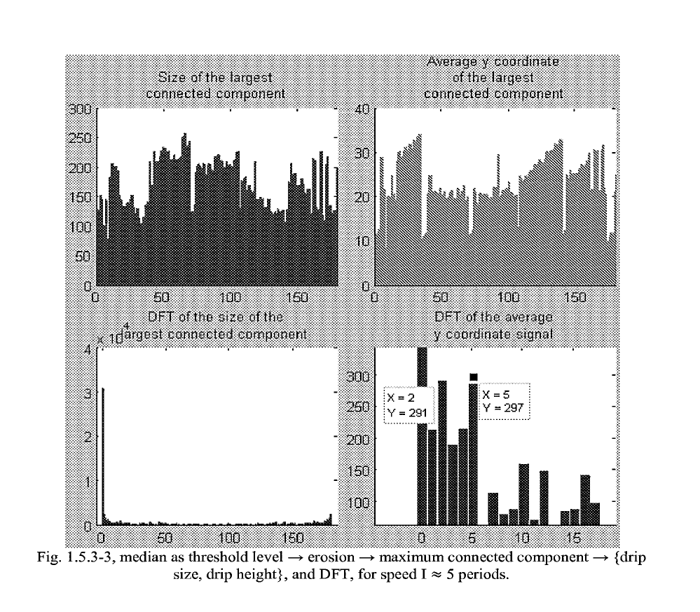

FIG. 1.1-1A show the image of drip chamber and FIG. 1.1-1B shows within FIG. 1.1-1A an area used where image analysis is performed on.

FIG. 1.1-2A shows a vertical Sobel gradient

FIG. 1.1-2B shows a vertical Prewitt gradient

FIG. 1.1-2B shows a Laplacian operator

FIG. 1.1-3 shows an image and its Sobel, Prewitt and Laplacian result.

FIG. 1.1-4A to FIG. 1.1-4D shows analysis steps performed on a sequence of captured images. Each figure contains on its top left the original image, top right the result of Sobel gradient operator, bottom left thresholding result of the Sobel gradient, bottom right erosion result of the bottom left.

FIG. 1.1-5 shows an erosion kernel used FIGS. 1.1-4A to D.

FIG. 1.1-6A shows drip height from speed II≈13 periods dripping video.

FIG. 1.1-6B shows DFT of FIG. 1.1-6A.

FIG. 1.1-7A shows drip size from speed II≈13 periods dripping video.

FIG. 1.1-7B shows DFT of FIG. 1.1-7A.

FIG. 1.1-8A shows region's average gray level from speed II≈13 periods dripping video.

FIG. 1.1-8B shows DFT of FIG. 1.1-8A.

FIG. 1.2.1-1 shows the comparison between image gradients, power-law and exponentiation transformation result.

FIG. 1.2.1-2 shows power-law result followed by Otsu thresholding and erosion.

FIG. 1.2.2-3 shows drip size data obtained after gray-level transformation y=5·(3^{x}−2), followed by Otsu threshold, erosion and maximum connected components. The lower is the DFT.

FIG. 1.2.3-1 is the piece-wise interpolation of power-law transformation y=5x⁴ in five segments.

FIG. 1.2.3-2 shows image piece-wise transformation compared with the original function=5x⁴.

FIG. 1.2.3-3 is the signal obtained by piece-wise transformation, followed by Otsu thresholding, erosion and maximum component. Drip size and height in upper and respective DFT in the lower.

FIG. 1.3-1 shows how to perform frequency filtering that is equivalent to a spatial domain filter.

FIG. 1.3-2 shows how to convert Vertical Sobel mask to a convolution kernel

FIG. 1.3-3 shows frequency-domain high-pass filter effect.

FIG. 1.3-4 shows another example of frequency-domain filtering.

FIG. 1.4-1 shows the result of wavelet filtering.

FIG. 1.4-2 shows the signals obtained by wavelet filtering followed by Otsu thresholding, erosion and maximum connected components and their DFT.

FIG. 1.5.1-1 compares Iterative method and Otsu's method

FIG. 1.5.1-2 shows the signals obtained by iterative method thresholding, preceded by Sobel gradient and followed by erosion and maximum connected components, together with their DFT.

FIG. 1.5.2-1 compares constant level threshold with Otsu and Iterative method.

FIG. 1.5.2-2 shows the signals obtained by constant level thresholding, preceded by Sobel gradient and followed by erosion and maximum connected components, together with their DFT.

FIG. 1.5.3-1 compares Otsu, mean and median thresholding.

FIG. 1.5.3-2 shows the signals obtained by mean thresholding, preceded by Sobel gradient and followed by erosion and maximum connected components, together with their DFT.

FIG. 1.5.3-3 shows the signals obtained by median thresholding, preceded by Sobel gradient and followed by erosion and maximum connected components, together with their DFT.

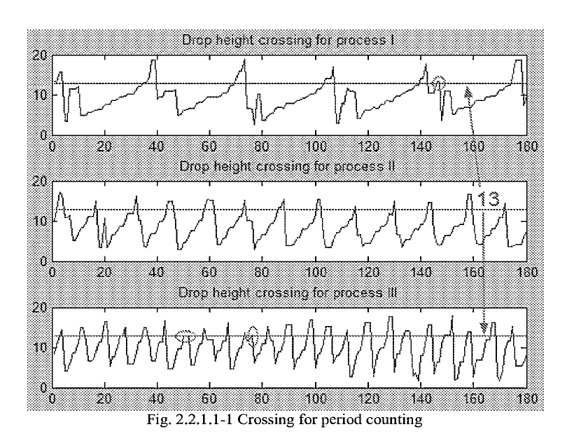

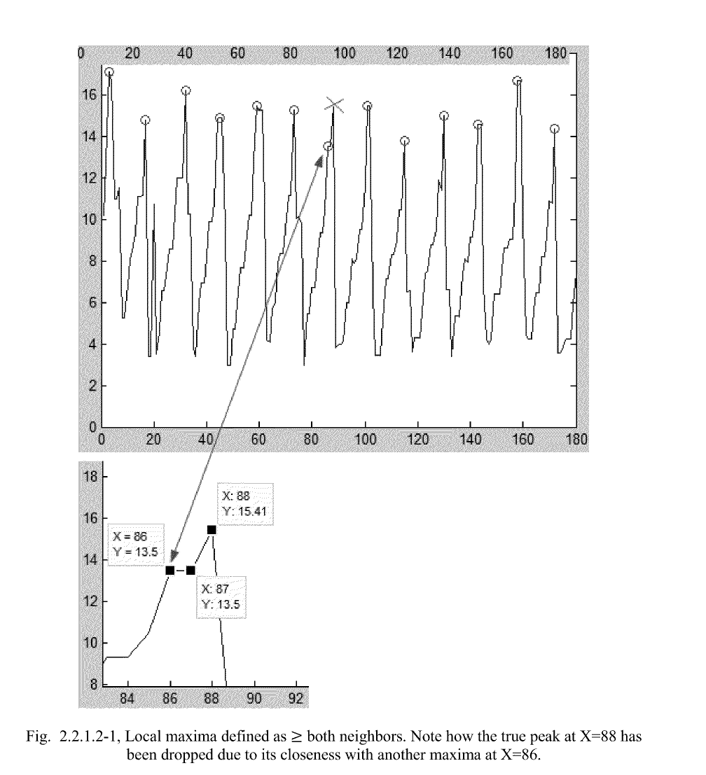

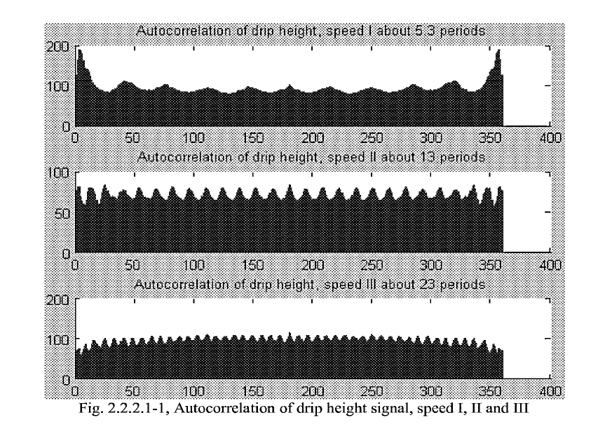

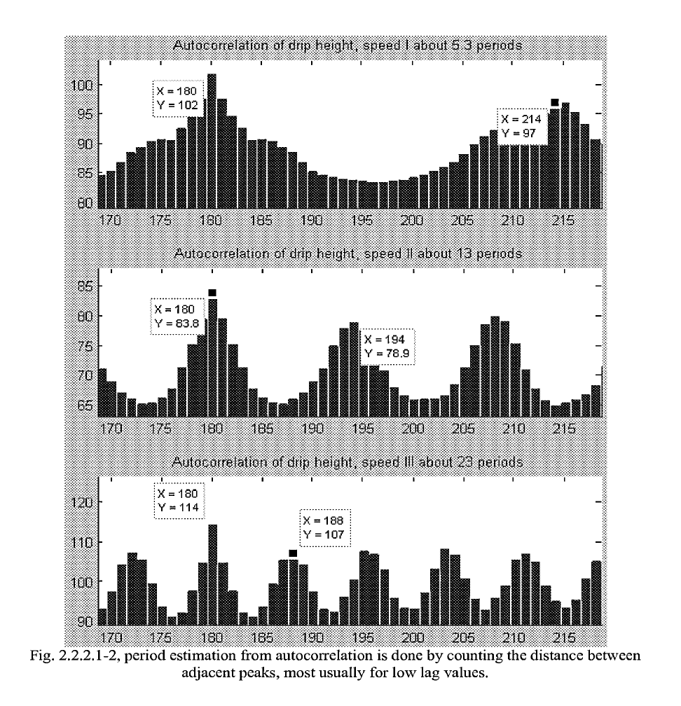

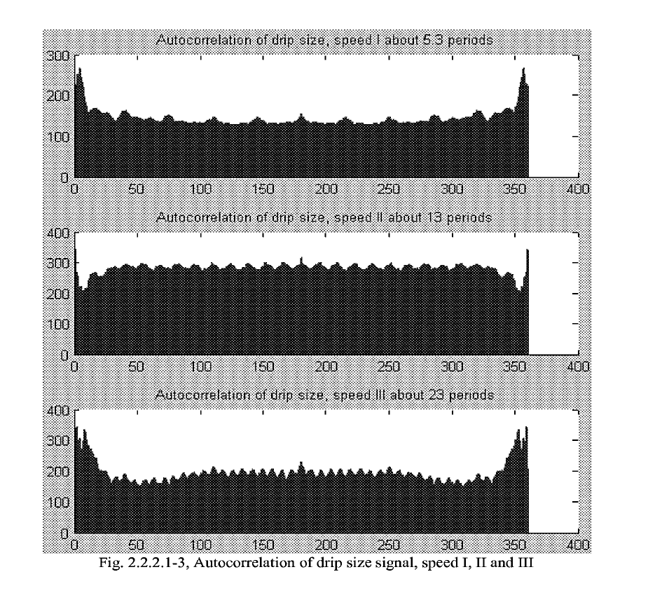

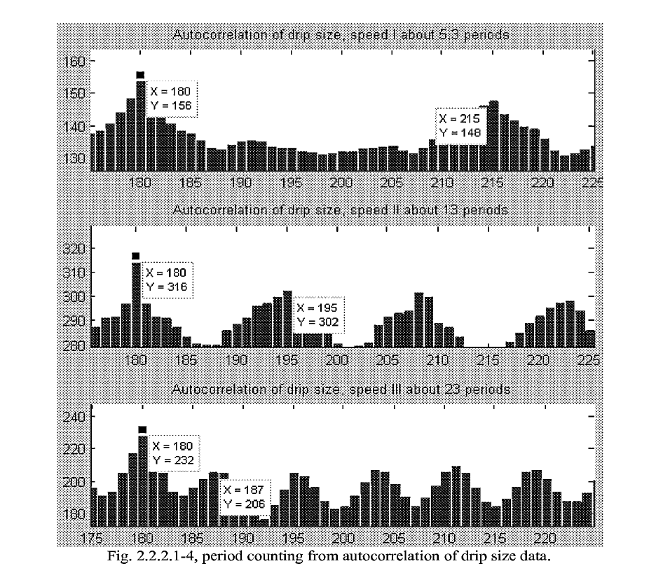

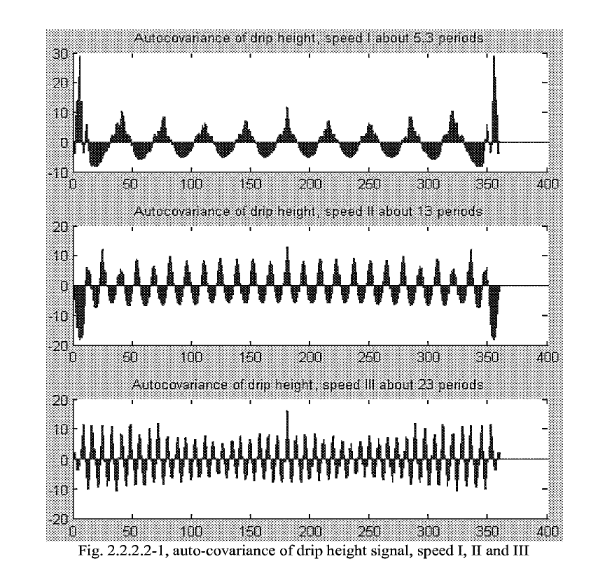

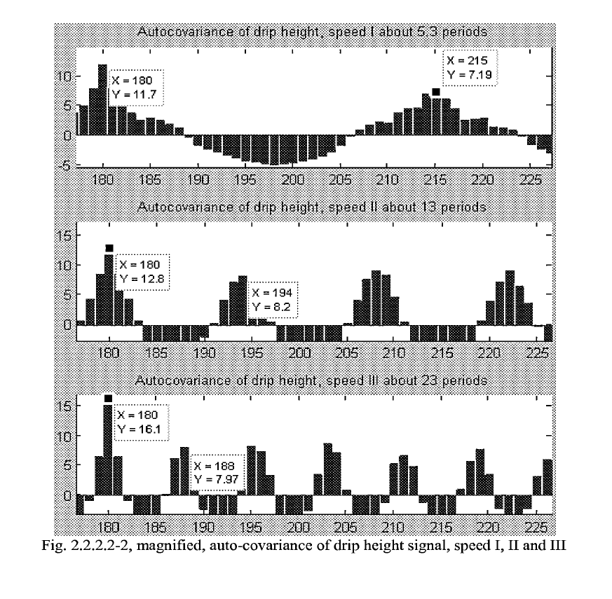

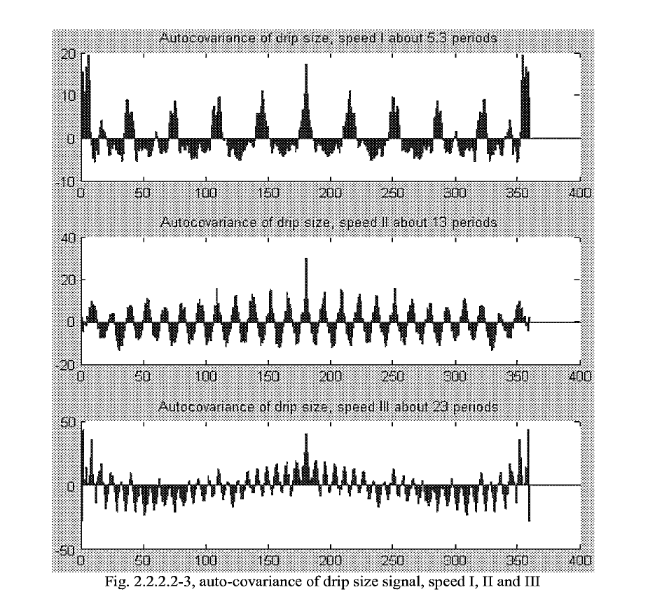

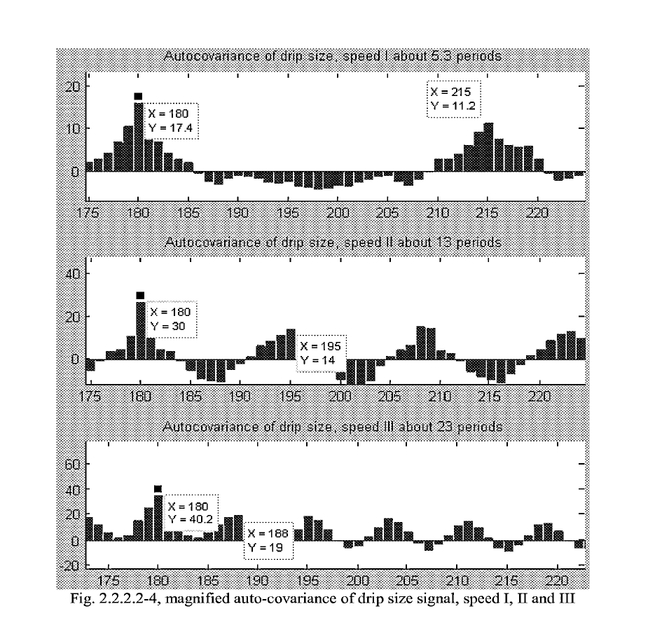

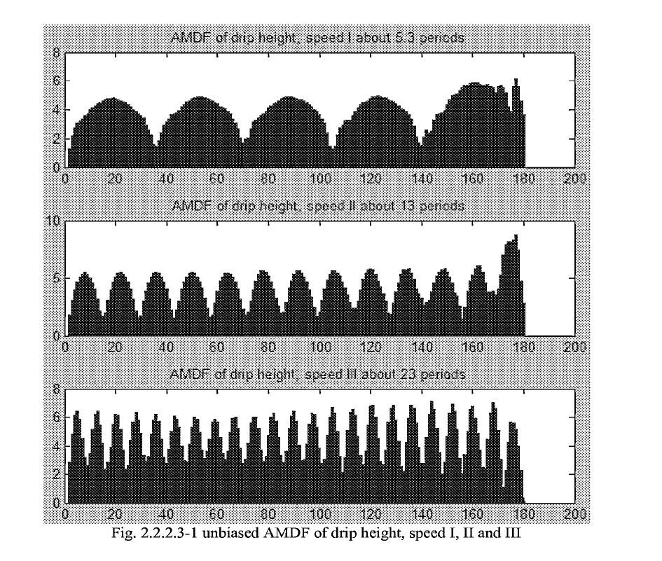

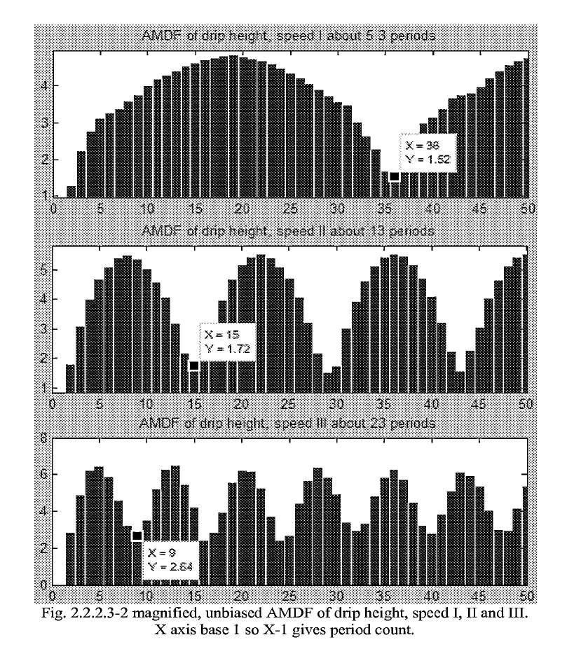

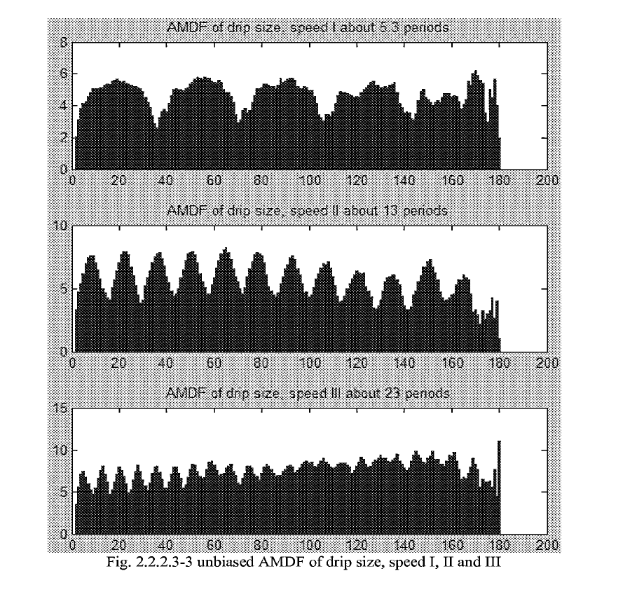

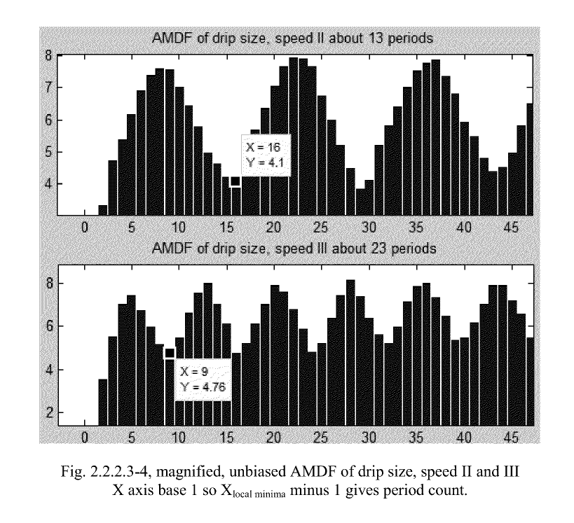

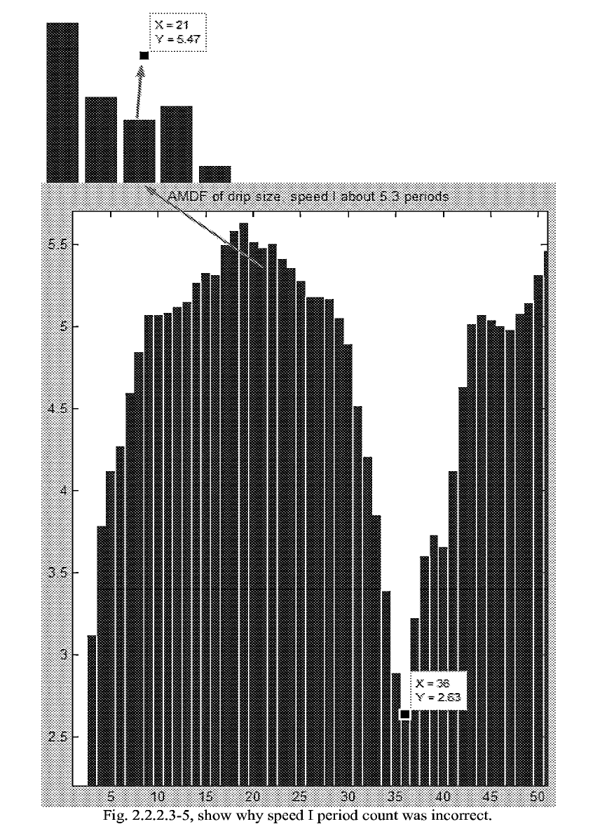

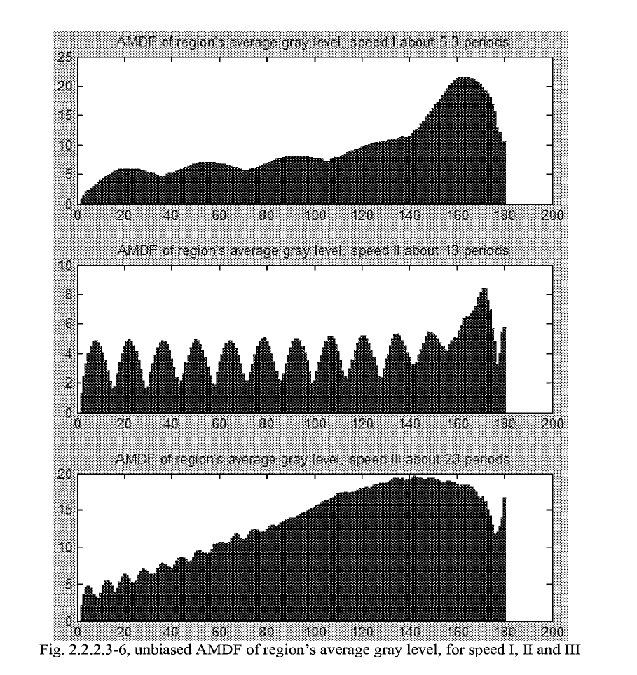

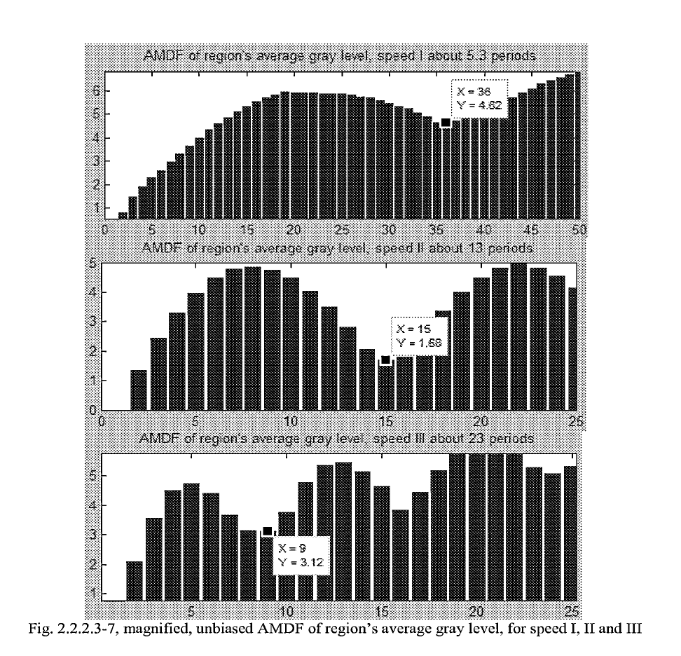

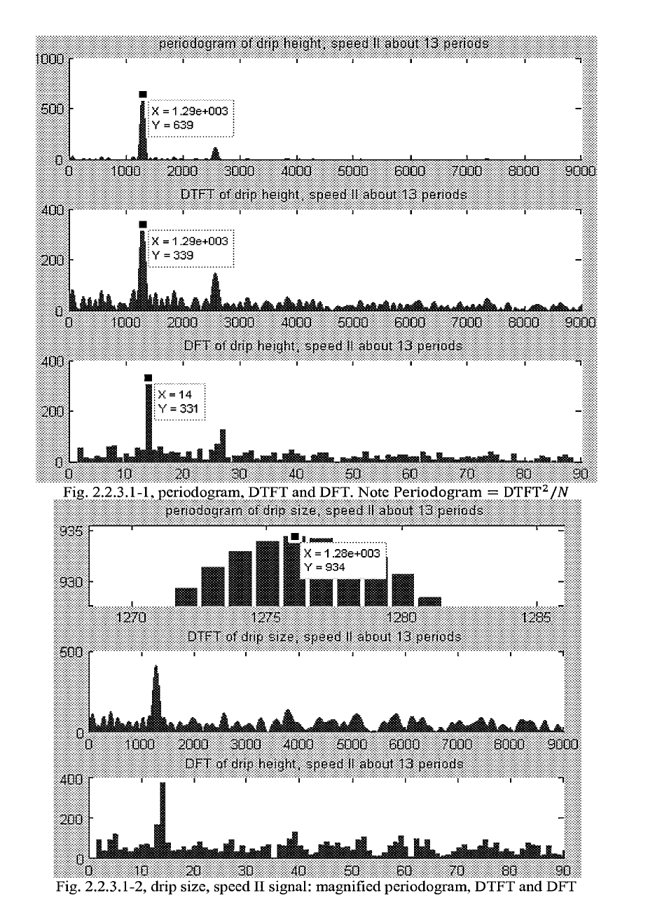

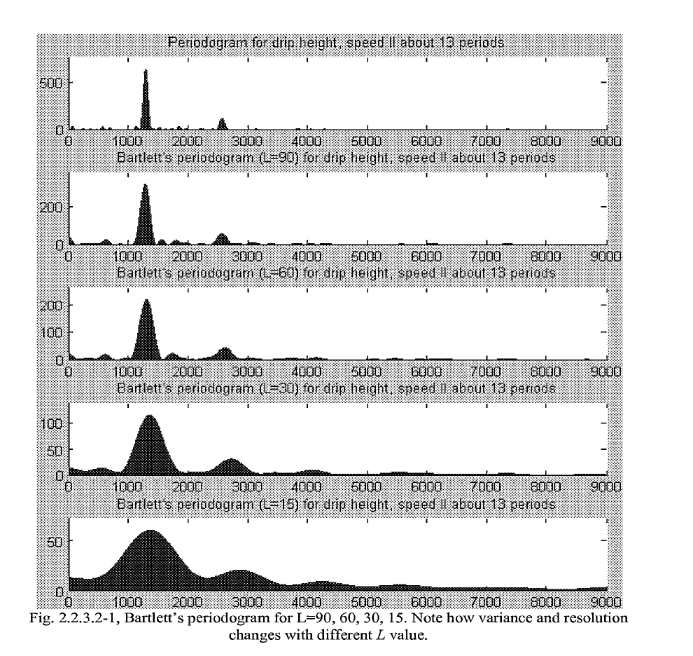

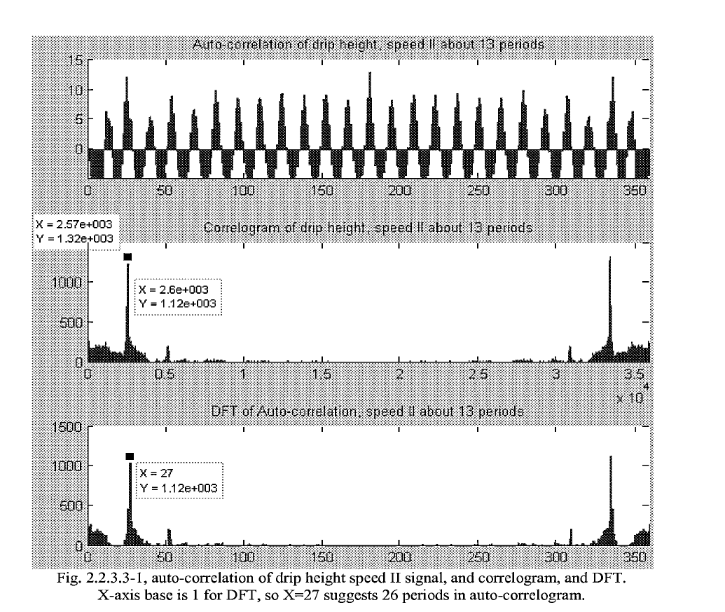

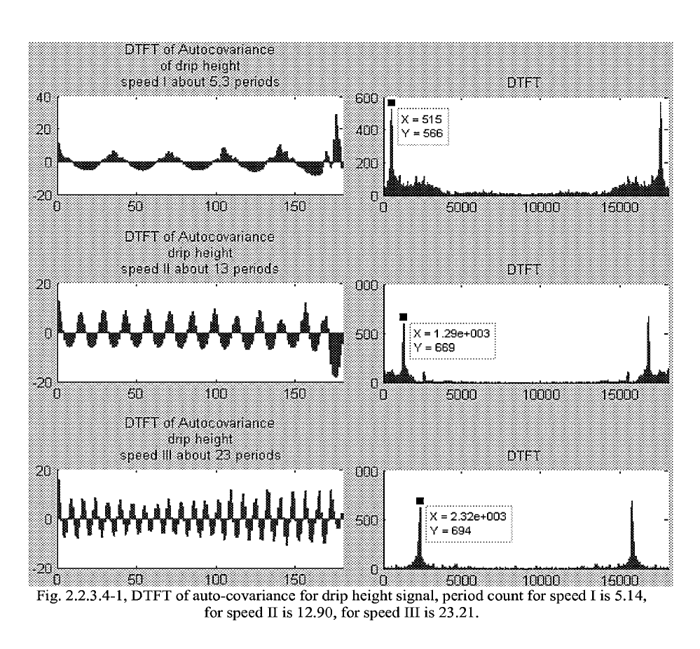

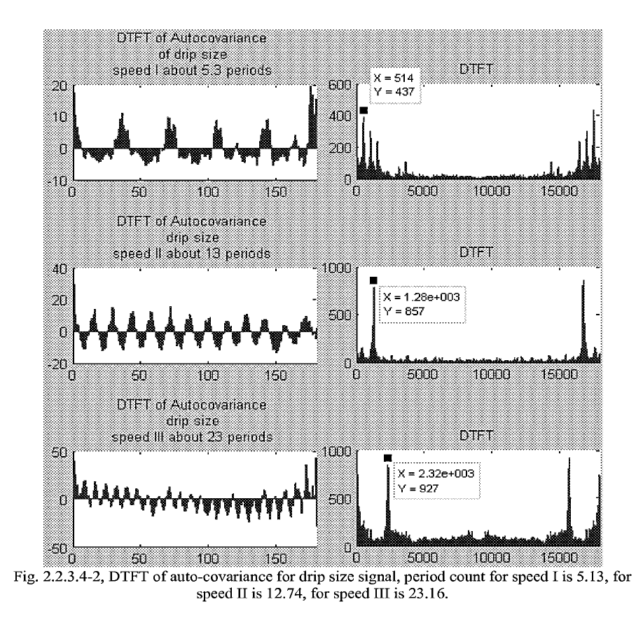

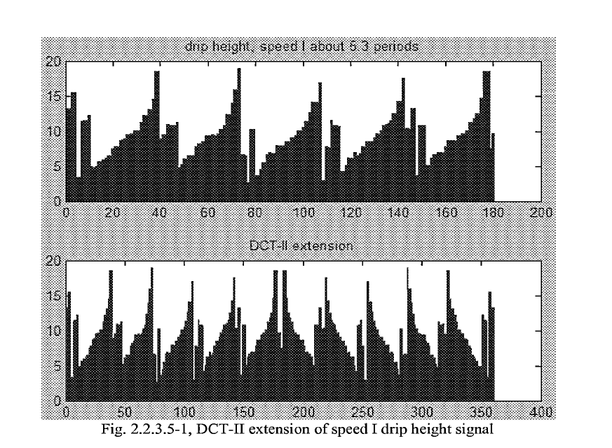

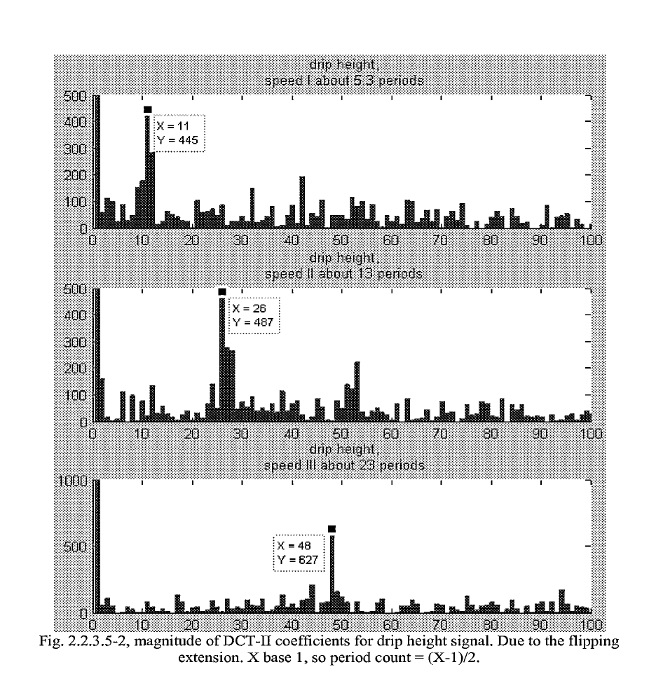

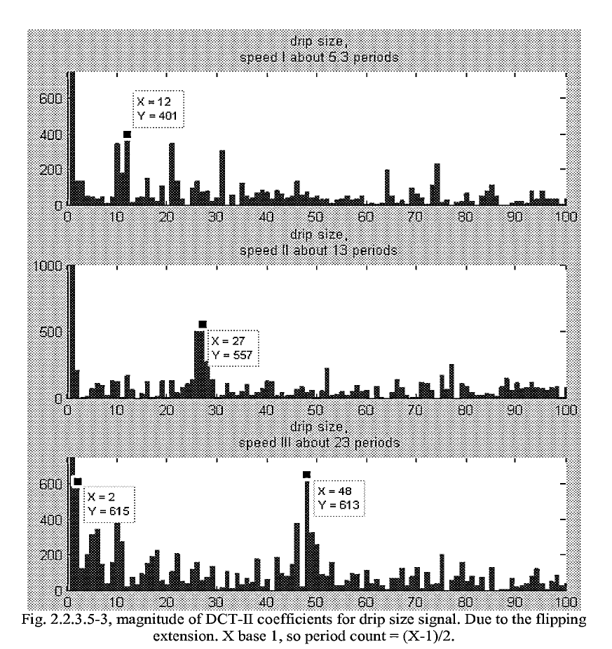

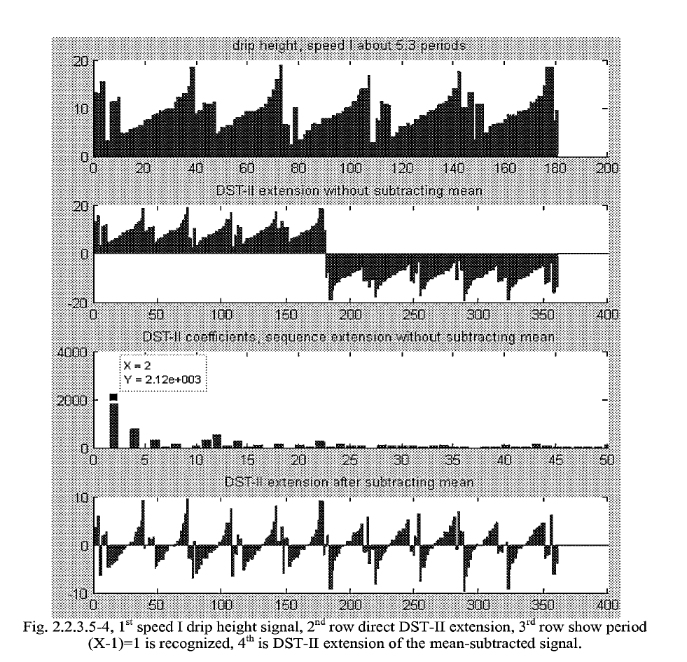

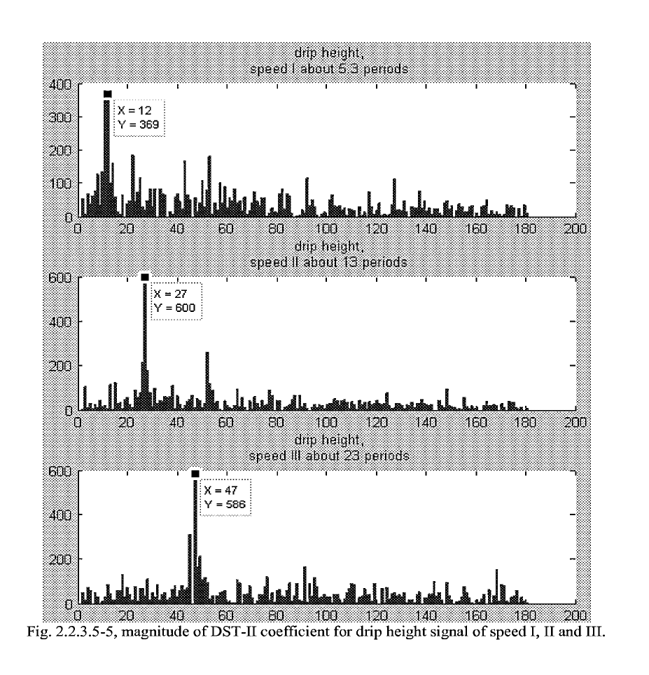

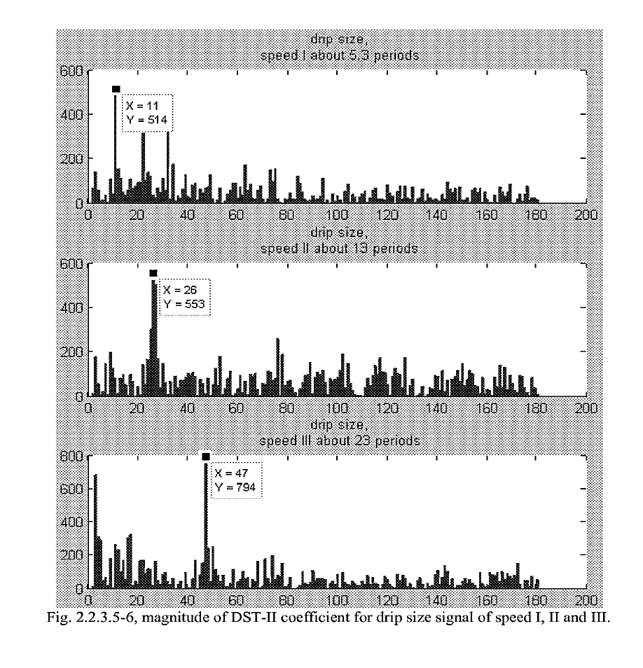

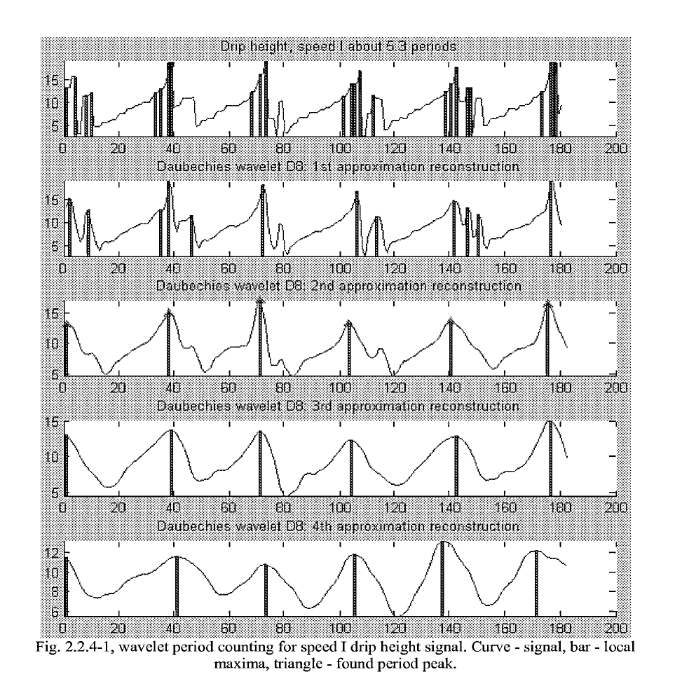

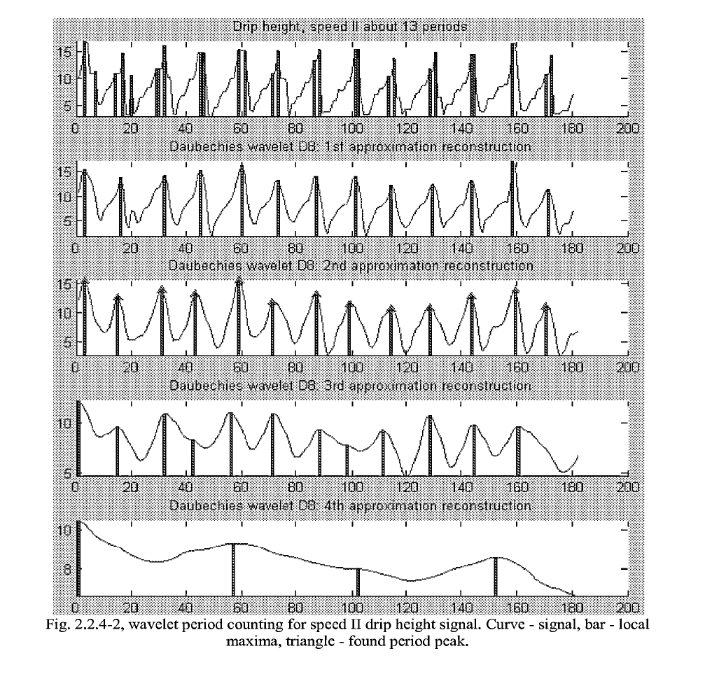

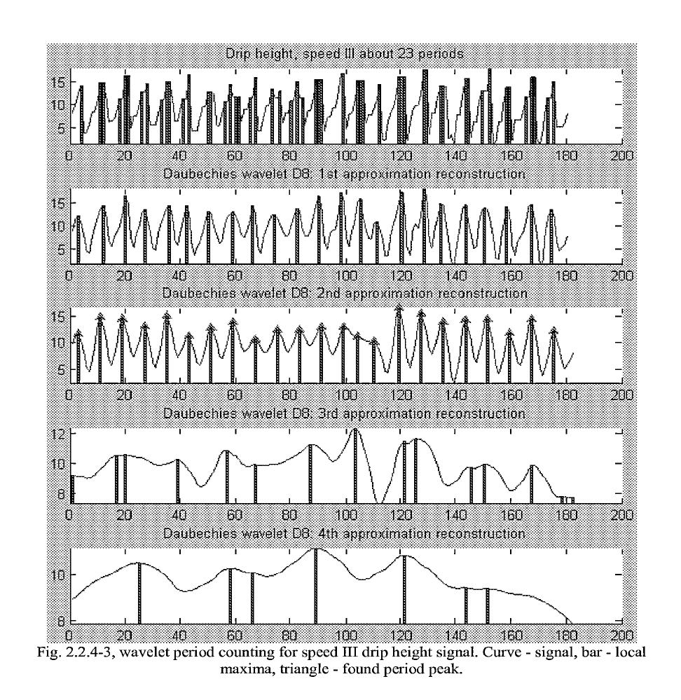

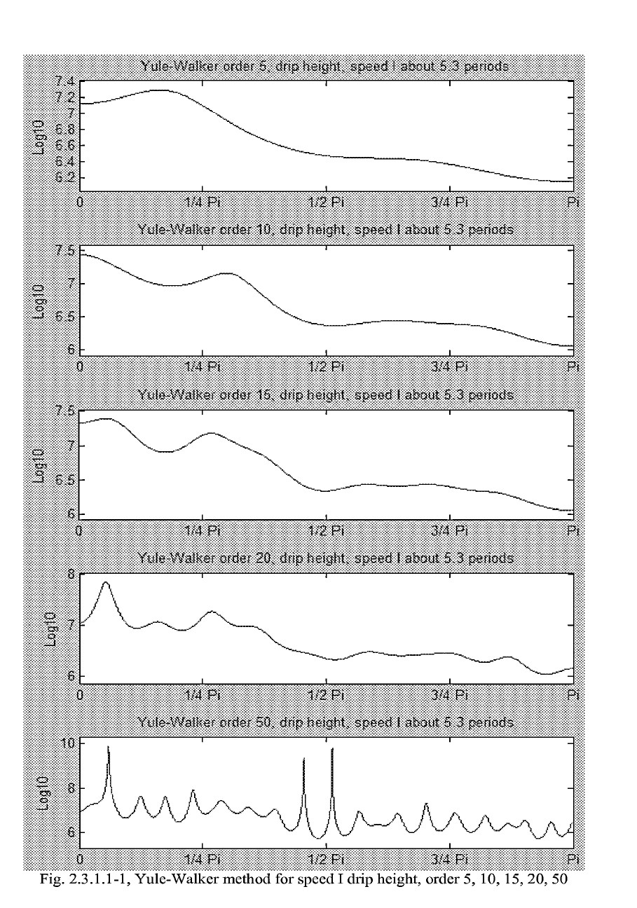

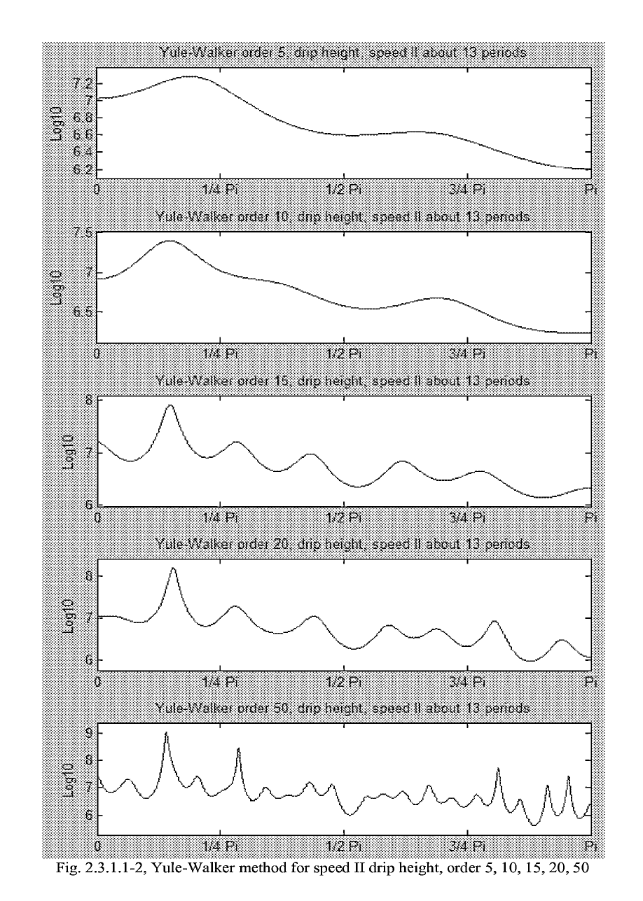

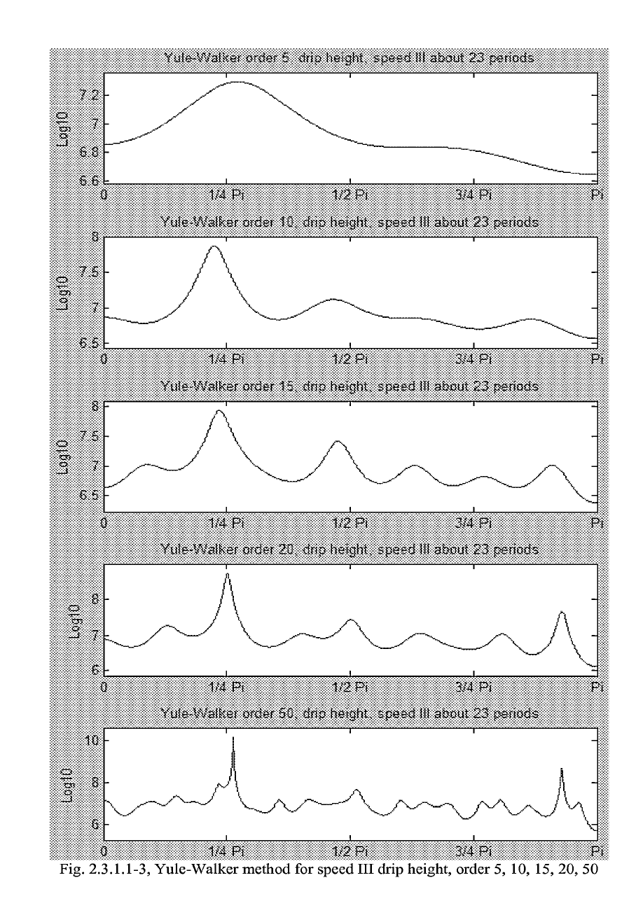

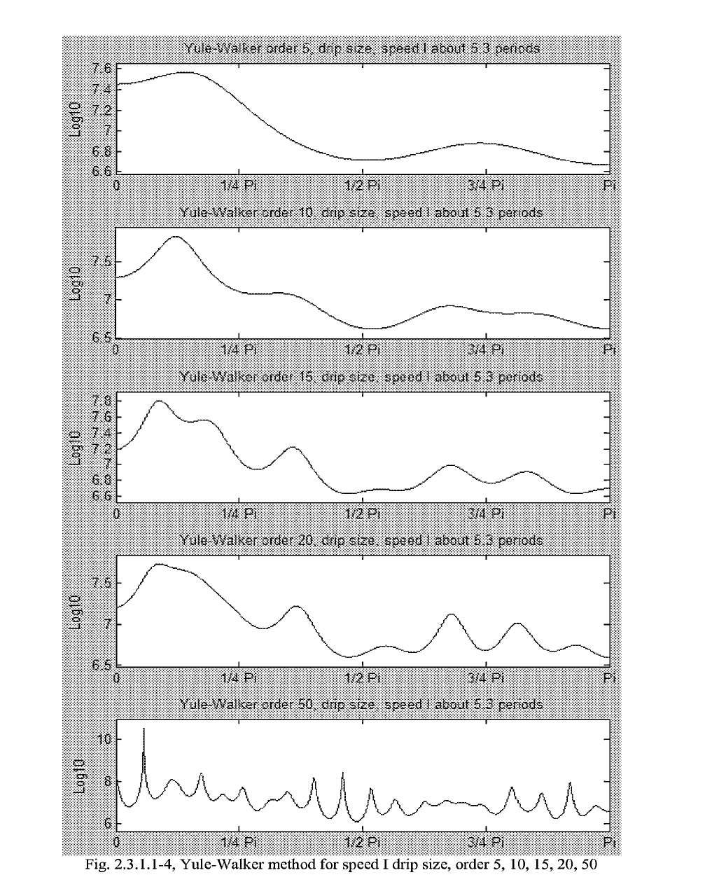

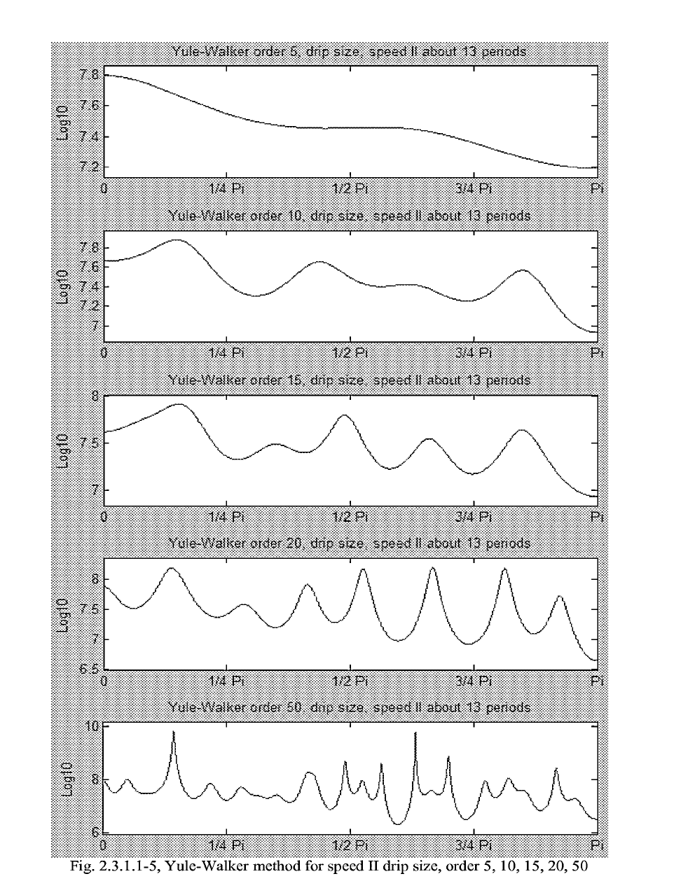

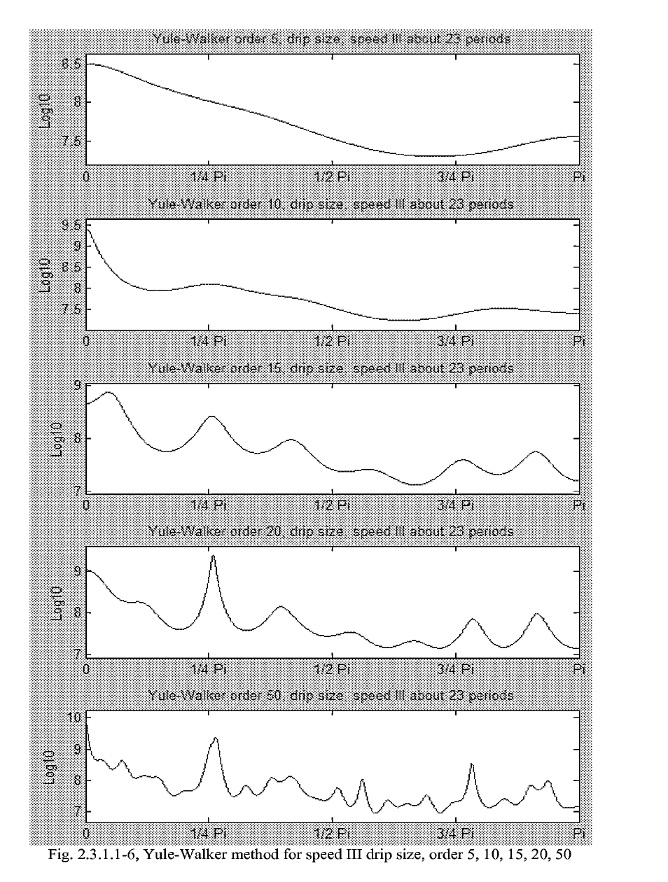

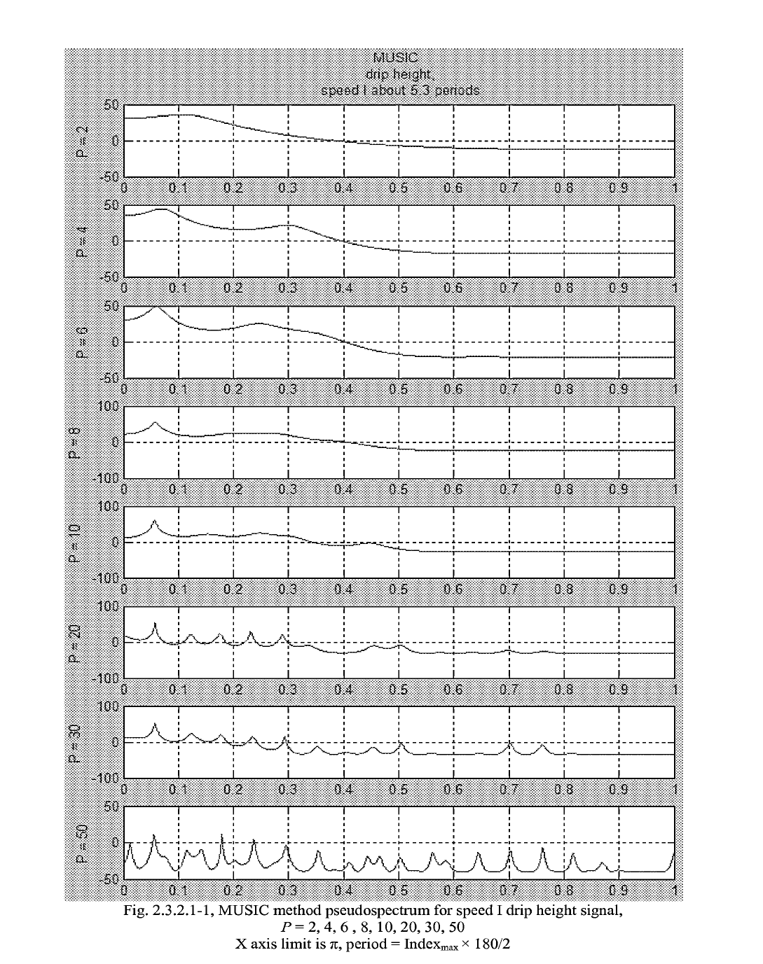

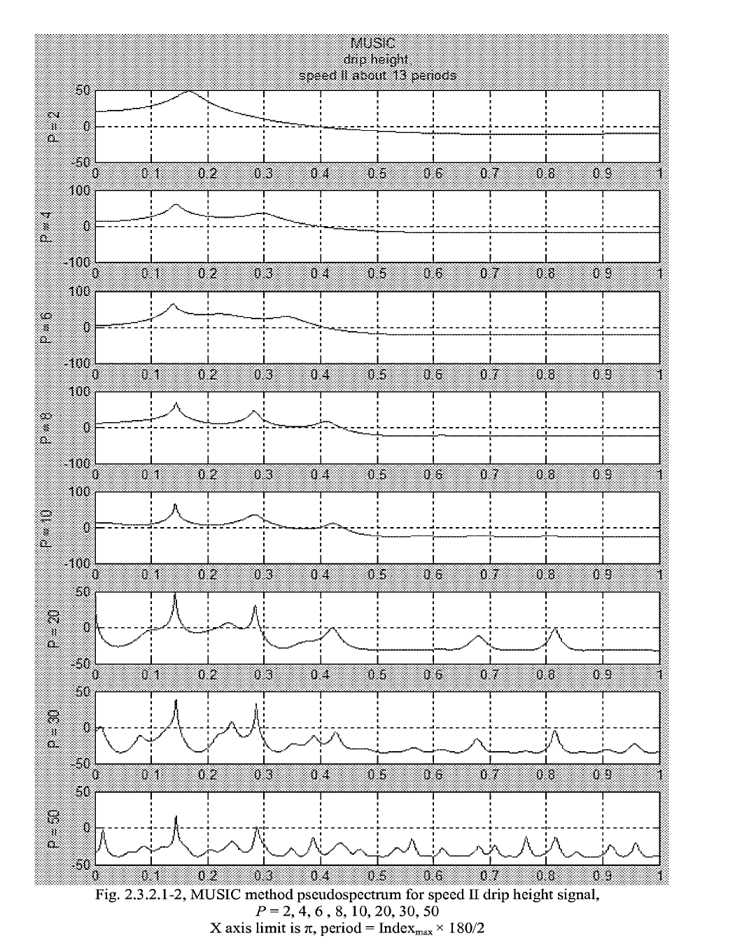

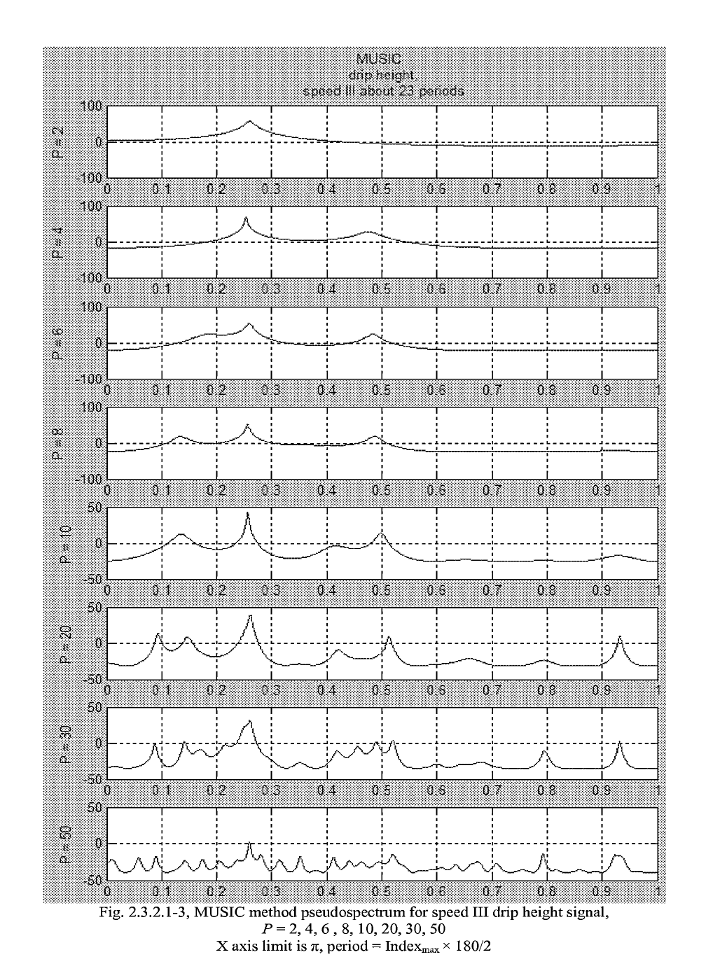

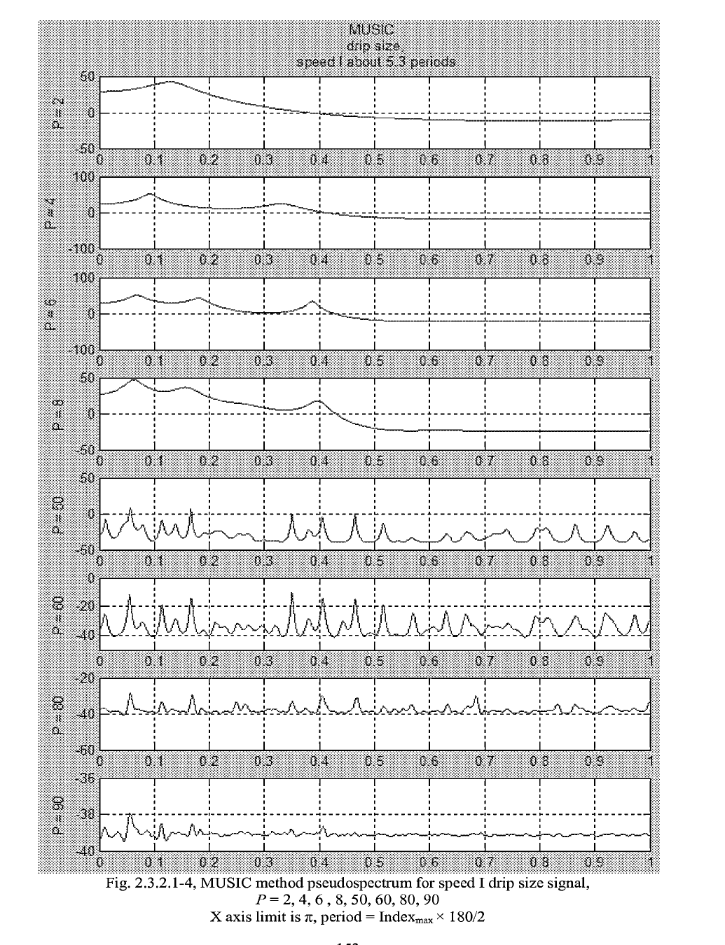

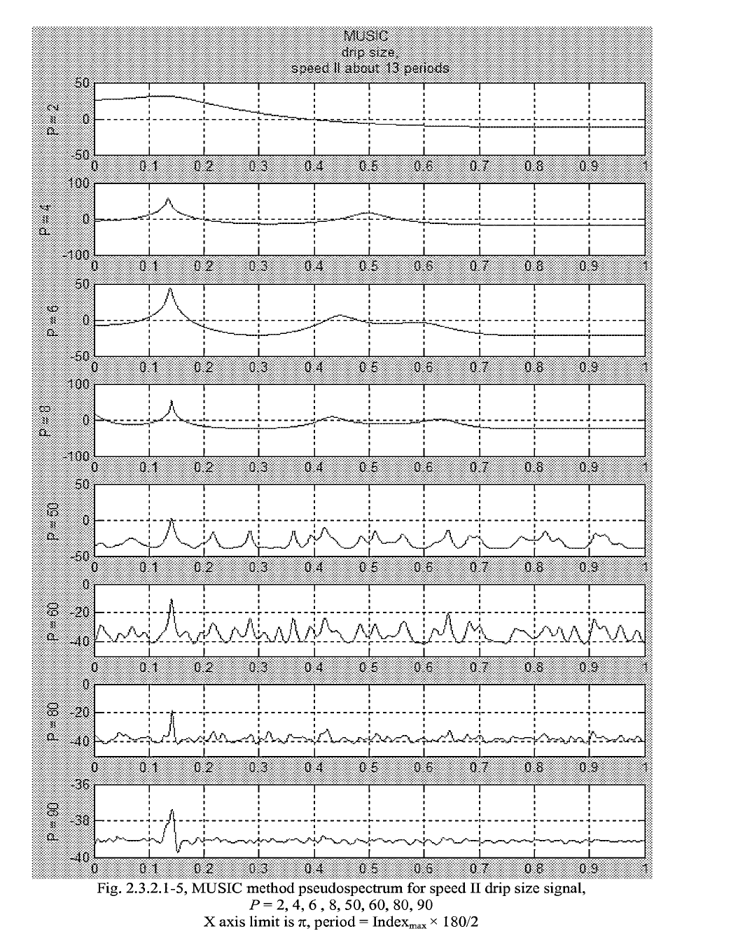

FIG. 2.2.1.1-1 shows how crossing can be used for period counting.

FIG. 2.2.1.2-1 shows how local maxima can be used for period counting.

FIG. 2.2.2.1-1 shows autocorrelation of drip height signal, speed I, II and III.

FIG. 2.2.2.1-2 shows period estimation from FIG. 2.2.2.1-1.

FIG. 2.2.2.1-3 shows autocorrelation of drip size signal, speed I, II and III.

FIG. 2.2.2.1-4 shows period estimation from FIG. 2.2.2.1-3.

FIG. 2.2.2.2-1 shows auto-covariance of drip height signal, speed I, II and III

FIG. 2.2.2.2-2 shows magnified, auto-covariance of drip height signal, speed I, II and III

FIG. 2.2.2.2-3 shows auto-covariance of drip size signal, speed I, II and III

FIG. 2.2.2.2-4 shows magnified auto-covariance of drip size signal, speed I, II and III

FIG. 2.2.2.3-1 shows unbiased AMDF of drip height, speed I, II and III

FIG. 2.2.2.3-2 shows magnified, unbiased AMDF of drip height, speed I, II and III.

FIG. 2.2.2.3-3 shows unbiased AMDF of drip size, speed I, II and III

FIG. 2.2.2.3-4 shows magnified, unbiased AMDF of drip size, speed II and III

FIG. 2.2.2.3-5 shows why speed I period count was incorrect.

FIG. 2.2.2.3-6 shows unbiased AMDF of region's average gray level, for speed I, II and III

FIG. 2.2.2.3-7 shows magnified, unbiased AMDF of region's average gray level, for speed I, II and III

FIG. 2.2.3.1-1 shows periodogram, DTFT and DFT of speed II drip height signal.

FIG. 2.2.3.1-2 shows drip size, speed II signal's magnified periodogram, DTFT and DFT

FIG. 2.2.3.2-1 shows Bartlett's periodogram for L=90, 60, 30, 15, for speed II drip height signal.

FIG. 2.2.3.3-1 shows auto-correlation of drip height speed II signal, and correlogram, and DFT.

FIG. 2.2.3.4-1 shows DTFT of auto-covariance for drip height signal.

FIG. 2.2.3.4-2 shows DTFT of auto-covariance for drip size signal.

FIG. 2.2.3.5-1 shows DCT-II extension of speed I drip height signal

FIG. 2.2.3.5-2 shows magnitude of DCT-II coefficients for drip height signal.

FIG. 2.2.3.5-3 shows magnitude of DCT-II coefficients for drip size signal.

FIG. 2.2.3.5-4 shows incorrect and correct ways DST-II extension.

FIG. 2.2.3.5-5 shows magnitude of DST-II coefficients for drip height signal.

FIG. 2.2.3.5-6 shows magnitude of DST-II coefficients for drip size signal.

FIG. 2.2.4-1 shows wavelet period counting for speed I drip height signal.

FIG. 2.2.4-2 shows wavelet period counting for speed II drip height signal.

FIG. 2.2.4-3 shows wavelet period counting for speed III drip height signal.

FIG. 2.3.1.1-1 shows Yule-Walker method for speed I drip height

FIG. 2.3.1.1-2 shows Yule-Walker method for speed II drip height

FIG. 2.3.1.1-3 shows Yule-Walker method for speed III drip height

FIG. 2.3.1.1-4, Yule-Walker method for speed I drip size

FIG. 2.3.1.1-5, Yule-Walker method for speed II drip size

FIG. 2.3.1.1-6, Yule-Walker method for speed III drip size

FIG. 2.3.2.1-1 shows MUSIC method pseudospectrum for speed I drip height signal

FIG. 2.3.2.1-2 shows MUSIC method pseudospectrum for speed II drip height signal

FIG. 2.3.2.1-3 shows MUSIC method pseudospectrum for speed III drip height signal

FIG. 2.3.2.1-4 shows MUSIC method pseudospectrum for speed I drip size signal

FIG. 2.3.2.1-5 shows MUSIC method pseudospectrum for speed II drip size signal

FIG. 2.3.2.1-6 shows MUSIC method pseudospectrum for speed III drip size signal

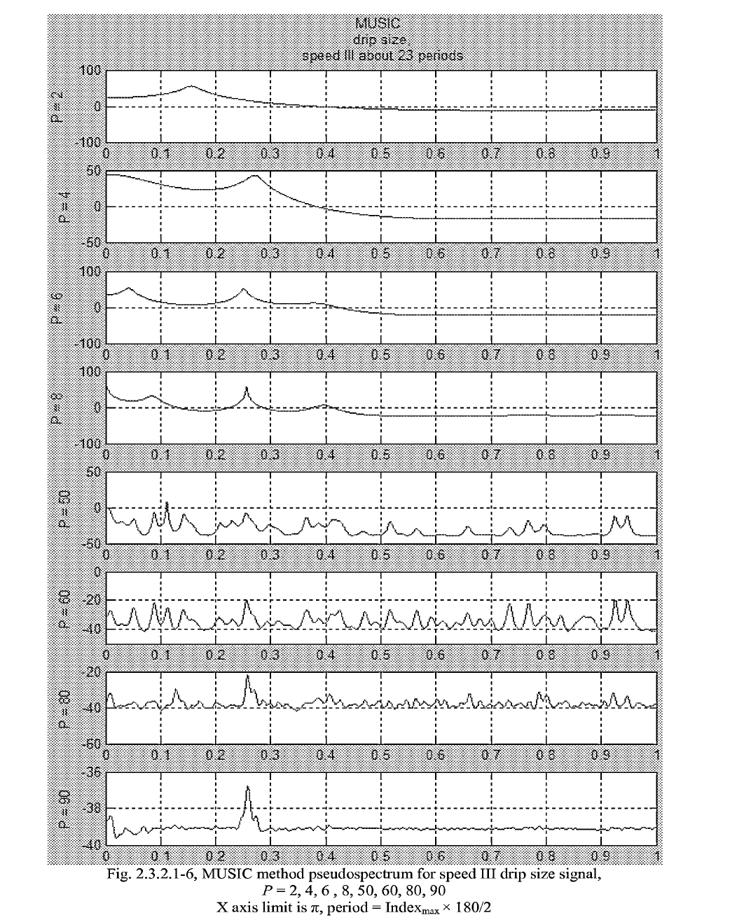

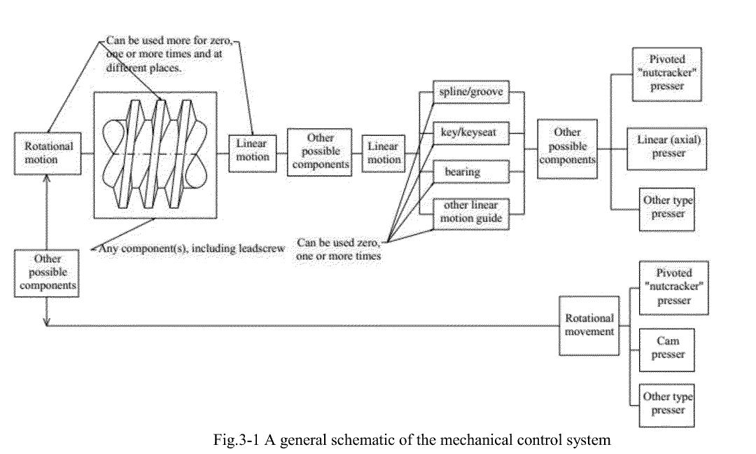

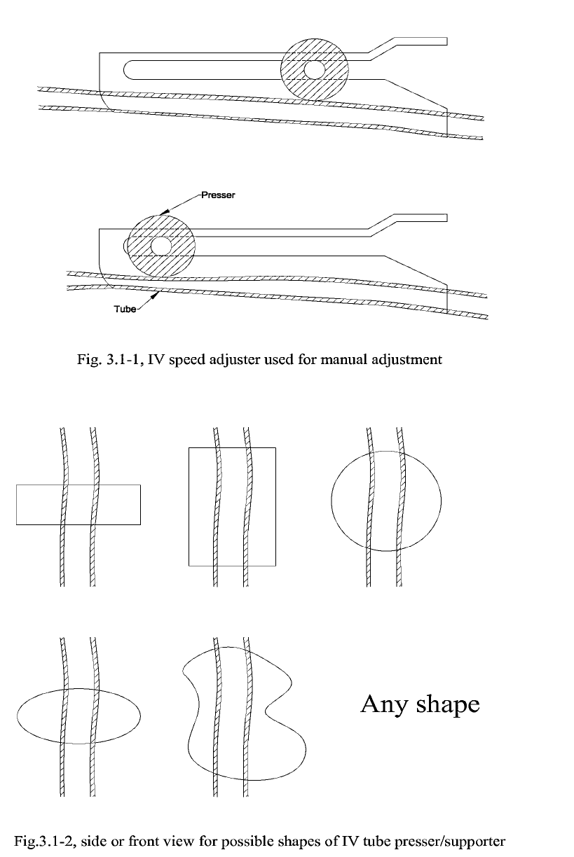

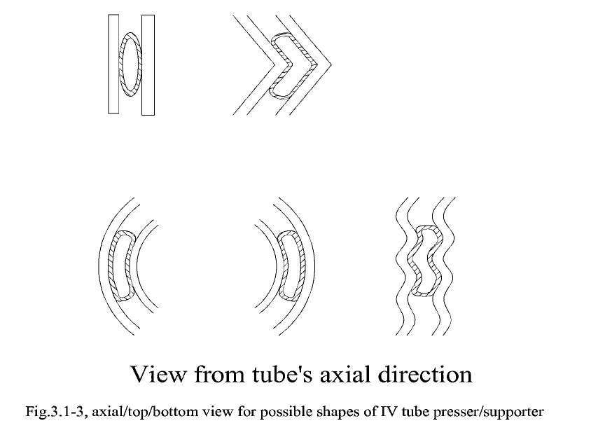

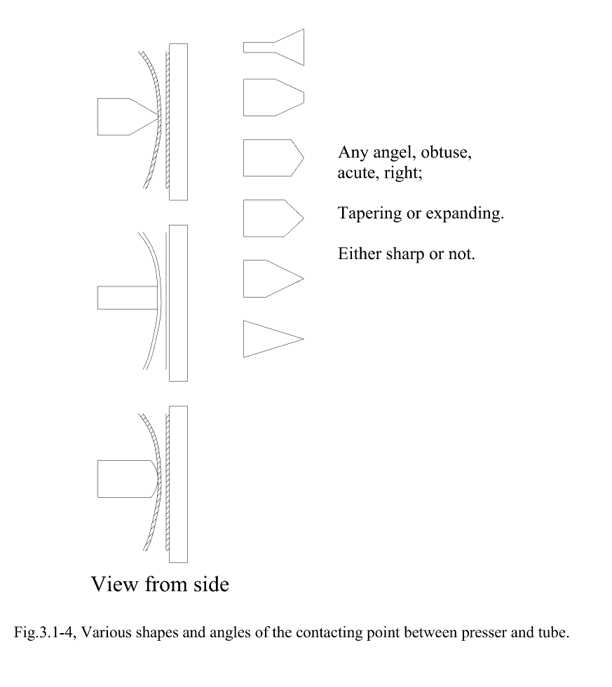

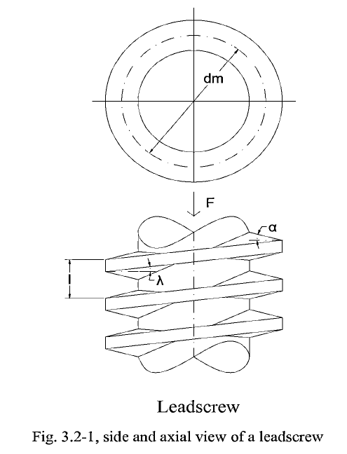

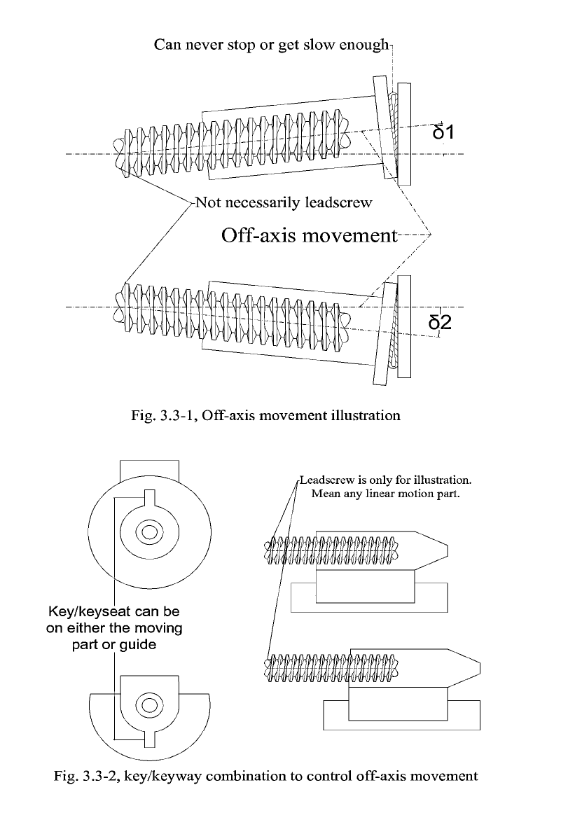

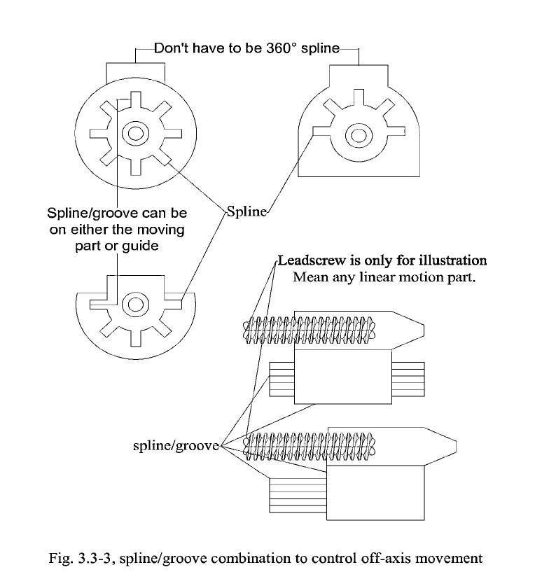

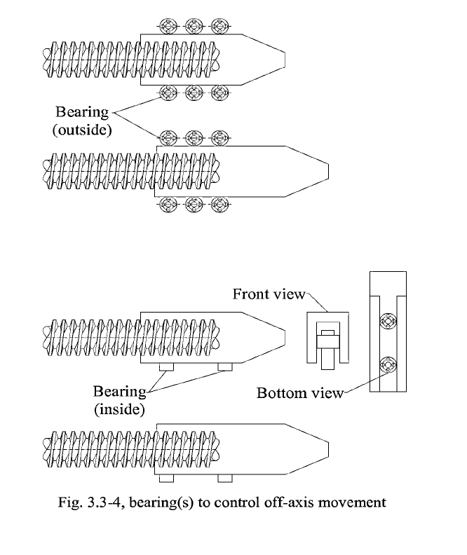

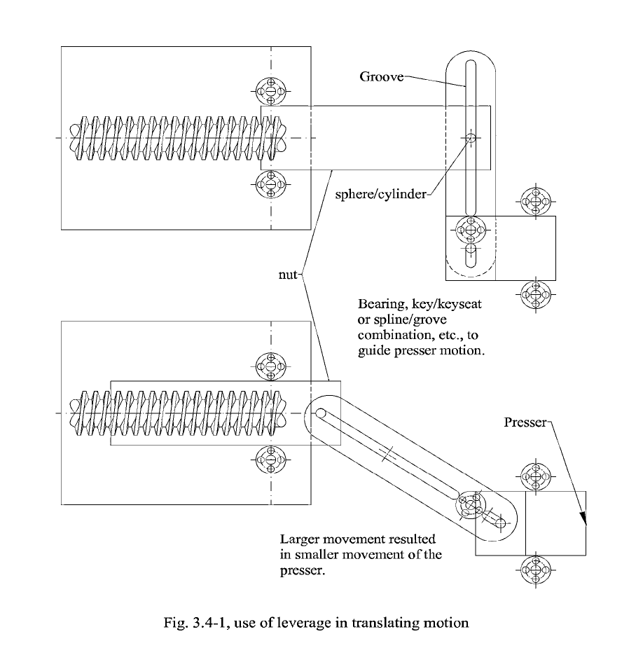

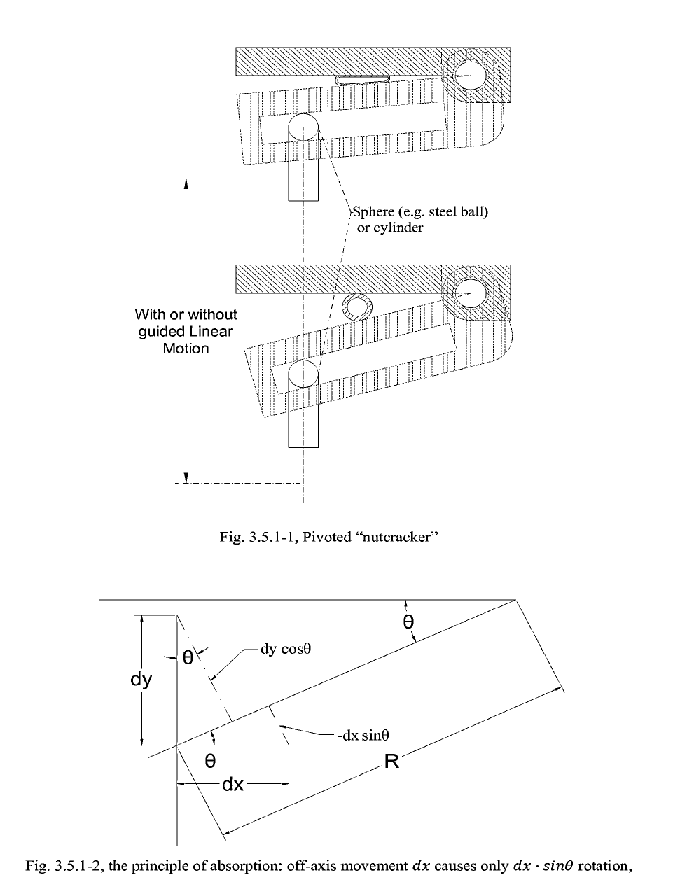

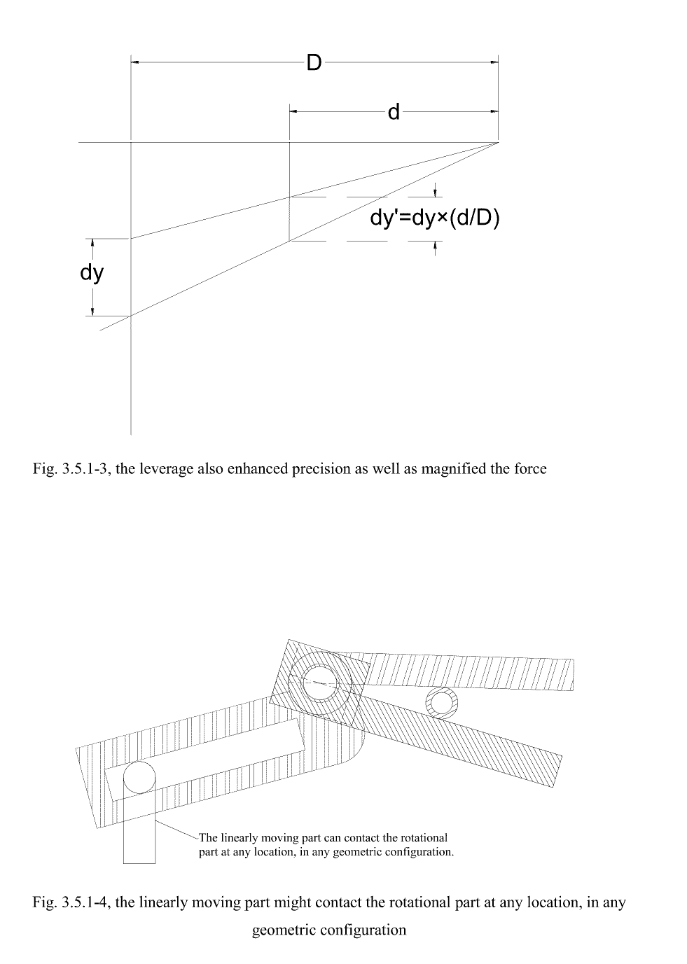

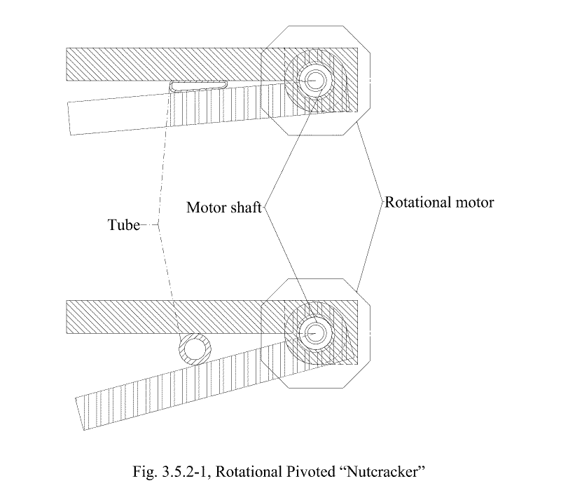

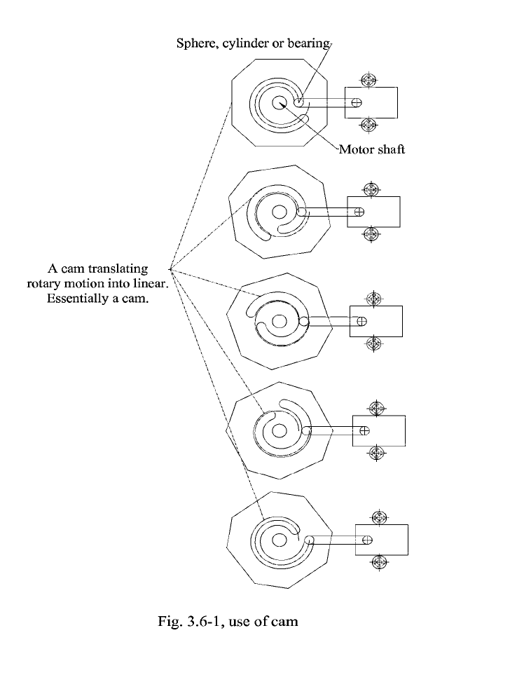

FIG. 3-1 shows a general schematic of the mechanical control system

FIG. 3.1-1 shows IV speed adjuster used for manual adjustment

FIG. 3.1-2 shows side or front view for possible shapes of IV tube presser/supporter

FIG. 3.1-3 shows axial/top/bottom view for possible shapes of IV tube presser/supporter

FIG. 3.1-4 shows shape, edge, angle and ways of contact between IV tube, presser and supporter.

FIG. 3.2-1 shows side and axial view of a leadscrew

FIG. 3.3-1 shows off-axis movement illustration

FIG. 3.3-2 shows key/keyway combination to control off-axis movement

FIG. 3.3-3 shows spline/groove combination to control off-axis movement

FIG. 3.3-4 shows bearing(s) to control off-axis movement

FIG. 3.4-1 shows use of lever in translating motion

FIG. 3.5.1-1 shows the pivoted “nutcracker”

FIG. 3.5.1-2 shows the principle of off-axis movement can be absorbed by the pivoted “nutcracker.

FIG. 3.5.1-3 shows the leverage of the pivoted “nutcracker.

FIG. 3.5.1-4 shows the linearly moving part might contact the rotational part at any location, in any geometric configuration.

FIG. 3.5.2-1 shows a rotational pivoted “Nutcracker”

FIG. 3.6-1 shows the use of cam

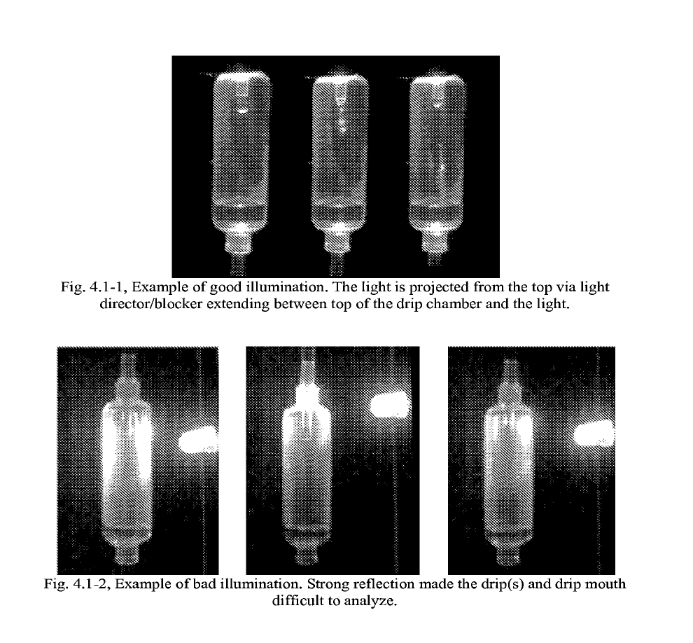

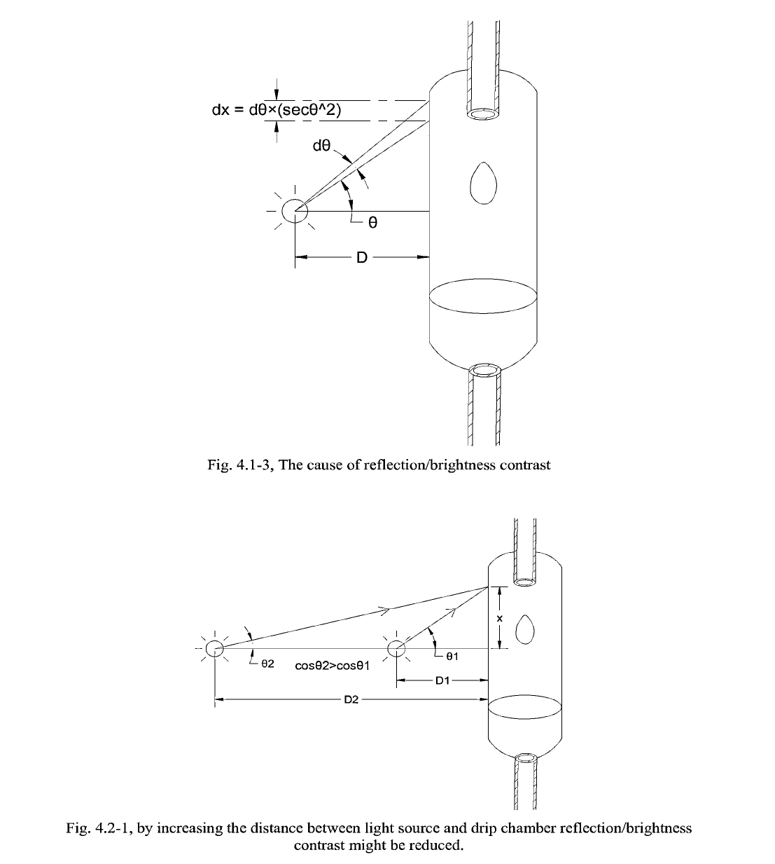

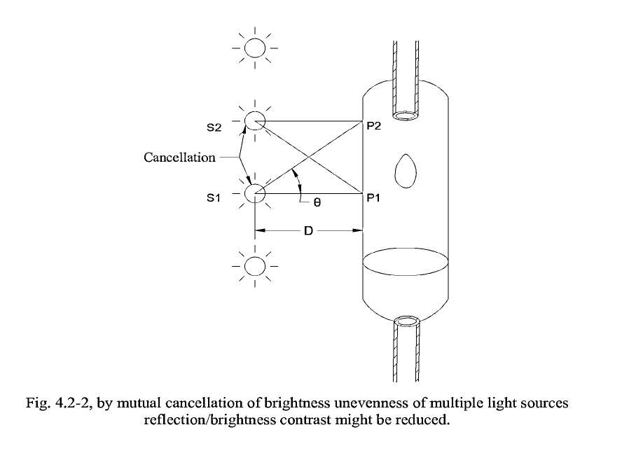

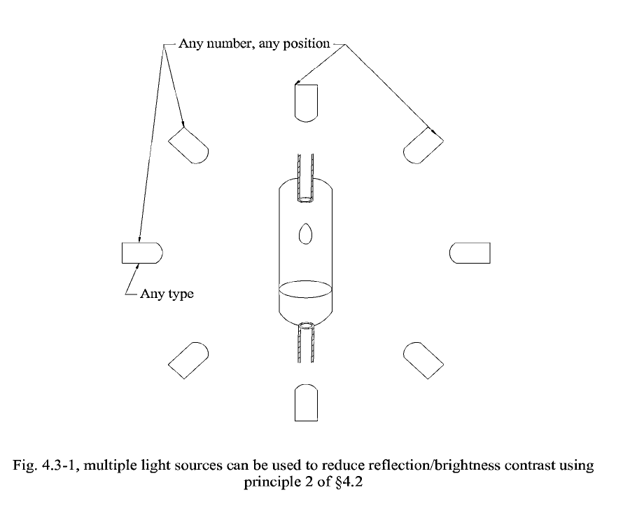

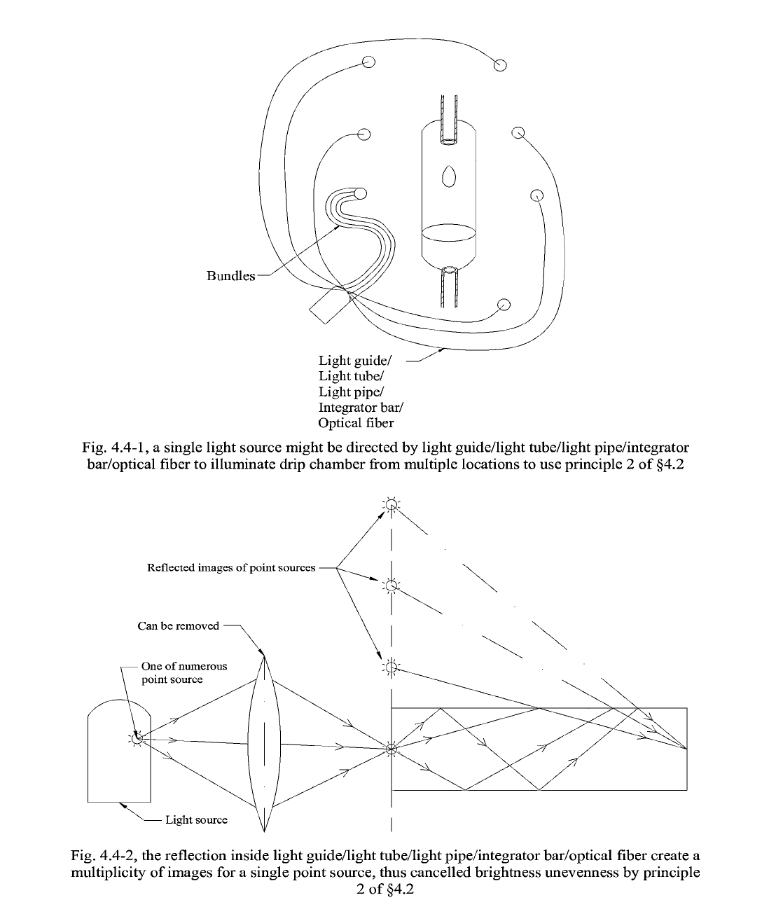

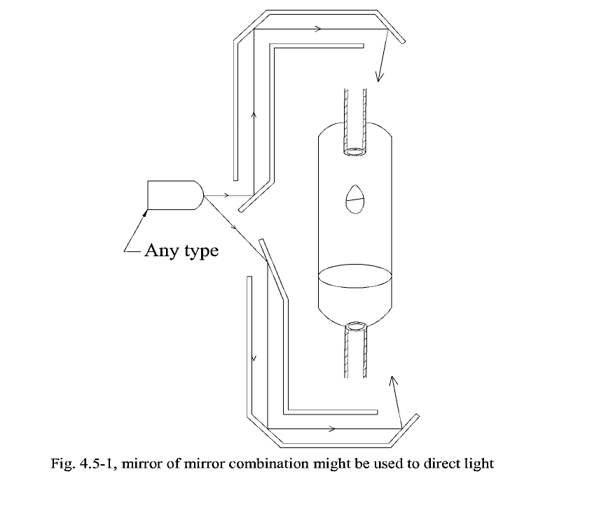

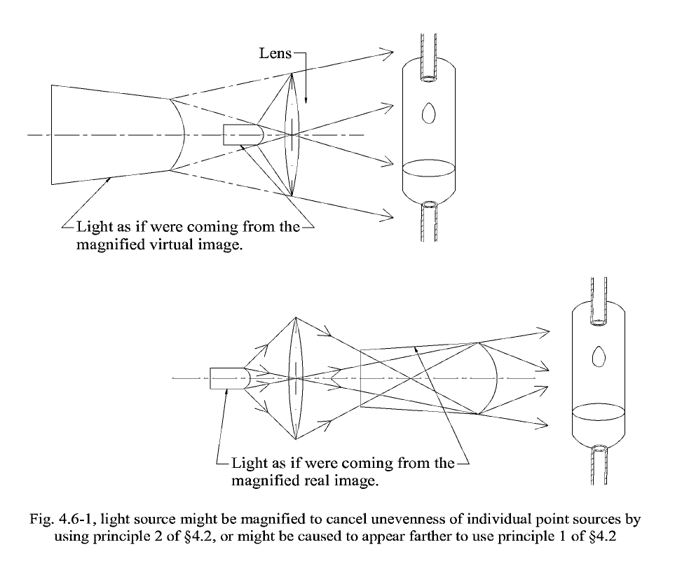

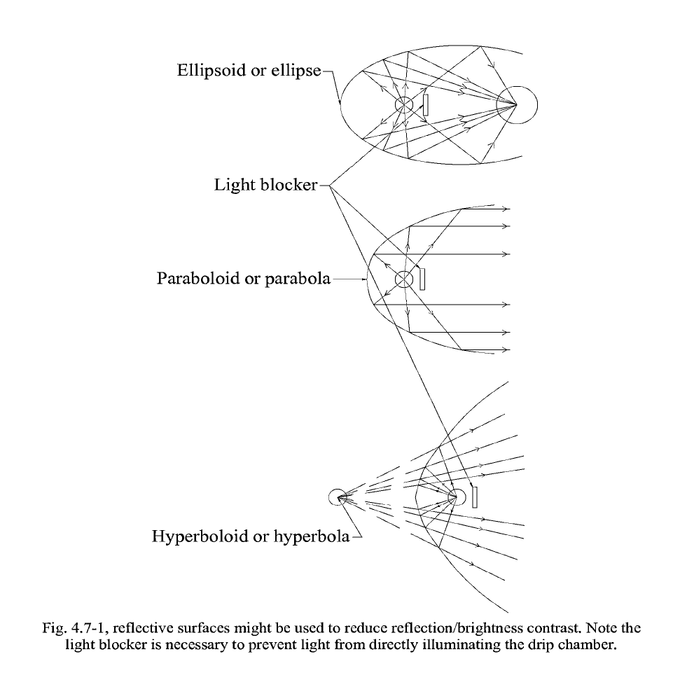

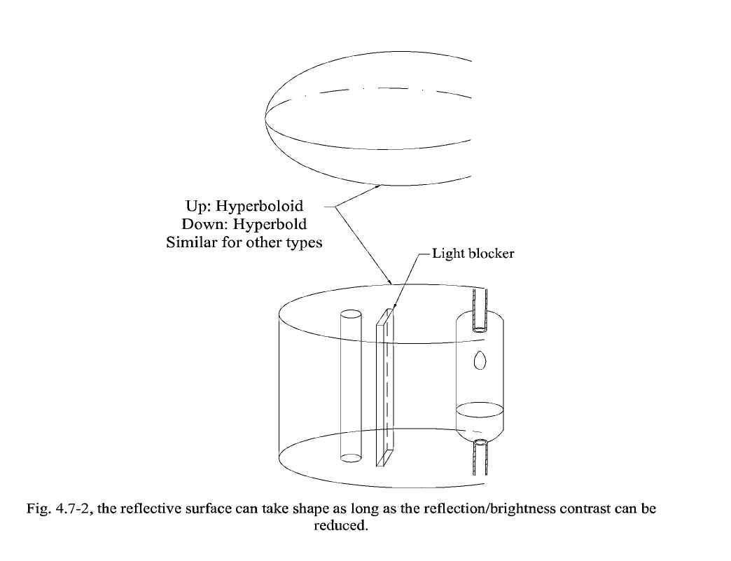

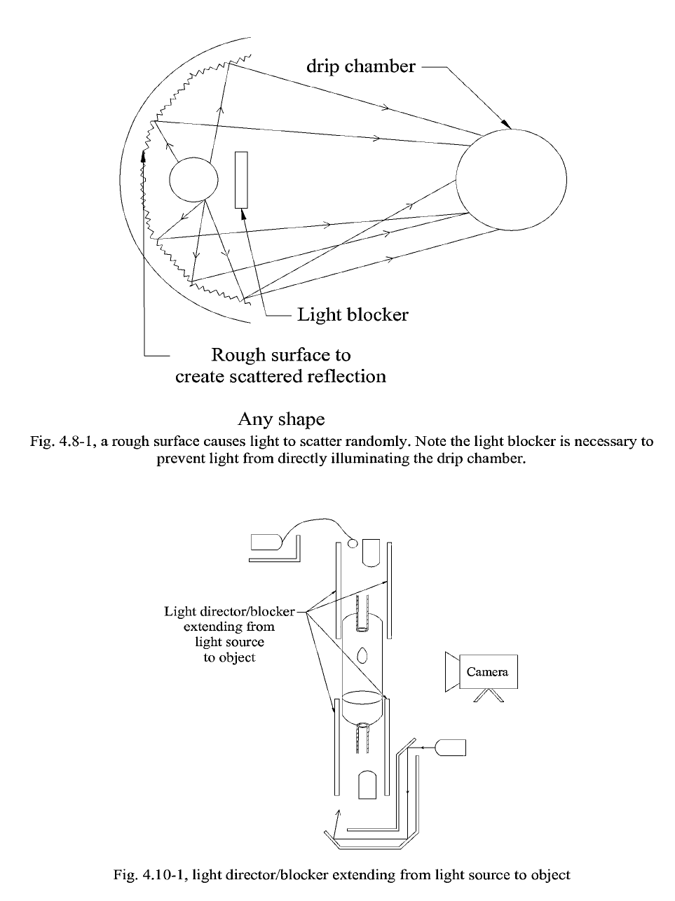

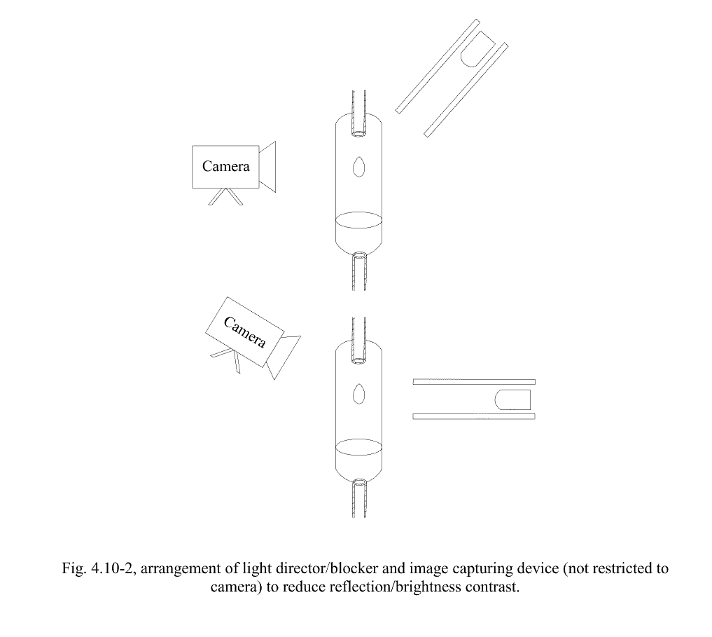

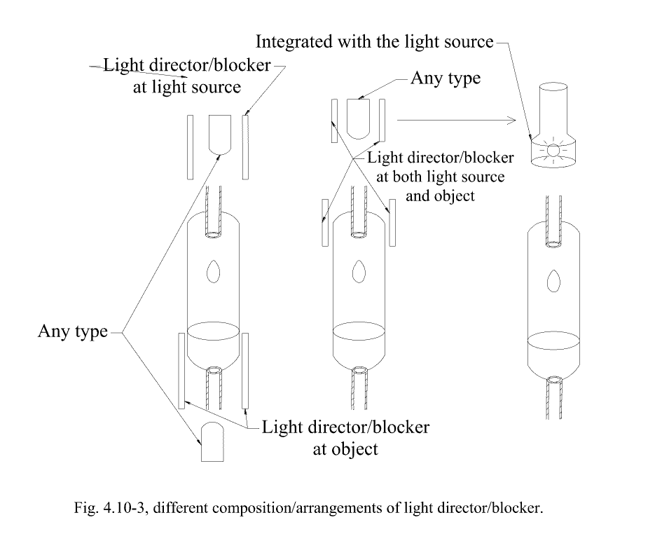

FIG. 4.1-1 shows example of good illumination

FIG. 4.1-2 shows example of bad illumination

FIG. 4.1-3 shows the cause of reflection/brightness contrast

FIG. 4.2-1 shows by increasing the distance between light source and drip chamber reflection/brightness contrast might be reduced.

FIG. 4.2-2 shows by mutual cancellation of brightness unevenness of multiple light sources reflection/brightness contrast might be reduced.

FIG. 4.3-1 show multiple light sources can be used.

FIG. 4.4-1 shows how a single light source might be directed by light guide/light tube/light pipe/integrator bar/optical fiber to illuminate drip chamber from multiple locations.

FIG. 4.4-2 shows the principle of light guide/light tube/light pipe/integrator bar/optical fiber in creating multiplicity of images for a single point source.

FIG. 4.5-1 shows mirror of mirror combination might be used to direct light

FIG. 4.6-1 shows how light source might be magnified to cancel unevenness of individual point sources.

FIG. 4.7-1 shows how reflective surfaces might be used to reduce reflection/brightness contrast.

FIG. 4.7-2 shows the reflective surface can take different ways of formation and shapes.

FIG. 4.8-1 shows how a rough surface might be used to cause light to scatter randomly.

FIG. 4.10-1 shows light director/blocker extending from light source to object

FIG. 4.10-2 shows light director/blocker and image capturing can be arranged in any relative position as long as reflection/brightness contrast in the view of the image capturing device can be reduced.

FIG. 4.10-3 shows light director/blocker can be put in different places.

### REFERENCE NUMERALS

Not used

### DETAILED DESCRIPTION

### 0. Introduction

The methods and apparatus for all aspects of a complete automatic IV monitoring and controlling system are given in this disclosure which expands on the scope of my previous applications and completes them:

1. application U.S. Ser. No. 12/825,368: IV Monitoring by Digital Image Processing

2. application U.S. Ser. No. 12/804,163: IV Monitoring by Video and Image Processing

3. application U.S. Ser. No. 13/019,698: Electromechanical system for IV control

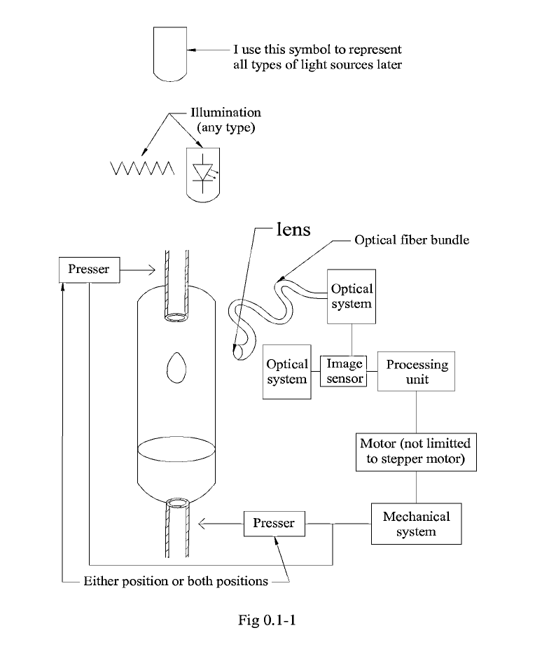

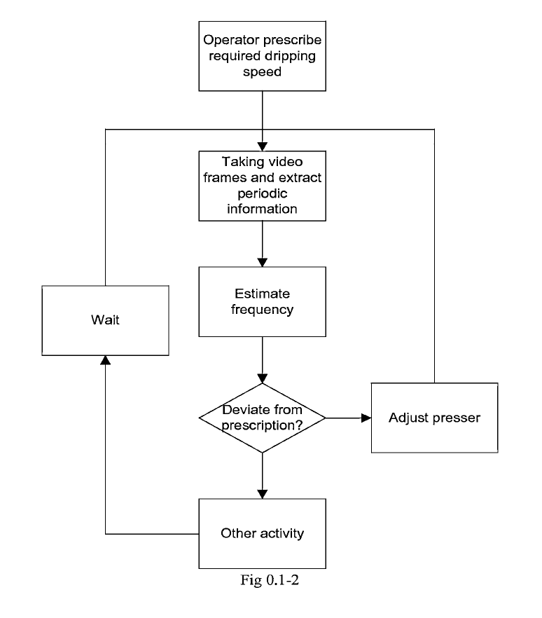

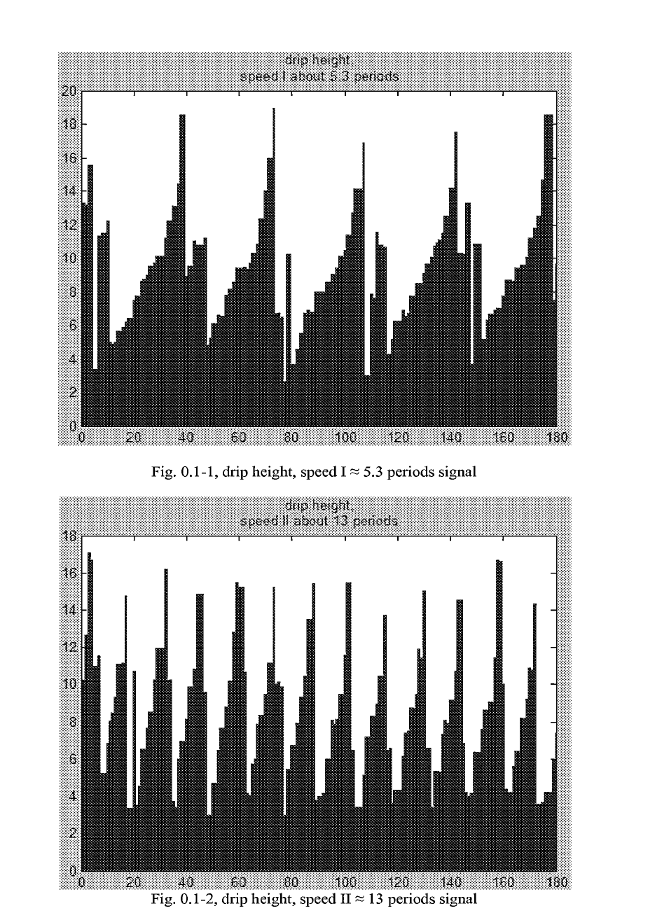

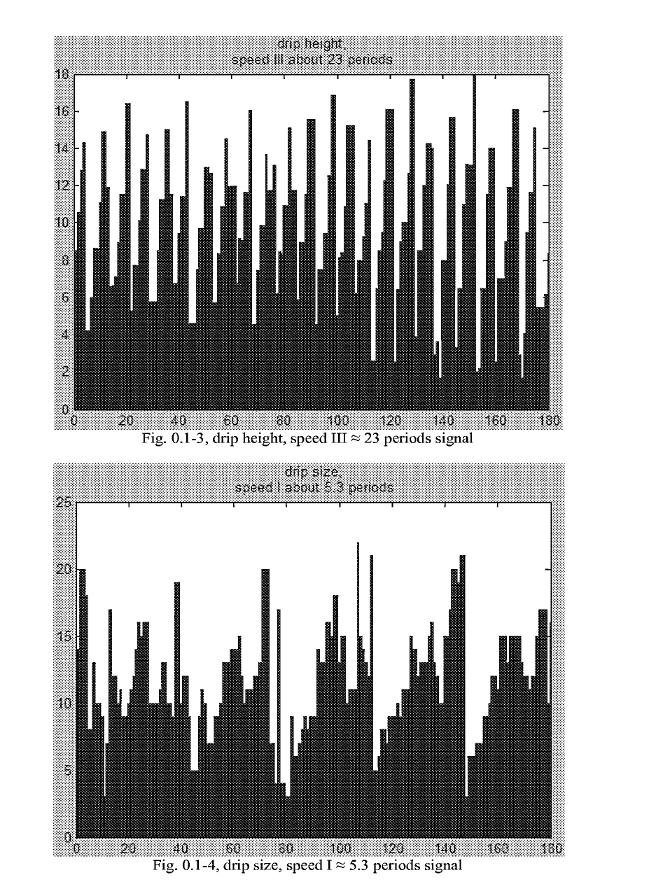

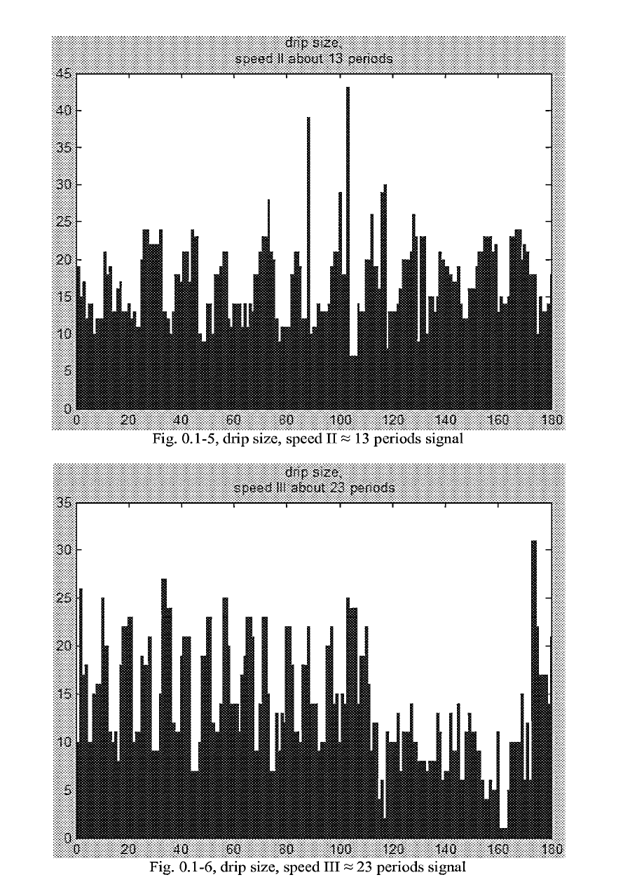

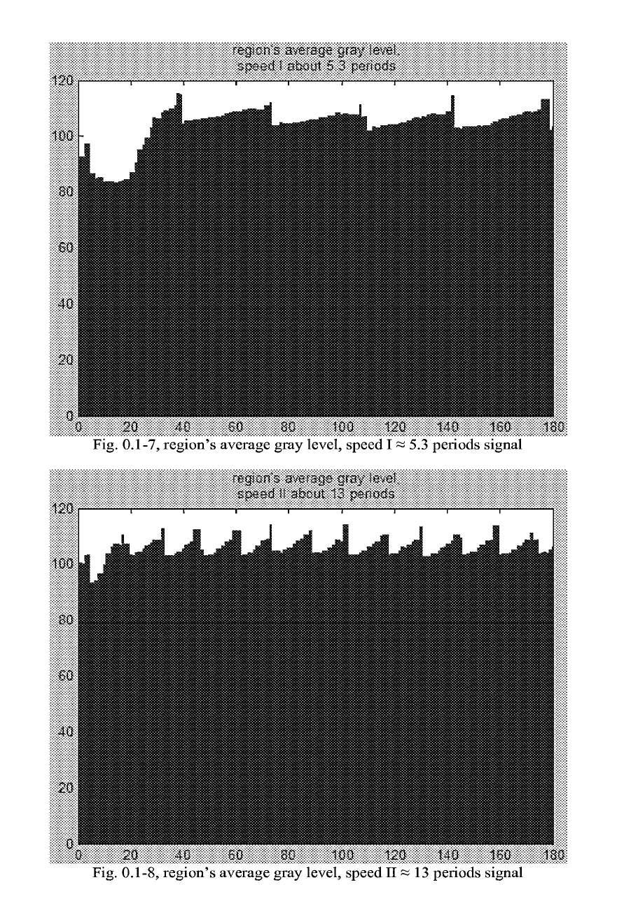

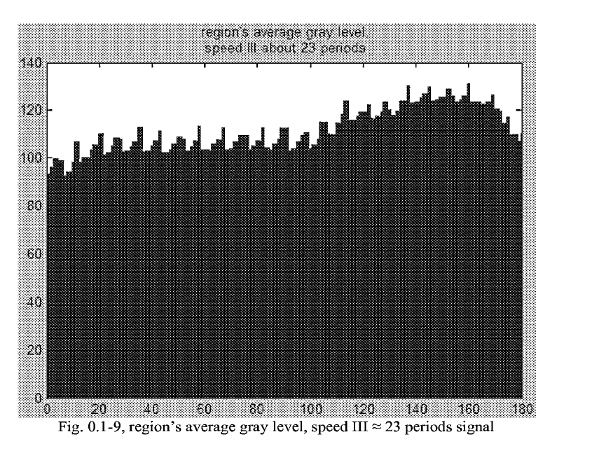

A schematic for the whole system is shown in FIG. 0.1-1 which comprises subsystem of illumination, subsystem of image capturing, processing and frequency estimation and subsystem of mechanical control.

In §1 Image Processing we are going to disclose a large number of image processing techniques for our application.

In §2 Frequency Estimation we are going to disclose a large number of frequency estimation techniques for counting period from periodic measurements. It covers all classes of known techniques by giving at least one example in each class.

In §3 Mechanical Control we disclose a wide variety of mechanisms and principles for effectively controlling the dripping rate.

In §4 Illumination we disclose techniques for properly illuminating the drip chamber so that reflections and other defects would not interfere with object we are observing.

A brief flowchart of the monitoring and control process is giving in FIG. 0.1-2.

0.1 Datasets

This part expands on application U.S. Ser. No. 12/804,163, and experiments in this disclosure would be extracted from the same video monitoring data of the IV dripping processes as used in application U.S. Ser. No. 12/804,163 (there might exist some slight differences due to unobserved changes in experiment environment). The length, frame rate, dripping speed and signal type is shown in the following table.

TABLE 0.1-1
Dataset Description

| | |
|---|---|
| Samples (N) | 180 |
| Sample per second | 15 |
| Time length | 12 sec |
| Speed | I: ≈5.3 periods |
| | II: ≈13 periods |
| | III: ≈23 periods |
| Type | drip height, |
| | drip size, |
| | region's average gray level |

There are therefore a total of 3×3=9 different datasets, and they are all listed in Table 0.1-1 and plotted in FIG. 0.1-1 to FIG. 0.1-9.

0.2 Notations

Due to the multiplicity of algorithms described in this disclosure and the multiplicity of datasets, enumerating individually each of their combinations would be laborious and would result in lengthy description. We therefore prefer to use the standard set notation such as: { }: Inclusion

x: Cartesian product

### Ø: Empty set

among others.

For example, {method A, method B}×{data I, data II} would mean applying each of the two methods on each of the two datasets, which can also be denoted by {(method A, data I), (method A, data II), (method B, data I), (method B, data II)}.

These are knowledge of high school math so anyone skilled in the field of art is assumed to be familiar with them.

### 1. Image Processing

The techniques disclosed here are extensions to techniques disclosed in application U.S. Ser. No. 12/804,163. We are going to show that for video/image captured for monitoring an IV process, there are still many other techniques can be used to process the images.

1.1 Review of Image Processing Techniques in application U.S. Ser. No. 12/804,163

We first review the techniques for image processing disclosed in application U.S. Ser. No. 12/804,163. FIG. 1.1-1A shows an image of an IV drip chamber, and in FIG. 1.1-1B we use a rectangle close to the dripping mouth to specify the area where the image processing will be taken on. The purpose of choosing an area close to the drip mouth is primarily to enable processing with low resolution, low frame-rate image capturing device and low speed processor. Real implementation could monitor any area if periodicity signal can be extracted.

FIG. 1.1-2A shows a vertical Sobel gradient operator, FIG. 1.1-2B shows a vertical Prewitt gradient operator and FIG. 1.1-2C shows a Laplacian operator.

An image of the dripping process is shown in FIG. 1.1-3 along with its Sobel, Prewitt and Laplacian gradient. Note that for Sobel and Prewitt gradient, we were taking sum of the absolute values of both the vertical and horizontal result:

|Gradient|=|Gₓ|+|G_{y}|

which is a standard practice in the field.

The purpose of applying these image enhancement techniques was to highlight important features for subsequent processing, and in this particular example gradient operation highlighted the drip from its background.

FIG. 1.1-4A to D show image processing steps for four images in a sequence. In each of the subfigure, for example FIG. 1.1-4A, the upper left is the original image with the index in the sequence shown in the title, and in upper right we show the example of applying Sobel gradient (vertical+horizontal). The lower left applies Otsu's thresholding method on Sobel gradient result and converted a gray level image to a binary image. In the lower right, we first erode the thresholded result and compute its connected components.

Important information are extracted from the connected components. In the titles of each of FIGS. 1.1-4A to D's lower right image, the first number shows the number of connected components, the second number shows the size of the maximum connected component measured in the number of pixels, and the third number shows the average height of the y coordinate of the maximum connected component with y increases from top to bottom in the image.

If we examine 1.1-4A to D, we could immediately verify that each step of processing improves the quality of the image and the results are always consistent with our visual inspection. After processing a total number of 180 images from a low-resolution camera with frame rate 15/sec for 12 seconds, the graph for maximum connected component's y coordinate is shown in FIG. 1.1-6A along with its DFT in FIG. 1.1-6B. The graph for size of the maximum connected component is shown in FIG. 1.1-7A along with its DFT in FIG. 1.1-7B.

We see that for both maximum connected component's height and drip signal, DFT both recognized the correct number of periods by the index of the non-DC component with the maximum DFT magnitude.

And if we compare FIG. 1.1-6A and FIG. 1.1-7A, we see that although the signal of maximum connected component's size is much less obvious in showing a periodic pattern than the signal of its height, DFT result still recognizes exactly the same number of periods from the both.

In FIG. 1.1-8A we show for the same image sequence a signal extracted by very crude, most simplistic and very improbable a means for extracting a meaningful signal: simply taking the average of all pixels' gray level value. Not a single image processing technique has been applied, yet the signal FIG. 1.1-8A still shows regular periodic pattern and its DFT in FIG. 1.1-8B also recognizes the correct period count.

Please also refer to application U.S. Ser. No. 12/804,163 for experiments with image sequence from dripping process of other speeds.

What has been revealed by the success of period counting for:
1. Drip height signal, arguable the best and most characteristic signal of dripping periodicity
2. Drip size signal, a signal moderately characteristic (or some might think it is the worst, as FIG. 1.1-7A might suggest)
3. Area's average gray level signal (or some might rank it as a moderately characteristic signal, as FIG. 1.1-8A might suggest), although in our example showing good periodicity, arguably from the fact that it lacks all processing steps perhaps would be the least characteristic/worst signal under other shooting environments.
   By [best, moderate, worst], we cover by giving examples in the extremes and middle of the whole spectrum of numerous ways of extracting a periodic signal from the IV dripping process, and proved with accurate results from the examples that any periodic signal could be used to detect the number of periods for the IV dripping periods.

Whereas the techniques introduced in application U.S. Ser. No. 12/804,163 are powerful and sufficient, there are still alternatives we will show in this disclosure.

### 1.2 Gray Level Transformation

Gray level transformations are among the simplest of all image enhancement techniques. Please refer to [Ch. 3, Gonzalez, R. C., Woods, R. E., Digital Image Processing, 2ed, Prentice Hall, 2002] for discussion.

### Definition:

Denote the value of pixel before transformation as x, transformation function as T ( ), value after transformation as y, gray level transformation transfer x to y by the relation y=T (x).

### 1.2.1 Power-Law Transformation

The basic form of power-law transformation is

y=T(x)=cx^{p}

In which c and p are usually taken to be positive values, but the possibilities of negative values are not ruled out.

It is also sometimes written as

y=T(x)=c(x+ε)^{p}

where ε is an offset added to x.

x would usually be normalized to [0,1], and ideally c(x+ε)^{p} would also map [0,1] to [0,1], but in practice this does not need to be strictly observed.

To get an idea of how power law transformation applies to images captured during an IV process, refer to FIG. 1.2.1-1. The left-up corner shows an unprocessed image (21 means it is the 21^{st} image in a sequence). Sobel, Prewitt and Laplacian gradient results are shown in the 2^{nd}, 3^{rd} and 4^{th} columns. We applied power law transformation y=5x⁴ and the result is in the 1^{st} row, 5^{th} column. The brighter part, which in the image is the drip due to light reflection, has been enhanced, and the background has been suppressed. This made it easier for following processing steps.

Note that before applying power-law transformation, we need to

1. Normalize pixels to [0,1].

2. Apply transformation.

And convert to the original range (in our example we just truncate) in the last step.

FIG. 1.2.1-2 shows the ensemble result of power-law transformation with thresholding, erosion discussed in application U.S. Ser. No. 12/804,163. The lower-left image show thresholding result, and the lower-right image is the result after erosion so that smaller parts are removed. From the lower-right image, the vertical location and height of the drip is extracted by finding the maximum connected components in the image, and would be stored into a vector. We could clearly see in the processing steps how the extracted information matches well with our visual interpretation.

FIG. 1.2.1-3 shows how dripping speed is measured from the drip height. The upper part shows the change of drip height extracted with y=5x⁴ transformation for image enhancement, from which we count 13 periods; the lower part shows its DFT transform, and the maximum non-DC component is at X=13, so that 13 periods can be determined

FIG. 1.2.1-4 shows how dripping speed is measured from the drip size. The upper part shows the change of drip size extracted with y=5x⁴ transformation for image enhancement, from which we count 13 periods; the lower part shows its DFT transform, and the maximum non-DC component is at X=13, so that 13 periods can be determined

We have also verified that using y=5x⁴ in conjunction with Otsu thresholding, erosion and maximum connected component produces correct periodic drip height and size signal for all speeds I, II and III. From the resultant drip height and size signal DFT recognizes the correct period count.

### 1.2.2 Exponentiation Transformation

### Common Synonym: Inverse-Log Transformation

Yet another type of simple gray-level transformation is exponentiation transformation, which is also called inverse-log transformation since log and exponentiation are the inverse.

The basic form of exponentiation transformation is

y=T(x)=c·[a^{x}−ε]

Where a is positive and usually greater than one. c is also usually a positive number.
x would usually normalized to [0, 1], and ideally c·[a^{x}−ε] would also map [0, 1] to [0, 1], but in practice this does not need to be strictly observed.

Refer to FIG. 1.2.1-1, in the 6^{th} image of the 1^{st} row we used exponentiation transformation y=5·[3^{x}−2], which show result different from power-law transformation and Sobel, Prewitt and Laplacian gradient results. The contrast the image is stronger than other types of enhancements, and the brightest part location matches the location of the drip.

In FIG. 1.2.2-1, the upper-right image in each group-of-4 subfigure shows y=5·[3^{x}−2] result, and the lower-left its thresholding result, the lower-right the erosion result on which drip height and size is extracted using from maximum connected component. It is clearly that the results are accurate.

FIG. 1.2.2-2 upper part is the drip height data over 180 samples, and the lower its DFT result. Its largest non-DC component is at X=13, indicating 13 periods; FIG. 1.2.2-3 upper part is the drip size data over 180 samples, and the lower its DFT result. Same period count as drip height signal is given by DFT.

It has been tested that gray-level y=5·(3^{x}−2) give correct periodic drip height signal when works in conjunction with Otsu threshold, erosion and maximum connected components for all speeds I, II and III. From the resultant drip height signal DFT gives the correct period count.

### 1.2.3 Piecewise-Linear Transformation and Look-Up Table

### Common Synonym:

Piecewise-linear function transformation, as described in [§3.2.4, Gonzalez, R. C., Woods, R. E., —Digital Image Processing (2ed)], is a method complementary to other gray-level transformation techniques with the advantage that it can approximate arbitrarily complex function. All previous can be implemented by using it. In hardware implementation, it is equivalent to what is normally called “look-up table”.

We have already shown in power-law transformation that y=5x⁴ worked. We use five linear segments to interpolate this function:

TABLE 1.2.3-1
end and intermediate points for linearly interpolating y = 5x⁴ in [0, 1].

| X | Y |
|---|---|
| 0.0 | 0.0 |
| 0.2 | 0.008 |
| 0.4 | 0.128 |
| 0.6 | 0.648 |
| 0.8 | 2.048 |
| 1 | 5.0 |

Pixels values will first be normalized to [0,1] and then interpolated within the segment it falls in. The function graph is shown in FIG. 1.2.3-1 and result of sharpened images are shown in FIG. 1.2.3-2 for five images. Values outside [0, 1] are simply truncated before converting back to the original pixel range. In each image we also put the original y=5x⁴ result with the interpolated result and we could see how closely they two matched.

Comparing with power-law, exponentiation and log, piece-wise transformation has the advantage that they can be implemented with look-up table which are quicker than calculation on-the-fly. It is therefore recommended as the actual implementation for these methods on products.

Of course, look-up tables can also be constructed such it doesn't seem to have been generated from any of the particular family of functions we exampled above. However, the essence of look-up tables is a mapping function, so no type of look-up table has any substantial difference from our examples.

We have also verified that using the 5-segment piece-wise linear transformation y=5x⁴ in conjunction with Otsu thresholding, erosion and maximum connected component produces correct periodic drip height and size signal for all speeds I, II and III. From the resultant drip height and size signal DFT gives the correct period count.

### Summary on Gray-Level Transformation

The difference between gray-level transformation and other spatial domain image enhancement techniques is:
1. Gray-level transformation is based on the value of each pixel itself alone.
2. Other types of spatial domain image, particularly various gradients, compute the new pixel value as a function of itself and its neighbor's values.

By combining this disclosure and application U.S. Ser. No. 12/804,163, we have therefore convincingly demonstrated that image enhancement techniques based on both pixel's value alone and pixel and its neighbors' value can be used in our application.

There are variations which has no substantial difference from what we have disclosed:
1. For power-law transformation y=T(x)=c(x+ε)^{p}, p<1 is also possible which gives a different value mapping than p>1. If the image captured by different image capturing devices and shooting environment has characteristics for which p<1 is better suited, then clearly p<1 can be used.
2. The inverse of exponentiation is the log transformation which is usually defined as y=c log(x+1), can also be used, for the same reason as (1) above.

We therefore conclude that Gray-level transformation as a general class of techniques, can be used in the processing steps of a video/image processing based IV monitoring system. No other techniques fall in this class could have any substantial difference with our disclosed methods.

### 1.3 Frequency-Domain Processing

Frequency Domain techniques are frequently used in image processing. They work by first transforming the image into its frequency domain representation, apply processing techniques and inverse-transform the result into spatial domain.

Please refer to [Ch. 4, Gonzalez, R. C., Woods, R. E., Digital Image Processing, 2ed, Prentice Hall, 2002] for discussion.

### Definition:

Define an digital image as P_{(a,b)}, 0≦a≦M−1, 0≦b≦N−1, and make periodic extension to coordinates outside [0, M−1]×[0, N−1] so that

P₍ₐ₊ₖ_{₁}_{M,b+k}_{₂}_{N})=P_{(a,b)}

in which both k₁ and k₂ are integers.

Periodic extension enables us to define periodic convolution

$${( P * G )}_{( a , b )} = {\sum }_{i = 0}^{M - 1} {\sum }_{j = 0}^{N - 1} ( {P}_{( i , j )} \cdot {G}_{( a - i , b - j )} ) = {\sum }_{( i , j ) = ( 0 , 0 )}^{( M - 1 , N - 1 )} {P}_{( i , j )} \cdot {G}_{( a , b ) - ( i , j )}$$

This is important because only with periodic extension could we theoretically prove the important theorem:

### Theorem I:

The 2D-DFT of the convolution of image P and G equals the product of their respective 2D-DFT. This is proved below:

$$\begin{matrix}\begin{matrix}{F ( P * G )}_{( I , J )} = {\sum }_{a = 0}^{M - 1} {\sum }_{b = 0}^{N - 1} {{e}^{- j ( \frac{2 π}{M} I \cdot a + \frac{2 π}{N} J \cdot b )} ( P * G )}_{( a , b )} \\ = {\sum }_{( a , b ) = ( 0 , 0 )}^{( M - 1 , N - 1 )} {{e}^{- j ( \frac{2 π}{M} I \cdot a + \frac{2 π}{N} J \cdot b )} ( P * G )}_{( a , b )} \\ = {\sum }_{( a , b ) = ( 0 , 0 )}^{( M - 1 , N - 1 )} {{e}^{- j \cdot 2 π ( \frac{I}{M} , \frac{J}{N} ) \cdot ( a , b )} ( P * G )}_{( a , b )} \\ = {\sum }_{( a , b ) = ( 0 , 0 )}^{( M - 1 , N - 1 )} ( {e}^{- j \cdot 2 π ( \frac{I}{M} , \frac{J}{N} ) \cdot ( a , b )} \cdot {\sum }_{( i , j ) = ( 0 , 0 )}^{( M - 1 , N - 1 )} {P}_{( i , j )} \cdot {G}_{( a , b ) - ( i , j )} ) \\ = {\sum }_{( a , b ) = ( 0 , 0 )}^{( M - 1 , N - 1 )} ( {\sum }_{( i , j ) = ( 0 , 0 )}^{( M - 1 , N - 1 )} {e}^{- j \cdot 2 π ( \frac{I}{M} , \frac{J}{N} ) \cdot ( a , b )} {P}_{( i , j )} \cdot {G}_{( a , b ) - ( i , j )} ) \\ = {\sum }_{( a , b ) = ( 0 , 0 )}^{( M - 1 , N - 1 )} ( \begin{matrix}{\sum }_{( i , j ) = ( 0 , 0 )}^{( M - 1 , N - 1 )} ( {e}^{- j \cdot 2 π ( \frac{I}{M} , \frac{J}{N} ) \cdot ( i , j )} \cdot {P}_{( i , j )} ) \cdot \\ ( {e}^{- j \cdot 2 π ( \frac{I}{M} , \frac{J}{N} ) \cdot ( a , b ) - ( i , j )} {G}_{( a , b ) - ( i , j )} )\end{matrix} ) \\ = {\sum }_{( i , j ) = ( 0 , 0 )}^{( M - 1 , N - 1 )} ( {e}^{- j \cdot 2 π ( \frac{I}{M} , \frac{J}{N} ) \cdot ( i , j )} \cdot {P}_{( i , j )} ) \cdot \\ ( {\sum }_{( a , b ) = ( 0 , 0 )}^{( M - 1 , N - 1 )} {e}^{- j \cdot 2 π ( \frac{I}{M} , \frac{J}{N} ) \cdot ( a , b ) - ( i , j )} {G}_{( a , b ) - ( i , j )} ) \\ = {\sum }_{( i , j ) = ( 0 , 0 )}^{( M - 1 , N - 1 )} ( {e}^{- j \cdot 2 π ( \frac{I}{M} , \frac{J}{N} ) \cdot ( i , j )} \cdot {P}_{( i , j )} ) \cdot F ( G ) \\ = F ( G ) \cdot {\sum }_{( i , j ) = ( 0 , 0 )}^{( M - 1 , N - 1 )} ( {e}^{- j \cdot 2 π ( \frac{I}{M} , \frac{J}{N} ) \cdot ( i , j )} \cdot {P}_{( i , j )} ) \\ = F ( G ) \cdot F ( P )\end{matrix} & \\ \begin{matrix}∴ \\ P * G = {F}^{- 1} ( F ( P * G ) ) = {F}^{- 1} ( F ( G ) \cdot F ( P ) )\end{matrix} & \end{matrix}$$

In practice the size of commonly used spatial domain filters are usually small. For example, the standard Sobel, Prewitt and Laplacian gradients used in application U.S. Ser. No. 12/804,163 are only of dimension 3×3. Therefore, whether we use periodic extension of digital images and consequently in convolution definition would only affect pixels at the very margin, of which we seldom have big interests in.

The above theorem means that the effect of each spatial domain filter using the periodic extension definition can be achieved via frequency domain multiplication.

The process of doing Sobel vertical filtering in frequency is shown in FIG. 1.3-1:
1. Take DFT of the original image. Shown in FIG. 1.3-1 lower left is the shifted version which moved coordinate [0, 0] to center, which is a convention in the field.
2. Spatial domain filters are typically arranged in (2k+1)×(2k+1) matrix and the weight corresponding to each image pixel itself is at the center (k+1, k+1). In spatial domain filtering it will be directly “masked” on the original image, multiply with underlying pixel and take the sum; However, since only convolution has a direct frequency-domain counterpart but not masking, we need to change it to equivalent convolution first:
   I. Swap pixels of the original spatial domain filter first upside-down, and then left side-right, or equivalently, symmetric about center (k+1, k+1). This is shown in FIG. 1.3-2. Note that in FIG. 1.3-2 left side-right swap has no effect since vertical Sobel gradient is already horizontally symmetric.
   II. Create a new image of the same dimension as the original image, assign all pixels value zero, then shift (I) result so that center (k+1, k+1) is moved to the origin. For pixels that fall out of the boundary after shifting, mark their location and value and use periodic extension in III below.
   III. Use periodic extension as defined above to set pixels within the valid image region.
   IV. Take (III)'s DFT.
3. Multiply (2.IV) result with I's result.
4. Convert (3) result to spatial domain by taking its inverse Fourier transform.

Note that if we compare FIG. 1.3-1's 3^{rd} and 4^{th} image on the 1^{st} row, we would clearly see the effect of periodic extension on the upper and lower boundaries of the original image. Since this effect happens only at the boundaries, in most cases they can simply be dropped by setting boundary pixel values either to an arbitrary value such as 0, or a value derived from value of its neighboring pixels.

Please also note that due to the large range of DFT transformation, the 2^{nd} row of FIG. 1.3-1 are shown by first add a constant (10) to DFT's absolute value and then take the logarithmic scale. This is also standard practice in the field. Since each logarithmic image have a different range, the gray levels in different images should not be compared with other.

We have now established that each spatial domain filter can be achieved via frequency domain filter. In practice, we don't need to compute the DFT image of the filter each time when it is used, but can simply do that once and store the result for future uses.

We might also use filters directly designed in the frequency domain and this is also basic knowledge in the field. We show an example of using a high pass filter to enhance the image.

The high-pass filter we chose is

$$H ( I , J ) = \{ \begin{matrix}1 , & \vert I \vert > 1 or \vert J \vert > 1 \\ 0 , & \vert I \vert \leq 1 and \vert J \vert \leq 1\end{matrix}$$

A total number of 3×3=9 frequency domain coefficients will be removed. An example of its effect is shown in FIG. 1.3-3. Note that in image titles we might use shorthand (x, y) to denote the yₜₕ subfigure in the xₜₕ row.

The 2^{nd} image in the 1^{st} row shows logarithmic scale 2D DFT of the original image. The filtered and shifted spectrum is shown in the 3^{rd} image, which clearly has a dark/empty center due to the filter effect. The reconstructed image is shown in the 4^{th} image but rather dark and the scaled display is in 5^{th} image of the 1^{st} row, showing how contrast has been enhanced.

Various thresholding methods such as Otsu and iterative method still threshold the image nicely, so is constant value thresholding with a proper constant value (35 here, see FIG. 1.3-3).

The result on another image (31^{th} in the sequence) is shown in FIG. 1.3-4 and we clearly see that in this image following methods {Otsu, iterative method and constant thresholding with threshold value 35} also recognize the correct size and location of the drip.

We test and found that using frequency-domain equivalent of Sobel gradient filtering works for dripping speed of speed I≈5.3 periods, speed II≈13 periods, speed III≈23 periods video monitoring data, and can be used along with other methods to extract both drip height and drip size signal.

We have also verified that using the 3×3 high-pass frequency domain filter in conjunction with Otsu thresholding, erosion and maximum connected component produces correct periodic drip height and size signal for all speeds I, II and III. From the resultant drip height and size signal DFT recognizes the correct period count.

Please refer to FIG. 1.3-5 for the speed II drip height and size signal obtained by frequency-domain high-pass filtering followed by Otsu′ thresholding, erosion and maximum connected component.

We have therefore shown that

1. Spatial domain filtering can be achieved in frequency domain.

2. Filters designed purely in the frequency domain can also be used to enhance the image. and the demonstration on the applicability of frequency domain techniques is therefore complete.

Depending on the video and other factors, of course filters different than what we have using can be applied, but none of these constitute any substantial difference.

### 1.4 Wavelet Methods

We demonstrate the image enhancement can also be achieved using wavelet transform. The basic idea of wavelet transformation is multi-resolution. In 1-D case, at each level it computes a set of approximation coefficients and a set of differentiation coefficients; in 2-D case, the same idea of approximation and differentiation are still used.

We illustrate the usage with the simplest wavelet: the Haar wavelet. For an image of dimension 2M×2N, after each level of transformation and down-sampling, the new size would become ¼ of the original, namely M×N. The information of each 2×2 block in the original image would be now contained in four coefficients, shown below:

$$[ \begin{matrix}a & b \\ c & d\end{matrix} ] ⇒ \begin{matrix}\frac{a + b + c + d}{2} {c}_{average} \\ \frac{a + b - c - d}{2} {c}_{horizontal} \\ \frac{a + c - b - d}{2} {c}_{vertical} \\ \frac{a + d - b - c}{2} {c}_{diagonal}\end{matrix}$$

Observe the c_{horizontal} is essentially a vertical gradient taking at two upper and two lower pixels together, and c_{vertical} is essentially a horizontal gradient taking two left and two right pixels together, this similarity then suggest that they can be used in place of ordinary spatial domain gradients.

In example of FIG. 1.4-1, in each figure the 2^{nd} image on the upper row is the addition the absolute value off c_{horizontal} and c_{vertical}, namely

|c_{horizontal}|+|c_{vertical}|

They looks weak due if we compare them to Sobel gradient results, this is due to the ½ coefficient which is much smaller than Sobel gradient coefficients. The 3^{rd} in the 1^{st} row of each group show the same result displayed scaled to its range (min→0, max→255). However, following processing such as thresholding are still based on the original wavelet gradient results.

We see that the brightness at drip region has obvious been enhanced, despite some apparent noises. The 1^{st} and 2^{nd} image in the 2^{nd} row in each figure show Otsu thresholding and erosion results and the 3^{rd} image is the threshold given by iterative method (see §1.5.1), and drip size/height will from here be extracted using maximum connected components.

Though the change of drip height and size shown in the 2^{nd} image of the 2^{nd} row of each subfigure is not as obvious as extracted with methods in previous sections and application U.S. Ser. No. 12/804,163, for the illustrational speed II≈13 periods video, the periodicity in result can still be seen from FIG. 1.4-2. DFT determines the correct 13 periods' count for both drip height and size signal.

TABLE 1.4-1
a tick ✓ means the wavelet gradient result followed by
Otsu thresholding, erosion and maximum component
is accurate in that DFT gives the correct period count.

| | Drip height | Drip size |
|---|---|---|
| Speed I | ✓ | |
| Speed II | ✓ | ✓ |
| Speed III | | ✓ |

We have therefore demonstrated the use of wavelet transformation in the image processing step of our application. There are numerous different types of wavelets with different length and values, but none differs substantially from our example here.

### 1.5 Thresholding

Thresholding is one of the most basic image processing techniques. In application U.S. Ser. No. 12/804,163 we show that Otsu's method can be used to automatically detect threshold level. In this disclosure we are going to show other methods also work.

### 1.5.1 Iterative Method

### Common Synonym:

Iterative method finds a thresholding level L in an iterative process. Its implementation is simple, requiring no specific knowledge of the image and is robust against noise.

### Procedure:

1. Choose an initial value for L, for example, the average value of the image. Other reasonable values can also be chosen or even generated randomly.
2. Divide the pixels into two sets:
   S₁={P_{i,j}:P_{i,j}>L}
   S₂={P_{i,j}:P_{i,j}≦L}
3. Compute means of two sets
   m₁=mean(S₁)
   m₂=mean(S₂)
4. Generate new thresholding level guess

$${L}_{new} = \frac{{m}_{1} + {m}_{2}}{2}$$

5. If L_{new} equals L, then set L=L_{new}, exit;
   Otherwise, still set L=L_{new}, then jump to step 2.

Please not that if integer precision is used for L, then the equality might need to be adjusted to testing if the difference is smaller than a certain value, say, 1.

Experiment results on three images in the sequence of speed II≈13 periods video in FIG. 1.5.1-1 show that the method gives almost the same result as Otsu's methods on all images. Image are processed with Sobel vertical+horizontal thresholding first.

TABLE 1.5.1-1
Compare Iterative method and Otsu's method

| Frame Number. | Otsu's | Iterative method |
|---|---|---|
| 30 | 98 | 99 |
| 33 | 89 | 89 |
| 37 | 88 | 85 |
| 40 | 30 | 32 |
| 44 | 86 | 91 |

We have verified that the results produced by Iterative method after Sobel gradient, then followed by erosion and maximum connected component, gives drip height and size signal from which period count be correctly obtained by DFT for speed I, II and III video. The results for speed II≈13 periods are shown in FIG. 1.5.1-2.

Otsu's method is representative of the class of thresholding algorithms that uses histogram information; with iterative method, we have shown that automatic thresholding can also be done without explicitly using histogram information.

### 1.5.2 Arbitrary/Constant Threshold Level, Manually-Assigned Threshold Level

### Common Synonym:

We may also use a fixed thresholding level rather than using any automatic algorithms. In experiments shown in FIG. 1.5.2-1, a constant, manually assigned level of 91 is used. It is close in most images of the sequence to Otsu and Iterative method result expect for in image 40.

The following table shows that except for a few images, the constant threshold value matches Otsu and iterative method result very well. Differences in a few images do not change the overall periods count. We have verified that the results produced by constant 91 threshold after Sobel gradient, then followed by erosion and maximum connected component, gives drip height and size signal from which period count be corrected obtained by DFT for speed I, II and III video. The results for speed II≈13 periods are shown in FIG. 1.5.2-2.

TABLE 1.5.2-1
Compare constant level threshold with Otsu and Iterative method

| Image No. | Otsu | Iterative method | Constant |
|---|---|---|---|
| 30 | 98 | 99 | 91 |
| 33 | 89 | 89 | 91 |
| 37 | 88 | 85 | 91 |
| 40 | 30 | 32 | 91 |
| 44 | 86 | 91 | 91 |

In real implementation, we have control over illumination, reflection, camera exposure time as well as other techniques. Since on a built device these parameters are all fixed, it would reasonable to expect that we could always find a constant thresholding level that work for the application well.

### 1.5.3 Mean/Median or Other Simple Thresholding Method

### Common Synonym:

In FIG. 1.5.3-1 mean and median of image pixels as thresholding value are compared with Otsu threshold in each quadrant, also followed by erosion and maximum connected component. Although visually they do no convey very good information on the size and location of the drip, the final signal extracted after erosion and maximum connected component, have been found:
1. For mean threshold, drip height of speed I, II and III all give correct period count via DFT. The result for speed II is shown in FIG. 1.5.3-2.
2. For median threshold, only drip size of speed I≈13 periods, not others, give correct period count via DFT. The result for speed I is shown in FIG. 1.5.3-3.

The shortcoming of mean and median thresholding is that they are sensitive to noise. However, as we have shown in application U.S. Ser. No. 12/804,163, even the average value of the raw image without any preprocessing exhibit periodicity that enables correct period count, as long as signal generated through mean or median thresholding step preserves the same periodicity of the original signal, it could then be used to as a possible choice.

Moreover, whether or not a method works depends on the characteristics of the dataset. With better shooting devices, environment, parameters setting and other improvement, the noise in image could be drastically reduced, and it is would be reasonable to expect mean or median thresholding would work for the dataset.

### Summary on Thresholding

As one of the most basic operations in image processing, there are many different ways to do thresholding.

If we classify them into two broad classes:
(1) In the class of non-automatic thresholding methods, we have shown that constant or manually determined threshold value could work.
(2) In the class of automatic thresholding methods,
   a. For histogram based methods, we have demonstrated that Otsu's method could work. It would be reasonable to expect that other methods also work.
   b. For non-histogram based methods, we have shown that iterative method could work, and
      i. Even methods as simple as mean and median of the image could work depending on the quality of signal.

Although we haven't exhaust all methods, all other methods could be classified in to {(1), (2).a, (2).b, (2).b.i} classes, and in each class we have shown example(s). All other methods would not have significant differences from ours.

### 2. Frequency Estimation

In my previous application U.S. Ser. No. 12/804,163, I have shown the degree of liberty in the choice of measurements for obtaining a periodic signal. This disclosure will show the degree of liberty in the choice of algorithms for frequency estimation.

Depending on the technical field, the term “frequency estimation” has many synonyms. “Spectral/spectrum” can be used in place of “frequency”, and “analysis/detection” are also used in many occasions instead of “estimation”. Terms like “period/periodicity” as well as “count” are also commonly used. It is believed that the choice of terms, if appears to be different from what I am using in this disclosure, would not render the claims of this application inapplicable since it is the underlying methods that precisely defining the scope of protection, rather than the particular choice made on the naming the methods.

In application U.S. Ser. No. 12/804,163 I used Discrete Fourier Transform (DFT) to count the number of periods for the forming/falling process of IV drips. Experiments results were given for a wide range of dripping speeds and three different types of periodic signal measurements (drip height, drip size, and average gray level of a certain region in the image), and DFT gave accurate period counts for all of them. We have demonstrated, by an experiment with drip size as the periodic signal, that even when direct eye inspection on the signal had difficulty in ascertaining the exact period count, the DFT would still give the correct counting number same as what have been observed from the dripping process itself. The accuracy as proved by the experiments shown in that disclosure, together with its theoretical soundness and simplicity of implementation, made it an ideal choice as the frequency estimation method for video/image based IV monitoring.

There are, however, still reasons to give alternative methods to DFT in this problem. One is because that DFT itself still admits improvement. Since DFT computes only on discrete values at ωₖ=k·2π/N, if the actual periods of dripping is a fractional number during a certain time interval T, the fractional part would got lost and the result would be one of the two integers closest to the fractional value. This is essentially a problem of “resolution” in frequency estimation terminology. This could be addressed by variety of methods shown later, and would contribute to faster convergence with the IV dripping speed controlling mechanism.

Another reason would be to ensure complete and full-scope protection for this invention. Spectral estimation as an established discipline has already a history of over one hundred years [Preface, page XV, Stoica, Petre & Moses, Randolph L. —Spectral Analysis of Signals] and [Marple, L. Digital Spectral Analysis with Applications]. The idea of Fourier transform, discrete and continuous, can be regarded as the ancestor of a great number of descendants. These later-invented methods have their origins in specifics applications which cannot be addressed satisfactorily by previous methods. For example, the Multiple Emitter Location and Signal Parameter Estimation (MUSIC) method was originally used to determine parameters of multiple wavefronts arriving at an antenna array from measurements made on the signals received at the array elements [Schmidt 1986]. Each method has its specific theoretical assumptions on the characteristics of signal and noise and one might not work for the scenario of another; it is only because that the quality of signal supplied by our video/image processing algorithms are exceedingly or sufficiently well that many of them can find applicability with the signal, not that they are really offering improvement or shedding new lights on the problem. Nonetheless, since legal definitions tend to be construed literally, the inventor would try his best to include as broader and exhaustive as possible alternatives that can be used to achieve the same goal. It is for this purpose a comprehensive list of frequency estimation methods is provided.

### 2.1 Suitability Criterion

We are using the same set of data for consistency so that differences between algorithms can be easily compared. However, our three types of data decreases in quality:

Quality(drip height)>Quality(drip size)>Quality(region's average gray level)

if Quality( ) assigns a numerical value with higher one represents a higher signal quality. For drip height signal which is the best among the three types, all the methods below give correct estimation from it; for regions' average gray level, some methods might not apply; the case of drip size is between the two extremes.

However, as we have repeatedly stressed in application U.S. Ser. No. 12/804,163, any periodic measurement can be used. It is self-evident that drip height is a better periodic signal comparing with region's average gray level, but the fact that region's average gray level might not pass the test of some of the algorithms listed below is primarily due to the way we were extracting the signal. As we have described in application U.S. Ser. No. 12/804,163, video/image processing is done in a very small video window near the drip chamber's mouth where drips are forming and starting to fall. In fact, as can be found out from FIG. 2E to FIG. 3D in application U.S. Ser. No. 12/804,163, the window size is smaller than 20 (width)×50 (height), fewer than 1000 pixels. The purpose of choosing such a small window is to enable accurate and low-cost solution. On the other hand, the mathematical algorithms themselves poses no restriction on the size of the window, and real implementations can in fact use higher resolution cameras and higher frame rates (>15), which would be the 1^{st} support for region's average gray level as a valid signal. The choice of signal as the average gray level of a particular region is actually reminiscent of the systems using infrared ray for dripping detection in which a pulse is generated each time the falling drip obstructs the ray path between the sender and receiver, this gives the 2^{nd} for its validity; the 3^{th} support of its validity comes from FIG. 4I and FIG. 4J of application U.S. Ser. No. 12/804,163, in which for (II: 12 to 13 drips) data DFT gave the correct estimation from region's average gray level signal.

Based on these three points, we could confidently declare that region's average gray level is also a valid signal for frequency detection; but to use it in a frequency detection algorithm, image resolution, frame rate as well as other parameters might need to be accordingly adjusted. Therefore, if one ever reads in following examples the region's average gray level didn't pass a particular algorithm's test, or I have not listed them with a particular algorithm, it is only true for my particular dataset listed within this disclosure. If I adjust camera shooting environments, parameters and video/image processing algorithms to provide good average gray level data that suits different algorithms, the consistency of data among this disclosure and between this and application U.S. Ser. No. 12/804,163 would be lost. For each particular algorithm, adjusted environment, shooting parameters and video/image processing algorithms could still provide average gray level data good enough for it.

The same reasoning also extends to my drip size signal listed in this disclosure, which doesn't have as high the guarantee of drip height signal to pass all frequency estimation algorithms' test. It is however can be used with each particular algorithm provided that environments, shooting parameters and video/image processing algorithms are adjusted accordingly.

The reader should also note that different frequency estimation methods can be used in combination to complement each other. One enlightening example would be using DFT along with AMDF (Average Magnitude Differential Function), which would be discussed in [§2.2.2.4 Hybrid Algorithm (I)]. As a method with sound mathematical basis and confirmed by experiments in application U.S. Ser. No. 12/804,163, DFT gives accurate period count at the resolution of integer level. Several other algorithms, for AMDF, have the ability to actually count period length which would enable determining fractional period counts. With some types of data whose quality is not good enough (defined shortly after below by Suitability(S,E)), it is possible that AMDF recognizes incorrect period length because it finds local minima at incorrect location. As a remedy to this, DFT could be applied first to find the number of integer periods P, and by a division N/P get the period length estimation from the DFT result, which would be close to the actual period length. We would use N/P as a ballpark estimate, and employ AMDF to locate finer the actual period length around N/P. This would be demonstrated in the section of AMDF, and would be mentioned repeatedly if other algorithms can be combined with DFT, or other groups of algorithms not including DFT can be combined to achieve better result than using a single algorithm alone.

There are no less than ten algorithms for frequency estimation that we would discuss in this disclosure. The combination of two algorithms would have N_{algorithm}×N_{algorithm}≧10²=100 types, and it is also possible to combine more together. It is therefore unnecessary and impossible to list all combinations.

It would be helpful at this point to give a formal definition of Suitability, which is a relation between a particular algorithm and a particular dataset:

Suitability: For a particular dataset S of length N, a frequency estimator E( ), and the true number of periods P as being observed by a visually-unimpaired human,

$$Suitability ( S , E ) {=}^{def} \{ \begin{matrix}1 , & \vert P - E ( S ) \vert < ɛ ( N ) \\ 0 , & \vert P - E ( S ) \vert \geq ɛ ( N )\end{matrix}$$

ε(N) can be a constant smaller number independent of N, such as 0.5 or 1; Or it can be a monotonically increasing function of N. Intuitively, if you have only a signal of length 10, an error of 1 period is of course intolerable; but if you have a signal of length 1000, the same error would certainly be within the margin.

Expressing our discussion above with this new function concisely:

Suitability(S_{my example signal},E)=0 [symbol] Suitability(S_{your improved signal},E)=0

And what really determines is the quality of S as well as the E(N) one chooses.

### 2.2 Nonparametric Methods

### Definition:

By non-parametric methods, we mean that no knowledge of the actual physical model that is generating the signal (and the noise) is assumed, and no attempt will be made to estimate the parameters of the model. The frequency will be estimated directly from the signal itself

2.2.1 Naïve Methods

Those methods basically work directly in the time domain without doing any transformation (in a very general sense, not restricted to time-frequency domain transformation), looking in the signal curve for visual cues of periodicity and mimics the eye inspection by an automated procedure.

### 2.2.1.1 Crossing

### Common Synonym: Zero Crossing, Zero Value Detection, Thresholding

If a signal is assumed to be quasi-periodic, it would generally swing between high and low points during a period. Its action of crossing a certain intermediate level value can therefore be used to detect is periodicity.

There can be some variations on the concrete implementation:

(1) Detect rising edges
a) Must >crossing level
b) Must ≧crossing level

(2) Detect falling edges
a) Must <crossing level
b) Must ≦crossing level

We see in FIG. 2.2.1.1-1 that for drip height data of speed II≈13 periods, this method gives exact counting. The threshold is chosen to be 13 pixels of height, which should not be confused with period counts although the two values coincide. For speed II≈5.3 periods, a small spike at n_{base 1}=146 results in an incorrect period count; for speed III≈23 periods a “splitting peak” near n_{base 1}=80 also added an incorrect count. In addition, for speed III≈23 periods, at n_{base 1}=50, 51 whether the period which should be counted is correct depends on the chose between a), b) in (1), only if b) is chosen would the count be exact.

The threshold of 13 was not automatically computed, but manually picked. One can of course contrive some ad-hoc algorithms to find it manually, but such algorithms can easily be invalidated by intentionally constructed counterexamples. With other choices of threshold, incorrect counts are still present.

A simple method might be used to alleviate the problem. For example, the indexes of all crossing points might be stored in an array, and use another scan through the array to find indexes that are obviously “too close” to its predecessor or successor. This might be formally described as:

```
ε = 0.5;
Index _ record = Ø;
for i = 2 to N
  if (S[i − 1] < threshold & & S[i] ≧ threshold) then
    Index _ record .add (i);
  end
end
sum = 0;
for i = 2 to Index _ record .length
  sum = sum + Index _ record[i] − Index _ record[i − 1];
end
mean = sum / (Index _ record .length − 1);
for i = 2 to Index _ record .length
  if (Index _ record[i] − Index _ record[i − 1]) < ε · mean then
    Index _ record .remove(i);
  end
end
return Index _ record .length
```

mean is the average distance between successive indices of “crossing” points, and if two successive indices is closer than ε·mean it means one of them might correspond to a small spike or a splitting peak. ε as 0.5 has been tested as an appropriate value for the drip height signal of speed I, II and III.

### 2.2.1.2 Maxima/Minima

### Common Synonym: (Signal) Derivative, (Local) Maximum/Minimum

Another method is to find local maxima/minima. This works well for ideal signals like pure sinusoids. For the data drip height data we collected, it is found that restrictions must be made so that not all maxima/minima can be selected, and adjacent maxima/minima that are “too close” have to be abandoned.

The following pseudo code has been tested to correctly recognize maxima for speed II≈13 periods drip height data.

```
ε = 0.3;
Threshold = 12;
Index _ record = Ø;
for i = 2 to N
  if (S[i − 1] ≦ S[i] & & S[i] ≧ S[i + 1] & & S[i] > Threshold) then
    Index _ record .add (i);
  end
end
sum = 0;
for i = 2 to Index _ record .length
  sum = sum + Index _ record[i] − Index _ record[i − 1];
end
mean = sum / (Index _ record .length − 1);
for i = 2 to Index _ record .length
  if (Index _ record[i] − Index _ record[i − 1]) < ε · mean then
    Index _ record .remove(i);
  end
end
return Index _ record .length
```

The reason that we need to compare S [i] with Threshold is for removing maxima at low heights and the use of ε·mean is for removing close indices corresponding to small spikes or splitting peaks.

The result of recognizing maxima with speed II≈13 periods, drip height data is shown in FIG. 2.2.1.2-1. Small circles mark the recognized maxima. The cross in the figure indicate that the maxima at n_{base 1}=88 have been drop since it's to close the local peak at n_{base 1}=86, therefore have been abandoned due to the ε·mean criterion.

Expect for signals for exceptionally well quality, difficulties might always exist to find ε and Threshold that work for all speeds and all types of periodic signals (drip height, drip size, region's average gray level, etc.).

### 2.2.2 Time Domain Statistical Methods

We will show three methods for period estimation using statistical methods directly in the time domain. These methods have strong abilities in detecting the periodicity of signals that are corrupted, or even buried in noises.

### 2.2.2.1 Auto-Correlation

### Common Synonym:

The unbiased auto-correlation of a real sequence S is defined as

$${R}_{xx} ( S , m ) = \frac{1}{N - \vert m \vert} \{ \begin{matrix}{\sum }_{n = 1}^{N - M} S [ n + m ] S [ n ] & m \geq 0 \\ {R}_{xx} ( - m ) & m < 0\end{matrix}$$

It also has a biased version

$${\overline{R}}_{xx} ( S , m ) = \frac{1}{N} \{ \begin{matrix}{\sum }_{n = 1}^{N - M} S [ n + m ] S [ n ] & m \geq 0 \\ {R}_{xx} ( - m ) & m < 0\end{matrix}$$

in which we put an overline on top of R for differentiation. In the following we discuss only unbiased version, while in practice the biased version can also be used.

This derived sequence Rₓₓ(S, m) from Swill exhibit the same (since S is not a pure periodic sequence, “same” should not be interpreted as in the ideal case) periodicity as S.

When |m| becomes closer to N, N−|m| would become small, and the average would N−|m| the corresponding N−|m| values would not be an accurate estimation. This could be seen in FIG. 2.2.2.1-1 and FIG. 2.2.2.1-3. Therefore, in practice we usually examine only smaller |m|'s.

In addition, for real S, Rₓₓ(S,m) is symmetric about 0,

Rₓₓ(S,m)=Rₓₓ(S,−m)

it is therefore suffice only to compute for positive m's.

In our application, we could choose m to ensure at least three periods can be covered in m video frames, this is of course depends on the frame rate of the image capturing device and the dripping speed.

The determination of periods is done by counting the distance between Rₓₓ(S,0) and the next local maxima. It can be mathematically proved, but is also intuitive clear that

$$\frac{1}{N - {kT}_{E}} {\sum }_{n = 1}^{N - {kT}_{E}} S [ n + {kT}_{E} ] S [ n ]$$

would attain local maxima, in which T_{E} denote the estimate of period T and k is an integer.

For drip height data of speed I≈5.3 periods, we could find that the next peak after Rₓₓ(S,0) would be when m=34. FIG. 2.2.2.1-1 is symmetrically plotted around N, so we have Rₓₓ(S,0) locating at n=180, and Rₓₓ(S,34) locating at n=214.

We immediately recognize an advantage of this method over DFT which was used in application U.S. Ser. No. 12/804,163. Since DFT takes only discrete values, this limitation on resolution made it unable to find the actual fractional period count between 5 and 6. Auto-correlation, however, gives us the more exact actual period length estimate. To determine the number of periods,

N_{periods}=180/34=5.29412

This is not only more accurate than DFT, but even more accurate than can be achieved by a very attentive human observer, since it is also difficult for us to estimate the fractional periods via eye inspection.

The ability of giving fractional period count, when integrated into the IV monitoring and control system (see application U.S. Ser. No. 13/019,698), has an important advantage:

### Example

If the resolution is limited to integer periods, then if a doctor prescribes a dripping speed of 62 drips/min, it would correspond to 6.2 drips in 6 seconds. A monitoring and controlling device that is capable of only recognizing integer periods cannot determine whether the speed has reached 6.2 drips or not after monitoring for a 6-second period but can only know, after repeated adjusting and monitoring, that the speed is now in the range of [6,7]. To approximate the speed as close as possible, it has to extend the observing period to much longer, in this case at least 30 seconds, since 62 has only two divisors smaller than itself: 2 and 31. Even if at 30 seconds it observed a drip count of 31 drips, the actual speed would still be between (30,32)_{30 sec}=(60,64)_{60 sec}. To get a precise speed control, it has to extend the observing interval from short to long until 1 minute or even longer. A device capable of fractional count doesn't suffer from this at all, and each observing period can be made as short as possible.
In clinical practice nurses rarely wait one minute or more in adjusting and observing infusion speed. If the device converges too slowly, it would inconvenient to both nurse and patient. It would also take longer to converge again if conditions have changed such as the patient raised his/her hand.

I emphasize that this is one of the most important improvement over DFT period counting in application U.S. Ser. No. 12/804,163. The inventor has confirmed by experimented with an embodiment that using algorithms giving fractional period count result in much quicker convergence speed.

### Note:

“Converge” is a mathematical term and its use here is to mean that after repeated adjust-monitor feedback loop, the actual speed of drip finally falls into the tolerance range of the prescribed value.

It is therefore recommended here as one of the recommended methods in real implementation.

FIG. 2.2.2.1-3 and FIG. 2.2.2.1-4 show auto-correlation also works for drip size signal for speed I, II and III.

TABLE 2.2.2.1-1
Compare drip height and drip size
results for Auto-correlation period estimation

| Auto correlation | drip height | drip size |
|---|---|---|
| speed I ≈ 5.3 periods | 34 | 35 |
| speed II ≈ 13 periods | 14 | 15 |
| speed III ≈ 23 periods | 8 | 7 |

If we compare auto-variance result for different data sizes {drip height, drip size}, we would find that drip height is clearly a better signal for period estimation. Drip size signal might result in a period length error of 1. However, if signal quality can be improved as well as other adjustments can be made, such as increasing the frame rate, there is a very high change that the difference can be eliminated.

### 2.2.2.2 Auto-Covariance

### Common Synonym:

The biased auto-covariance of a real sequence S is defined as

$${\overline{V}}_{xx} ( S , m ) = \frac{1}{N} \{ \begin{matrix}{\sum }_{n = 1}^{N - m} ( S [ n + m ] - \frac{1}{N} {\sum }_{i = 1}^{N} S [ i ] ) ( S [ n ] - \frac{1}{N} {\sum }_{i = 1}^{N} S [ i ] ) & m \geq 0 \\ {V}_{xx} ( - m ) & m < 0\end{matrix}$$

and use an overline on top of V for differentiation with the unbiased version. In the following we discuss only unbiased version, but in practice biased version can also be used.

The unbiased auto-covariance of a real sequence S is defined as

$${V}_{xx} ( S , m ) = \frac{1}{N - \vert m \vert} \{ \begin{matrix}{\sum }_{n = 1}^{N - m} ( S [ n + m ] - \frac{1}{N} {\sum }_{i = 1}^{N} S [ i ] ) ( S [ n ] - \frac{1}{N} {\sum }_{i = 1}^{N} S [ i ] ) & m \geq 0 \\ {V}_{xx} ( - m ) & m < 0\end{matrix}$$

in which we note that

$$\frac{1}{N} {\sum }_{i = 1}^{N} S [ i ]$$

are actually the mean of S[n]·Vₓₓ(m) is in fact the auto-correlation of the mean-removed sequence,

$${V}_{xx} ( S , m ) = {R}_{xx} ( S - {μ}_{S} , m ) , {μ}_{S} = \frac{1}{N} {\sum }_{i = 1}^{N} S [ i ]$$

Vₓₓ(S, m) is also symmetric about 0:

Vₓₓ(S,m)=Vₓₓ(S,−m)

it is therefore suffice only to compute for positive m's.

Just as for Rₓₓ(S,m), we could choose m to ensure at least three periods can be covered in m video frames, this, however, depends on the frame rate of the image capturing device and the dripping speed.

The determination of periods is done by counting the distance between Vₓₓ(S,0) and the next local maxima. Like for Rₓₓ(S,m), Vₓₓ(S,kT_{E}) would attain local maxima, in which T_{E} denote the estimate of period T and k is an integer.

The ability of being able to detect actual period length, hence being able to calculate fractional period count is also possessed by auto-covariance.

Our experiment has shown that auto-covariance has the ability to detect periods for both drip height and drip size signal. These results are shown in FIG. 2.2.2.2-1 to FIG. 2.2.2.2-4.

TABLE 2.2.2.2-1
Compare drip height and drip size
result for Auto-covariance period estimation

| Auto-covariance | drip height | drip size |
|---|---|---|
| speed I ≈ 5.3 periods | 35 | 35 |
| speed II ≈ 13 periods | 14 | 15 |
| speed III ≈ 23 periods | 8 | 8 |

Like auto-correlation, auto-covariance is also one of the recommended methods in actual implementation.

### 2.2.2.3 Average Magnitude Differential Function (AMDF)

### Common Synonym: Comb-Filter, Optimum Comb Method

The Biased Average Magnitude Differential Function (AMDF) of a real sequence S is defined as

$${\overline{D}}_{xx} ( S , m ) = \frac{1}{N} {\vert S [ n + m ] - S [ n ] \vert}^{k} , m > 0$$

in which we use an overline on top of D for differentiation with the unbiased version. In the following we discuss only unbiased version, but in practice biased version can also be used.

The Unbiased Average Magnitude Differential Function (AMDF) of a real sequence S is defined as

$${D}_{xx} ( S , m ) = \frac{1}{N - m} {\sum }_{n = 1}^{N} {\vert S [ n + m ] - S [ n ] \vert}^{k} , m > 0$$

It is only defined for m>0 because of symmetry about 0. k can be chosen to be any positive value, but integers like 1, 2 are commonly used.

And a property is that

$$D ( S , m ) = \frac{1}{N} {\vert S [ n ] - S [ n ] \vert}^{k} = \frac{1}{N} {\vert 0 \vert}^{k} = 0$$

Please refer to [M. J. Ross, H. L. Shaffer, A. Cohen, R. Freudberg and H. J. Manley, “Average Magnitude Difference Function Pitch Extractor,” IEEE Trans. on Acoustics, Speech and Signal Processing, vol. 22, no. 5, pp. 353-362, 1974] for its mathematical discussion.

If we compare the equation of AMDF and with the equation Rₓₓ(S,m) of autocorrelation, it is immediately recognized that Dₓₓ(S,m) is actually a complement of Rₓₓ(S,m). Rₓₓ(S, m) takes summation over multiplications of shifted pairs, whereas Dₓₓ(S,m) takes summation over differences of shifted pairs plus a power k. For Rₓₓ(S,m) local maxima are attained when m=kT_{E}, in which T_{E} denote the estimate of period T and k is an integer; for Dₓₓ(S,m) it would conversely be that local minima are attained when m=kT_{E}.

Our experiments (without * in the column heads) have shown that AMDF works drip height and region's average gray level of all speeds I, II and III.

TABLE 2.2.2.3-1
Compare drip height and drip size result for AMDF
period estimation

| | | | region's |
|---|---|---|---|
| | | | average gray |
| AMDF | drip height | drip size* | level |
| speed I ≈ 5.3 periods | 35 | 35 | 35 |
| speed II ≈ 13 periods | 14 | 15 | 14 |
| speed III ≈ 23 periods | 8 | 8 | 8 |

Please refer to FIG. 2.2.2.3-1-FIG. 2.2.2.3-7. The axes bases in starts at 1 for the 1^{st} data in the array, so that the actual period length is X−1.

Experiments for biased version of AMDF are not shown for the simple reason that each value can be obtained by multiplying the corresponding unbiased AMDF term with (N−m)/N. It gives correct result for drip's height and region's average gray level data. For drip size data its result subject to the same problem as the biased version such for speed I≈5.3 periods signal, and can be corrected in the same way as shown in the next section.

In the next section we are going to show that AMDF could also work for drip size signal.

* means used with DFT or other algorithms

### 2.2.2.4 Hybrid Algorithm (I)*

We note that for AMDF, its recognition ability seems worse than auto-correlation and auto-covariance in that it seems having failed to detect drip size signal periods correctly. But the nice shape of drip height signal's AMDF curve seems actually recommending itself for signals of even worse quality, as it already worked for region's average gray level signal. So where has it failed for drip size signal?

A close examination would show that (see FIG. 2.2.2.3-1 to FIG. 2.2.2.3-7):
1. For drip size signal of speed II≈13 periods and speed III≈23, the detection was correct.
2. For drip size signal of speed II≈5.3 periods, it was due to the existence of a small local minimum at m=20 (X=21) that caused the wrong period length detection. It is obviously not a deep value as at m=35 (X=36), but still deceived the program to treat it at a minimum cause by m=kT_{E}.

It can easily be solved by a number of remedies:
1. Restrict the search of local minima to small AMDF value D(S,m). To implement this formally, one might set a threshold TH such that only D(S,m)<TH would be checked for local minima TH could also be a function of signal sequence S, or preferably sequence D(S,m), mε1, . . . , N−1. For example, find the average of local minima, and require D(S,m)<ε· D̅ₘ̅ₐ̅ₓ̅ᵢ̅ₘ̅ₐ̅(̅S̅,̅m̅)̅, in which the overline denote average operation and ε would be a constant value, say, 1.5. However, it is not easy to found ε or other functions to determine TH with a sound theoretical basis.
2. But there is an easy solution: DFT+AMDF. The idea is very simple:
   a) DFT has only integer resolution, but very accurate;
   b) AMDF give exact period count, but might detect wrong local minima
We therefore combine the two algorithms. Since DFT recognizes 5 periods and has only integer resolution, the actual period length

$$T ∈ [ \frac{N}{5 + 1} , \frac{N}{5 - 1} ] = [ \frac{180}{6} , \frac{180}{4} ] = [ 30 , 45 ]$$

If we search in this interval for speed II≈5.3 periods' AMDF result, we clearly avoided m=20 (X=21), and would only get m=35 (X=36) since 35⊂[30, 45]. In this way, we get the best of both.
The idea of using a coarse resolution followed by a finer resolution can be found in a whole array of applications, for example in the numerical solution to differential or polynomial equations, where it is called “successive approximation”. The essential ideas are the same.

The purpose of this section, titled “Hybrid Algorithm (I)*”, if for demonstrating that judicious combination of algorithms, based on the understanding of their strengths and weaknesses, can achieve better result than individually applied alone. As we have discussed in the beginning of §2. Frequency Estimation, no less than 10 algorithms for frequency will be described in this disclosure, and their combinations of 2, 3, and more, are numerous. We declare that the principle of hybrid algorithms/algorithm combination is also disclosed here for the video/image-based IV monitoring application, and the required protection would be made clear in the claims.

### 2.2.3 Fourier and Fourier-Related Methods

Fourier transform has a vast number of variations and derivatives and it's impossible to exhaust. A clear distinction between Fourier-family methods and previous methods is that it whereas previous methods uses time domain signal directly, Fourier methods would estimate its constituent components at different frequencies. e^{j·ωt} can take either discrete or continuous w. We have already presented methods using the discrete Fourier transform in application U.S. Ser. No. 12/804,163, and in this disclosure we are going to describe its continuous counterparts.

### 2.2.3.1 Periodogram and Discrete-Time Fourier Transform

### Common Synonym: DTFT: Discrete-Time Fourier Transform

The periodogram of a real sequence S is defined as

$$P ( ω ) = \frac{1}{N} {\vert {\sum }_{n = 1}^{N} S [ n ] {e}^{- j ω n} \vert}^{2}$$

Please refer to [Stoica, P., and R. L. Moses, Introduction to Spectral Analysis, Prentice-Hall, 1997, pp. 24-26] for this definition.

The discrete-time Fourier transform (DTFT) of a real sequence S is defined as

$$D ( ω ) = {\sum }_{n = 1}^{N} S [ n ] {e}^{- j ω n}$$

which has the inverse transform

$$S [ n ] = \frac{1}{2 π} {\int }_{- π}^{π} D ( ω ) {e}^{j ω n} \cdot d ω$$

Periodogram and DTFT are related by

$$P ( ω ) = \frac{1}{N} {\vert D ( ω ) \vert}^{2}$$

Which means periodogram is simply the square of DTFT's magnitude divided by N. Both of them can be used to estimate signal frequency for our application.

And advantage of periodogram and DTFT over DFT is that they estimate fractional frequency. This is also achievable by auto-correlation, auto-covariance and AMDF as well as many other algorithms described afterwards, but with different principle. In clinical application this would result in quick convergence speed which is an important improvement over DFT speed counting. Please refer to [§2.2.2.1 auto-correlation] for discussion.

Note that in calculating periodogram and DTFT, it is recommended that the mean-removed version of the signal is used. This is because

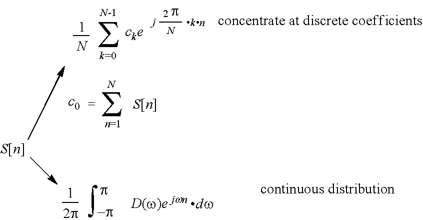

In other textbooks and literatures,

$$\frac{1}{N}$$

might appear in the analysis equation of DFT and absent in the synthesis equation. There are also other conventions such as using

$$\frac{1}{\sqrt{N}}$$

in both analysis and synthesis equation. Please refer to [Ch.8, Oppenheim & Schafer, Discrete-Time Signal Processing (2ed)] for derivations.

In the discrete case, S[n] is decomposed to exactly n complex exponentials with

$$ω = 0 , \frac{2 π}{N} \cdot 1 , \frac{2 π}{N} \cdot 2 , \\ \frac{2 π}{N} \cdot ( N - 1 ) ,$$

whereas DTFT (and periodogram) is evaluated over the entire continuum of [−π,π]. For many signals a large portion of its energy is at the DC component, so that

$${c}_{0} = {\sum }_{n = 1}^{N} S [ n ]$$

in DFT could be larger than many other coefficients, yet we can simply exclude c₀ from coefficient magnitude comparison. For DTFT (and periodogram) the DC energy of the signal will be distributed over a band of low frequency centered at 0, so excluding 0 along would still leave many ω values with small Δω increments, and D(ω) and P(ω) at these ω's could be larger than D(ω) and P(ω) at higher ω's which corresponding to the AC components of the signal, and would therefore cause problem if we compare D(ω) or P(ω) magnitude to estimate the signal frequency. The simplest solution is to remove the signal's mean.

Continuum can only be approximated, so we finely divide each

$$\frac{2 π}{N}$$

into m pieces of

$$\frac{2 π}{m \cdot N} ,$$

m can be arbitrarily picked. In FIG. 2.2.3.1-1 m=100, so the resolution is very fine. DFT is also put in for comparison. We see that DTFT and DFT are proportional; periodogram would have large values enlarged and small values diminished due to the square over DTFT, relatively, which basically suggests that the contrast between values have been enhanced.

The frequency estimation would be done by simply scanning the DTFT/periodogram sequence. The DTFT/periodogram peak for drip height signal of speed II≈13 periods is at

$$X = 1288 ( ω = \frac{2 π}{m \cdot N} \cdot 1287 ) ,$$

the number of periods over S [n] can then be calculated as

$$\begin{matrix}P = \frac{\frac{2 π}{m \cdot N} \cdot 1287 \cdot N}{2 π} \\ = \frac{1287}{m} \\ = \frac{1287}{100} \\ = 12.87\end{matrix}$$

which is obviously of a higher resolution than DFT's 13 periods count.

If we compare {Auto-correlation, Auto-covariance, AMDF, DTFT/periodogram}'s result for drip height signal of speed II≈13 periods:

| | | | | DTFT/ |
|---|---|---|---|---|
| | Auto-correlation | Auto-covariance | AMDF | periodogram |
| Period | 14 | 14 | 14 | |
| length | | | | |
| Period | 180/14 = 12.857 | 180/14 = 12.857 | 180/14 = | 12.87 |
| count | | | 12.857 | |

The coincidences are extremely close. The accuracies of these four methods are therefore simultaneously confirmed.

### Note on Computation:

To improve efficiency, we could use method similar to “successive approximation” described in [§2.2.2.4 Hybrid Algorithm (I)] where DFT is followed by AMDF. We could first locate the ballpark estimate using DFT, and then compute ω's of fine increments only at the vicinity of the discrete codetermined by DFT. In this above case the two integers surrounding 12.857, namely [12,13], which translates into [1201,1301] for DTFT/periodogram indices. There then only m=100 ω values to compute. This works for any m.

It has also been verified that DTFT/periodogram works for all other signals in {drip height, drip size}×{speed I, II, III. The results for drip size signal of speed II is are shown in FIG. 2.2.3.1-2.

### 2.2.3.2 Bartlett's Periodogram Averaging

### Common Synonym: Bartlett's Method, Averaged Periodogram

The Bartlett's periodogram average is one of the variations of periodogram and is defined as

$$B ( ω ) = \frac{1}{N} {\sum }_{i = 0}^{K - 1} {\vert {\sum }_{n = 0}^{L - 1} S [ i L + n ] {e}^{- jω n} \vert}^{2} , \\ KL = N$$

The averaging happens over each segment of length L, and the squared magnitude will be summed over K such segments, and finally divided by N. With local averaging over segments of length L, the spectral resolution will be reduced by K, whereas the variance can be expected to reduce.

For a thorough discussion, please refer to [§8.2.4 of Hayes, M.—Statistical Digital Signal Processing and Modeling (Wiley, 1996)].

We have conducted experiments with {drip height, drip size}×{speed I, II, III}×{L=90, 60, 30, 15}, a total of 24 different combinations. The results drip height signal of speed II are shown in FIG. 2.2.3.2-1 along with periodogram results for comparison. We would clearly see in each figure that as L becomes smaller, the variance becomes smaller while the resolution also decreases. With L values that are too small, such as 15, values at the vicinity of zero could become larger thus cause problems in estimation. In fact, consider the extreme case that L=1:

$$L = 1 , \\ \begin{matrix}K = N / 1 \\ = N\end{matrix}$$

$$\begin{matrix}B ( ω ) = \frac{1}{N} {\sum }_{i = 0}^{N - 1} {\vert {\sum }_{n = 0}^{1 - 1} S [ i + n ] {e}^{- jω n} \vert}^{2} \\ = \frac{1}{N} {\sum }_{i = 0}^{N - 1} {\vert S [ i + 0 ] {e}^{- jω \cdot 0} \vert}^{2} \\ = \frac{1}{N} {\sum }_{i = 0}^{N - 1} {\vert S [ i ] \vert}^{2}\end{matrix}$$

i.e., B (ω) would become a constant irrespective of ω. It is therefore cautioned that L values that are too small should be avoided.

The value of m which is used to finely divide Δω increments in FIG. 2.2.3.2-1 is also chosen to be 100, and real implementation can use any value. Just as for periodogram and DTFT, for efficient computation and more accurate estimation one could first use DFT to locate the interval and then compute Bartlett's periodogram on the vicinity of the interval.

### 2.2.3.3 Correlogram/Periodogram of Auto-Covariance

### Common Synonym:

The correlogram of a real sequence S is defined as

$${φ}_{c} ( ω ) = {\sum }_{k = - ( N - 1 )}^{N - 1} {R}_{xx} ( S , k ) {e}^{- jω k}$$

in which Rₓₓ(S, k) is the auto-correlation sequence as defined in [§2.2.2.1 Auto-correlation]. Please refer to [§2.2, Stoica, Petre & Moses, Randolph L. —Spectral Analysis of Signals] and [Blackman and Tukey 1959] for its mathematical discussion.

Hybrid Algorithm (II)*
Compare it with the definition of DTFT in [§2.2.3.1 Periodogram and DTFT], it can in fact be defined as the DTFT of Auto-correlation. Since it is the DTFT of a derived sequence from S, namely, Rₓₓ, it can also be classified as a hybrid algorithm as was first introduced in [§2.2.2.4 Hybrid Algorithm (I)].

There are primarily two reasons why we could used correlogram to estimate the frequency:
1. Intuitively, as we have seen in [§2.2.2.1 Auto-correlation], autocorrelation exhibit the same periodicity as signal S itself, therefore it is reasonable that its DFTF will give us the same periodicity estimate as DTFT directly from S.
2. A rigorous proof would require restrictions such that the auto-correlation sequence decays sufficiently rapidly, and the convolution property of DTFT will be used. Please refer to [Ch.1 & Ch.2, Stoica, Petre & Moses, Randolph L. —Spectral Analysis of Signals] for its detail.

FIG. 2.2.3.3-1 shows experiment for drip height data at speed II≈13 periods. At the bottom DFT of auto-correlation is also provided for comparison. It can of course be used as an alternative to DTFT, subjecting to the problem of integer resolution as have been discussed in previous sections.

Note that due to symmetry, for correlogram we computed only the first half of the length.

Please also note that due to the fact that has been explained in [§2.2.3.1 Periodogram and DTFT], in computing continuous DTFT we removed the mean of the Rₓₓ sequence. Otherwise there will be high values at lower frequencies which would cause difficulties for period estimation.

In FIG. 2.2.3.3-1 DTFT's m=100 and correlogram the peak is found to be at X=2571, the length of φ_{c}(ω) sequence is 2N−1=359. The number of periods in the original sequence S could then be calculated as

$$\begin{matrix}P = \frac{\frac{( X - 1 ) \cdot 2 π}{( 2 N - 1 ) \cdot m} \cdot N}{2 π} \\ = \frac{X - 1}{m} \cdot \frac{N}{2 N - 1} \\ = \frac{2570}{100} \cdot \frac{180}{359} \\ = 12.886 \end{matrix}$$

TABLE 2.2.3.3-1
Compare correlogram with other methods

| | Auto- | Auto- | | DTFT/ | Correlo- |
|---|---|---|---|---|---|
| | correlation | covariance | AMDF | periodogram | gram |
| Period | 14 | 14 | 14 | | |
| length | | | | | |
| Period | 180/14 = | 180/14 = | 180/14 = | 12.87 | 12.891 |
| count | 12.857 | 12.857 | 12.857 | | |

When compared with results from other methods described above, correlogram result is found to be very close to them. This accuracy of correlogram is therefore confirmed.

Experiments have also been made on the remaining of {speed I, II, III}×{drip height, drip size} signal, all resulted in accurate measurement.

Since we were comparing DTFT magnitude which differs from periodogram only by a constant scale and a squaring operation, it is evident that periodogram of auto-correlation could also work.

### 2.2.3.4 DTFT/Periodogram of Auto-Covariance

### Common Synonym:

Just as we may define DTFT on autocorrelation sequence, we might also define DTFT on autocovariance sequence. This is yet another example that hybrid algorithms can be devised from methods in our algorithm repertoire without limitation.

It is simply defined as

$${DTFT}_{{V}_{xx}} ( k ) = {\sum }_{k = - ( N - 1 )}^{N - 1} {V}_{xx} ( S , k ) {e}^{- jω k}$$

The auto-covariance Vₓₓ sequence can be either biased or unbiased.

Due to symmetry in Vₓₓ we can take compute only either first or second half of Vₓₓ. The result for {drip height, drip size}×{speed I, II, III} data are shown in FIG. 2.2.3.4-1 and FIG. 2.2.3.4-2 where we computed only for half of the unbiased Vₓₓ sequence and take DTFT 100 precision of DFT. We confirmed that the result was accurate.

Since in the experiments we were comparing the magnitude of coefficients of DTFT which differs only by a constant and a squaring operation with periodogram, it evident that periodogram of auto-covariance could also work.

### 2.2.3.5 Discrete Cosine Transform (DCT) and Discrete Sine Transform (DST)

### Common Synonym:

DCT and DST are variations of the DFT representing real sequence S with real coefficients. Depending on the different choices of defining periodic and symmetric extension, there are at least 16 different variations of DCT and DST. Please refer to [Wang, Z. 1984, Fast Algorithms for the Discrete W Transform for the Discrete Fourier Transform, IEEE Trans, on ASSP, Vol. 32(4), pp. 803-816,] and [Martucci, S. A. 1994, Symmetric Convolution and the Discrete Sine and Cosine Transforms, IEEE Trans on Signal Processing, Vol. 42(5), pp. 1038-1051] for them. However, none of the variations differ substantially so we are going to illustrate the usage with two most common versions: DCT-II and DST-II.

Please also refer to [§7.5, Proakis, John G. —Digital Signal Processing (4ed)] for DCT. DST can be found on numerous other literatures.

To represent real sequence with real coefficients extension of the original sequence must be made. For DCT-II, the original sequence is first “flipped” right-side left and then appended to the original sequence. To put it formally,

$${S}_{DCT - II} = \{ \begin{matrix}S [ n ] , & 0 \leq n \leq N - 1 \\ S [ 2 N - 1 - n ] , & N \leq n \leq 2 N - 1\end{matrix}$$

We take as ordinarily the DFT of S_{DCT II}:

$$\begin{matrix}\begin{matrix}{DFT}_{{S}_{DCT - II}} ( k ) = {\sum }_{n = 0}^{2 N - 1} {S}_{DCT - II} ( n ) \cdot {e}^{- j \frac{2 π}{2 N} \cdot nk} \\ = {\sum }_{n = 0}^{N - 1} {S}_{DCT - II} ( n ) \cdot {e}^{- j \frac{2 π}{2 N} \cdot nk} + \\ {S}_{DCT - II} ( 2 N - 1 - n ) \cdot {e}^{- j \frac{2 π}{2 N} ( 2 N - 1 - n ) \cdot k} \\ = {\sum }_{n = 0}^{N - 1} {S}_{DCT - II} ( n ) \cdot [ {e}^{- j \frac{π}{N} \cdot nk} + {e}^{- j \frac{π}{N} ( 2 N - 1 - n ) \cdot k} ] \\ = {\sum }_{n = 0}^{N - 1} {S}_{DCT - II} ( n ) \cdot {e}^{- j \frac{π}{N} ( - \frac{1}{2} k )} \cdot \\ [ {e}^{- j \frac{π}{N} ( n + \frac{1}{2} ) k} + {e}^{- j \frac{π}{N} ( - \frac{1}{2} - n ) \cdot k} ] \\ = {e}^{- j \frac{π}{N} ( - \frac{1}{2} k )} \cdot {\sum }_{n = 0}^{N - 1} {S}_{DCT - II} ( n ) \cdot \\ [ {e}^{- j \frac{π}{N} ( n + \frac{1}{2} ) k} + {e}^{- j \frac{π}{N} ( - \frac{1}{2} - n ) \cdot k} ] \\ = {e}^{- j \frac{π}{N} ( - \frac{1}{2} k )} \cdot {\sum }_{n = 0}^{N - 1} {S}_{DCT - II} ( n ) \cdot 2 \cdot cos ( \frac{π}{N} \cdot ( n + \frac{1}{2} ) k )\end{matrix} & \\ ∴ \\ DCT - {II}_{S} ( k ) = {\sum }_{n = 0}^{N - 1} {S}_{DCT - II} ( n ) \cdot 2 \cdot cos ( \frac{π}{N} \cdot ( n + \frac{1}{2} ) k ) & \end{matrix}$$

Due to symmetry, the first N DCT-II coefficients already contain the full information of the extended sequence, and S_{DCT-II} can be reconstructed by first multiplying DCT-II sequence with respective

$${e}^{- j \frac{π}{N} ( - \frac{1}{2} k )}$$

and then take the inverse DFT. The first N result of the inverse DFT would be the original sequence S.

What we are interested in, however, is to count the number of periods of the original sequence S. Strictly speaking DCT is not well-suited for this purpose due to the “flipping” operation in constructing the extended sequence. But if the periodicity in the original signal S is truly strong it could still work in a similar as measuring periods from DFT.

FIG. 2.2.3.5-1 show the DCT-II extension for drip height, speed II≈5.3 periods signal compared with the original. Note how the symmetric extension added ambiguities to the signal in terms of periodicity.

Despite the inherent problem with period interpretation, FIG. 2.2.3.5-2 still show correct integer level precision period count for drip height signal of speed I, II and III. For example, in the 2^{nd} figure since the maximum magnitude non-DC component has index 26 (base 1), the period should be (26−1)/2=12.5, consistent with other methods.

FIG. 2.2.3.5-3 show DCT-II result for drip size data of all speeds. The result for speed I and II are correct. For speed III≈23 periods, the value at X=48 is 613, almost equal 615 at X=2. This suggests that to use DCT-II safely we might need to restrict the maximum magnitude coefficient searching range, or requiring better quality signal.

DST-II differs with DCT-II only in that it not only “flip” the original sequence, but also invert (take negative) them so that odd symmetry new sequence cancels cosine coefficients while preserving sine sequence.

$${S}_{DCT - II} = \{ \begin{matrix}S [ n ] , & 0 \leq n \leq N - 1 \\ - S [ 2 N - 1 - n ] , & N \leq n \leq 2 N - 1\end{matrix}$$

We take as ordinarily the DFT of S_{DST-II}:

$$\begin{matrix}\begin{matrix}{DFT}_{{S}_{DCT - II}} ( k ) = {\sum }_{n = 0}^{2 N - 1} {S}_{DCT - II} ( n ) \cdot {e}^{- j \frac{2 π}{2 N} \cdot nk} \\ = {\sum }_{n = 0}^{N - 1} {S}_{DCT - II} ( n ) \cdot {e}^{- j \frac{2 π}{2 N} \cdot nk} - \\ {S}_{DCT - II} ( 2 N - 1 - n ) \cdot {e}^{- j \frac{2 π}{2 N} ( 2 N - 1 - n ) \cdot k} \\ = {\sum }_{n = 0}^{N - 1} {S}_{DCT - II} ( n ) \cdot [ {e}^{- j \frac{π}{N} \cdot nk} - {e}^{- j \frac{π}{N} ( 2 N - 1 - n ) \cdot k} ] \\ = {\sum }_{n = 0}^{N - 1} {S}_{DCT - II} ( n ) \cdot {e}^{- j \frac{π}{N} ( - \frac{1}{2} k )} \cdot \\ [ {e}^{- j \frac{π}{N} ( n + \frac{1}{2} ) k} - {e}^{- j \frac{π}{N} ( - \frac{1}{2} - n ) \cdot k} ] \\ = {e}^{- j \frac{π}{N} ( - \frac{1}{2} k )} \cdot {\sum }_{n = 0}^{N - 1} {S}_{DCT - II} ( n ) \cdot \\ [ {e}^{- j \frac{π}{N} ( n + \frac{1}{2} ) k} + {e}^{- j \frac{π}{N} ( - \frac{1}{2} - n ) \cdot k} ] \\ = {e}^{- j \frac{π}{N} ( - \frac{1}{2} k )} \cdot {\sum }_{n = 0}^{N - 1} {S}_{DCT - II} ( n ) \cdot 2 j \cdot sin ( \frac{π}{N} \cdot ( n + \frac{1}{2} ) k ) \\ = j \cdot {e}^{- j \frac{π}{N} ( - \frac{1}{2} k )} \cdot {\sum }_{n = 0}^{N - 1} {S}_{DCT - II} ( n ) \cdot 2 \cdot sin ( \frac{π}{N} \cdot ( n + \frac{1}{2} ) k )\end{matrix} & \\ ∴ \\ DCT - {II}_{S} ( k ) = {\sum }_{n = 0}^{N - 1} {S}_{DCT - II} ( n ) \cdot 2 \cdot sin ( \frac{π}{N} \cdot ( n + \frac{1}{2} ) k ) & \end{matrix}$$

However, caveat must be taken that unless the original sequence is already roughly symmetric about the X axis, the average of the sequence needs to be subtracted for the original before doing the extension.

FIG. 2.2.3.5-4 shows for drip height speed I≈5.3 periods data, directly flip+invert extension leaves the first half positive and the second half negative. If there is any likely periodicity in the sequence, the closest number would be one. This can be seen from the 3^{rd} subfigure of FIG. 2.2.3.5-4 that the maximum magnitude coefficient is at X=2 (base 1), 2−1=1, and this means that there is only one period in the extended sequence.

The correct way of extension is to first subtracting mean from the original sequence then do the normal DST-II extension.

The results for {drip height, drip size}×{speed I, II, III} are shown in 2.2.3.5-5 and 2.2.3.5-6. After subtracting minus one from the X index of maximum magnitude coefficients (due to base 1 used) and divide by 2, we confirmed that all the period counts are accurate.

Other numerous padding and extension schemes of DCT and DST are clearly usable but none would constitute substantial difference the two here.

### 2.2.4 Wavelet Transform

### Common Synonym: Haar Transform, Wavelet Method

The basic ideas behind wavelet transform are multi-resolution and filter banks. There is a low pass filter and a high pass filter. After a signal is passed through the low-pass filter and down-sampled (denoted by ↓), the result represents the low-frequency local component of the signal; on the other hand, the down-sampled high-pass filter result represents the high-frequency local component of the signal. In the simplest form of wavelet transform, namely the Haar transform, the low-frequency local component is simply the local average of adjacent components, and the high-frequency local component is the difference between two adjacent components.

Please refer to [Strang & Nguyen—Wavelets and Filter Banks] and [Daubechies, Ingrid—Ten Lectures on Wavelets] for detailed discussion on wavelet methods.

Shubha Kadambe and G. Faye Boudreaux-Bartels described a method for detecting pitch in speech signal in [Application of the Wavelet Transform for Pitch Detection of Speech Signals, IEEE Transaction on Information Theory, Vol. 38, No. 2, March 1992]. They perform a type of wavelet transform known as dyadic wavelet transform on the speech signal at different scales, and locate local maxima exceeds 80% of the global maxima. If any location of local maximum agrees across two scales, then this location would be recognized as a maximum corresponds to transients caused by glottal closure. They would then measure the time between adjacent local maxima to determine the period length.

The advantage of this method was due to the non-stationary nature of speech signals. Speech signal changes over times, and include many different types of sounds such as consonants and vowels. The method Kadambe made no assumption that the signal would be stationary, and would actually detect local maxima:

t(M₁),t(M₂),t(Mₖ)

for which t(Mᵢ₊₁)−t(M₁) differ widely.

The IV dripping process, on the other hand, can largely be assumed to be a stationary type of signal expect during moments when the patient is moving his arm or due to other activities. Although not particular attractive, wavelet transform can still be used to detect periods for this type of signal, and the principle is to some extent similar with time-domain methods.

Using the same idea as Kadambe's, one of the possible implementation using wavelet for this application can be described as:
1) Choose a type of wavelet
2) Compute the approximation coefficients cₐ and differentiation coefficients c_{d} iteratively.

After each iteration, abandon c_{d} (or set it to all zeros) and reconstruct an approximate signal purely from cₐ, then send cₐ (or the reconstructed approximate signal) into the next iteration. Stop the process after a certain number of iterations.
3) At the last (the designer usually needs to specify the number of levels himself) level, find local maxima (either > or ≧ both neighbors, or other combination) whose value exceeds a certain percentages ε of the global maxima. For each of the local maxima X, scan upwards up to the original S: if at all levels the neighbor of [X−K, X+K] contain local maxima, then recognize this location as a peak of the signal.
4) Count the number of peaks as the number of periods.

Note that the reason we are searching in [X−K, X+K] is because the approximate reconstruction is not guaranteed to show peaks at the same location as the original signal, therefore an interval of search is needed. Please also refer to [Strang & Nguyen—Wavelets and Filter Banks] and [Daubechies, Ingrid—Ten Lectures on Wavelets] for detailed discussion.

Please also note that if the length of the chosen wavelet (in our example Daubechies D8) is larger than 2, then padding (extension) for points at the beginning and end of Spadding is needed to ensure proper operation. Wavelet transform itself doesn't impose any restriction on how the padding is done and popular choices include using periodic extension (like rolling to the other end), derivative extension (calculate the derivative at end points and interpolate extension points with the derivative), zero extension and constant extension. In our example we have chosen constant extension since it would not cause problem to our period count algorithm. For Daubechies D8 wavelet, it is done by padding the original S to

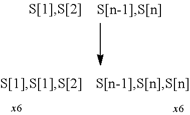

If other padding scheme is used in real implementation, caution must be taken on not to create any “spurious period” to the algorithm.

For drip height signal of all speeds I, II and III, experiments have been done with the following parameters:

TABLE 2.2.4-1
Parameters used in wavelet period count

| | Value |
|---|---|
| Wavelet | Daubechies D8 |
| | 0.32580343 |
| | 1.01094572 |
| | 0.8922014 |
| | −0.03957503 |
| | −0.26450717 |
| | 0.0436163 |
| | 0.0465036 |
| | −0.01498699 |
| Level | Two levels of approximation |
| ε | 0.6 |
| K | 3 |

Results are shown in FIG. 2.2.4-1 to FIG. 2.2.4-3. The algorithm with parameters above recognizes correctly peaks at all speeds I, II and III. The peak locations are marked with upward-pointing triangles. The 3^{rd} and 4^{th} level of approximate reconstruction are also shown below the 2^{nd} approximate reconstruction from which we can see that excess levels of approximation might flatten the signal too much to cause peak detection fail.

Of course, real implementation can make adjustments to the parameters above, and the detailed algorithm and parameters above should only be regarded as an illustration rather than limitation.

The Daubechies family of wavelet can have different lengths, and there are many other types of wavelets such as {biorthogonal, cubic spline, Haar, Mexican hat, Morlet, Meyer, symlets} and customarily constructed types. But none of them would constitute substantial difference from our algorithm.

Daubechies D2 wavelet is equivalent to Haar wavelet, and wavelet transform with it is also called Haar transform.

Depending on the quality of the signal, it is reasonable to expect that others types of wavelets and parameters can be used for peak (peak) counting in this application.

### 2.3 Parametric Methods

### Definition:

The parametric methods assume that the signal satisfies a generating model with known functional form and then proceed by estimating the parameters in the assumed model. The signal's spectral characteristics of interest are then derived from the estimated model. [§3.1, page 90, Stoica, Petre & Moses, Randolph L.—Spectral Analysis of Signals]

There are many different types of parametric methods including those based on

1. Autoregressive model (AR)

2. Moving average model (MA)

3. Autoregressive model-Moving average model (ARMA)

4. Subspace/eigenvector methods

As we have mentioned in [§2. Frequency Estimation], spectral estimation as an established discipline has already a history of over one hundred years [Preface, page XV, Stoica, Petre & Moses, Randolph L.—Spectral Analysis of Signals] [Marple, L. Digital Spectral Analysis with Applications], and different are invented for different application where signals all have their unique characteristics. Many of the parametric methods (just as many non-parametric methods above) could work for our signal only because the quality of these signals are fairly well (stationary, no noise contamination/corruption, simple process; etc.), not that our signals do require these parametric methods to be estimated correctly. In fact, as we have seen with the examples of {auto-correlation, auto-covariance, AMDF, periodogram/DTFT, correlogram}, the accuracy of these algorithms are already sufficient well, and in fact admits little if not no room of improvement. In practice, the implementation of many parametric methods is usually more difficult. Many of them would require solving groups of linear equations or solving polynomial equations (for example, finding all eigenvalues of a matrix) of high orders. Consequently, numerical issues will also be involved.

In the AR/MA/ARMA class of algorithms, we are going to describe Yule-Walker method. In the subspace/eigenvector methods, we are going to describe Multiple Emitter Location and Signal Parameter Estimation (MUSIC) and Pisarenko harmonic decomposition. These two methods are well-known, widely used, and representative of their respective class of methods.

### 2.3.1 Auto-Regressive Spectrum Estimation

### 2.3.1.1 Yule-Walker Method

Common Synonym: Autocorrelation Method (not to be Confused with the Previous Auto-Correlation Method)

Parametric methods make an assumption that output S can be modeled as a difference equation involving itself and input sequence w:

$$S [ n ] = - {\sum }_{k = 1}^{p} {a}_{k} S [ n - k ] + {\sum }_{k = 0}^{q} {b}_{k } w [ n - k ] \\ so that \\ H ( z ) = \frac{B ( z )}{A ( z )} = \frac{{\sum }_{k = 0}^{q} {b}_{k} {z}^{- k}}{1 + {\sum }_{k = 1}^{p} {a}_{k} {z}^{- k}} \\ and \\ H ( {e}^{j ω} ) = \frac{B ( {e}^{j ω} )}{A ( {e}^{j ω} )} = \frac{{\sum }_{k = 0}^{q} {b}_{k} {e}^{- j ω k}}{1 + {\sum }_{k = 1}^{p} {a}_{k} {e}^{- j ω k}} \qquad ( 2.3 .1 \text{-} 1 )$$

Refer to equation (2.3-1),
1. If q=0, S [n] depends on previous values of itself, thus called an Auto-regressive (AR) model;
2. If p=0, S [n] is an weighted moving average of w[n] so it is called an Moving-average (MA) model;
3. If p≠0 and q≠0, S [n] depends on both its previous values and the moving average of w[n], so it is called an Auto-regressive moving-average model (ARMA).

Yule-Walker is a method for estimating frequency for AR models. For a real sequence S its steps are:
1) From its auto-correlation sequence generate a Toeplitz matrix:

$$[ \begin{matrix}r ( 0 ) & r ( 1 ) & & r ( n ) \\ r ( 1 ) & r ( 0 ) & & \\ & & & r ( 1 ) \\ r ( n ) & & & r ( 0 )\end{matrix} ] , \\ r ( k ) = \frac{1}{N} {\sum }_{n = 1}^{N - k} x [ n ] x [ n + k ]$$

Here the biased auto-correlation is used to ensure the matrix is positive definite. Unbiased auto-correlation can also be used and please refer to [Hayes, M.—Statistical Digital Signal Processing and Modeling (Wiley, 1996)] for detail.
2) Using either Levinson-Durbin or other method to solve

$$[ \begin{matrix}r ( 1 ) \\ \\ r ( n )\end{matrix} ] + [ \begin{matrix}r ( 0 ) & & r ( n - 1 ) \\ & & \\ r ( n - 1 ) & & r ( 0 )\end{matrix} ] \cdot [ \begin{matrix}{a}_{1} \\ \\ {a}_{n}\end{matrix} ] = [ \begin{matrix}0 \\ \\ 0\end{matrix} ]$$

3) Set

$${\vert {b}_{0} \vert}^{2} = r ( 0 ) + {\sum }_{k = 1}^{n} {a}_{k} r ( k )$$

4) Estimate the power spectrum as

$$\frac{{\vert {b}_{0} \vert}^{2}}{{\vert 1 + {\sum }_{k = 1}^{n} {a}_{k} {e}^{- jω k} \vert}^{2}} .$$

Experiments in FIG. 2.3.1.1-1 to FIG. 2.3.1.1-6 show that Yule-Walker method work for {drip height, drip size}×{speed I, II, III} data. These figures are drawn in logarithmic scale to make local peaks clearly visible, otherwise they will be scaled to become too small for viewing. Order of the AR model increase from 5 to 50 for each dataset.

If we compare (FIG. 2.3.1.1-1 and FIG. 2.3.1.1-3) and (FIG. 2.3.1.1-4 and FIG. 2.3.1.1-6), we would note that lower speed signal (speed I≈5.3 periods) requires higher order of AR model to achieve accurate frequency estimation than higher speed signal (speed III≈23 periods). This is consistent with the AR model: the lower the speed, the longer the period, therefore each S [n] would depend on a longer sequence of its previous values so that higher order AR model would better model the sequence and would therefore give more accurate frequency estimation.

Please also note that in FIG. 2.3.1.1-1 to FIG. 2.3.1.1-6, the axis label are already normalized to [0,π]. To get the number of periods for N sample points we simply multiply the peak's normalized X-axis value by N and then divide it by 2π. The calculations below use un-normalized indices for better accuracy.

For drip height, speed II≈13 periods signal, [0,π] is divided into 18000 parts and the number of periods should be counted from the index of maximum power spectrum value as

$$\frac{\frac{( Index - 1 ) \cdot π}{18000} \cdot N}{2 π} = \frac{( Index - 1 )}{2} \cdot \frac{180}{18000} = \frac{( Index - 1 )}{200}$$

TABLE 2.3.1.1-1
speed II drip height signal period estimation using Yule-Walker method

| | Period count (Underlined |
|---|---|
| AR order | numbers are indices) |
| 5 | (3391 − 1)/200 = 16.95 |
| 10 | (2659 − 1)/200 = 13.29 |
| 15 | (2665 − 1)/200 = 13.32 |
| 20 | (2777 − 1)/200 = 13.88 |
| 50 | (2528 − 1)/200 = 12.635 |

Compare it with method comparison in Table 2.2.3.3-1, we find that a higher order would usually be necessary to give accurate estimates, which is also consistent with our discussion on period length/dripping speed and model order above.

As we have discussed before, there are {AR, MA, ARMA} three types of parametric models. The reasons we choose AR over the other two types of modeling is because:
1. Sin general is a periodic signal, and obviously depends on its previous values. AR model fits this physical basis best; poor estimation might occur from MA model since its assumption is not consistent with the reality.
2. Most of the practical problem of frequency estimation would have power spectrum centered at certain frequencies which can be modeled with poles. For the same configuration of poles it would require much higher order MA model than AR model to approximate them.
3. Since from discussion 1 AR fits and from discussion 2 MA unfits, any ARMA model which satisfactorily models the signal would have AR as its dominant part. Therefore, it has no substantial difference from the AR model.

Although we have concluded that AR model is the best fit for our signal among parametric models, if the data quality is extremely well and/or some other processing are involved, the possibility of modeling the periodic IV monitoring signal using MA or ARMA model cannot be ruled out. Therefore, the previous discussion should only be regarded as a recommendation to real implementation rather than any limitation.

And of course just like the case with other methods, we could combine AR modeling with other methods, such as DFT, to achieve higher efficiency or improved accuracy.

### 2.3.2 Eigenvector/Subspace Method

### 2.3.2.1 Multiple Emitter Location and Signal Parameter Estimation (MUSIC) & Pisarenko Harmonic Decomposition

### Common Synonym:

Related: Pisarenko Harmonic Decomposition (Equivalent when M=P+1)

Multiple Emitter Location and Signal Parameter Estimation (MUSIC) is an improvement over Pisarenko Harmonic Decomposition. These methods are different in that the “spectrum” we get are no longer an estimate of the real physical power spectrum, but is only used to estimate the frequencies of complex exponentials.

In Pisarenko harmonic decomposition, S is assumed to be a sum of P complex exponentials in white noise. P+1 values of the autocorrelation sequence is either known or estimated. In the (P+1)×(P+1) autocorrelation matrix, the dimension of the remaining noise subspace would be (P+1)−P=1 and is spanned by eigenvector corresponds to the minimum eigenvalue νₘᵢₙ, νₘᵢₙ would be orthogonal to the whole signal space hence all signal eigenvectors, therefore

$${e}_{i}^{H} {v}_{min} = {\sum }_{k = 0}^{P} {v}_{min} ( k ) {e}^{- j k {ω}_{i}} = 0 , i = 1 , 2 , … , P$$

It follows that the DTFT of νₘᵢₙ would be zero at each ωᵢ, so its inverse (and the inverse of its squared magnitude) would exhibit sharp peaks at ωᵢ frequencies, and from that one knows the frequencies of the constituent complex exponentials.

That inverse, which we denote as

$$I ( ω ) = \frac{1}{{\vert {\sum }_{k = 0}^{P} {v}_{min} ( k ) {e}^{- j k ω} \vert}^{2}} = \frac{1}{{\vert {e}^{H} \cdot {v}_{min} \vert}^{2}} = \frac{1}{{\vert DTFT ( {v}_{min } ) \vert}^{2}}$$

is called pseudospectrum (or eigenspectrum) to differentiate it from the real/physical power spectrum which appeared in other methods.

Please refer to [§8.6, Hayes, M.—Statistical Digital Signal Processing and Modeling (Wiley, 1996)] for derivation and discussion.

In Pisarenko harmonic decomposition the number of signal eigenvectors is assumed to be the length of autocorrelation sequence minus one; if instead, this requirement is removed and for an autocorrelation matrix of M×M, P can take other values such that M>P+1, then it would become the assumption of Multiple Emitter Location and Signal Parameter Estimation (MUSIC) method.

It is therefore clear that when M=P+1, the two methods are equivalent, so that Pisarenko Harmonic Decomposition can be classified as a special case of MUSIC.

In MUSIC method, the Pseudospectrum I(ω) will then be calculated

$$\begin{matrix}{I}_{MUSIC} ( ω ) = \frac{1}{{\sum }_{i = P + 1}^{M} {\vert {\sum }_{k = 0}^{M - 1} {v}_{i} ( k ) {e}^{- j k ω} \vert}^{2}} \\ = \frac{1}{{\sum }_{i = P + 1}^{M} {\vert {DTFT}_{ω} ( {v}_{i } ( k ) ) \vert}^{2}} \\ = \frac{1}{{\sum }_{i = P + 1}^{M} {\vert {e}^{H} \cdot {v}_{i} \vert}^{2}}\end{matrix}$$

in which νᵢ's are the eigenvectors of the noise subspace. The effect of averaging would be reducing spurious peaks. Please also refer to [§8.6.3, Hayes, M.—Statistical Digital Signal Processing and Modeling (Wiley, 1996)] for detailed discussion.

The procedure of using Multiple Emitter Location and Signal Parameter Estimation (MUSIC, we have also classified Pisarenko harmonic decomposition as its special case) for estimating the signal frequency is:
1. If using the general MUSIC method, select P, and a M>P+1; if using Pisarenko harmonic decomposition, decide P and M=P+1.
2. Compute the auto-correlation matrix of dimension M×M
3. Calculate eigenvalues and eigenvectors of the auto-correlation matrix.
4. Compute Pseudospectrum I_{MUSIC}(ω). Find its frequency corresponding to the largest magnitude and use this as frequency estimation.

Of course, we can also use DFT to locate the interval and then use the MUSIC or Pisarenko harmonic decomposition for finer estimation.

Experiments have been done by setting M as signal S length, and vary P at different values between 2 and 50. The estimated period count for drip height signal at speed II≈13 periods is shown in the table. The underlined numbers are the indices of maximum pseudospectrum value and [0, 2,π] is divided into 10000 small increments. The period count is calculated as

$$\frac{X \cdot \frac{2 π}{10000} \cdot 180}{2 π} = 0.018 X$$

TABLE 2.3.2.1-1
period estimation for speed II drip height signal with different P

| P | Period count |
|---|---|
| 2 | (837 − 1) × 0.018 = 15.048 |
| 4 | (725 − 1) × 0.018 = 13.032 |
| 6 | (693 − 1) × 0.018 = 12.456 |
| 8 | (721 − 1) × 0.018 = 12.96 |
| 10 | (713 − 1) × 0.018 = 12.816 |
| 20 | (711 − 1) × 0.018 = 12.78 |
| 30 | (719 − 1) × 0.018 = 12.924 |
| 50 | (720 − 1) × 0.018 = 12.942 |

By comparing with Table 2.2.3.3-1 we could see that with properly chosen P MUSIC algorithm could result in an accurate estimation comparable with other methods.

FIG. 2.3.2.1-1 to FIG. 2.3.2.1-6 show these methods work for {drip height, drip size}×{speed I, II and III}. For drip size signal larger P such as over 80 might be needed, depending on the quality of the signal.

Please also note that FIG. 2.3.2.1-1 to FIG. 2.3.2.1-6 are shown in logarithmic scale. There are two reasons: (1) if it shown in linear scale, many of the smaller values would be hardly visible. (2) what is displayed is actually pseudospectrum, so we don't have to make them as in linear scale as shown for previous experiments.

We have therefore shown that frequency can also be estimated not by via any means to estimate the original power spectrum (periodogram or any other), but via its pseudospectrum through eigenvalue decomposition. We conclude that pseudospectrum methods can also be used for our IV speed monitoring application.

### 3. Mechanical Control

In application U.S. Ser. No. 12/804,163 we disclosed many essential techniques for video/image processing based IV monitoring. In previous sections of this disclosure we have expanded their scope.

In application U.S. Ser. No. 13/019,698 we disclosed mechanisms for controlling IV dripping speed, so with the monitoring and controlling combination an automatic IV monitoring and control system could be built.

In this section we are going to disclose other possible mechanisms for IV dripping speed control.

FIG. 3-1 is a general schematic of the mechanical sub-system of our IV monitoring and control system. A leadscrew is shown more prominently than other parts because we believe it is essential to the system. However, we stress that no limitation is made here that the real implementation must use leadscrew and its function can be substituted by other parts.

Following sections would frequently refer to FIG. 3-1.

### 3.1 Tube Presser and Supporter

Devices such as FIG. 3.1-1 are used in conventional gravity based dripping for adjusting drip speed. It works by pressing the tube to adjust its thickness. The presser rolls in a groove and changes the thickness of the tube by pressing it.

For an automatic controlled IV system we need something of the same functionality.

First we need something to press the tube so that the cross-sectional area where the liquid passes can be changed. This is not a particularly difficult problem. For example, we can control the tube thickness with our finger. Any mechanism that could effectively change the cross-sectional area of the tube could do the work.

There is no particular requirement on the shape of the presser and back supporter of the tube. Loosely speaking, as long as they can match well so that the tube surface can be effectively pressed, they could work. FIG. 3.1-2 shows the side (or front) view of some possible shapes of back supporter for tubes.

Viewing from the perspective of tube's axial direction (top/bottom), there can also be a numerous matching and complementary shapes to form the presser/supporter combination. Five examples are shown in FIG. 3.1-3.

On the left of FIG. 3.1-4, from top to bottom, we give example that the shape of the contacting point between presser and tube can of an angle, or flat, or rounded. On the right of FIG. 3.1-4, we see that angle can be obtuse, right or acute; it can either taper or expand; it can either have a sharp edge or a flat surface at the contacting point.

The formal requirement is very simple:
If adjusting the relative positioning of presser and supporter can cause the flow in the tube to stop, then they the two could be used a presser/supporter pair.

Please also note that although in the figures referred above we have seen a large number of pressers differ in shape, there are still other types of pressers that do not fall into this class. The presser/supporter pairs shown above are used for a linear actuator is pushing the presser directly toward the direction of the tube. Besides linear actuator, there are still

1. “Pivoted” “nutcracker” type, discussed in [§3.5.1].

2. Rotational type, discussed in [§3.5.2].

3. Cam embodiment, discussed in §3.6.

Please refer to FIG. 3-1 for the general schematics of the mechanical subsystem.

In the next section we are going to discuss linear actuator.

### Target

It would be desirable that a mechanism for IV control has the following characteristics:

1. High resolution so that the control can be accurate.

2. Self-locking so that no energy is required for maintaining control position.

3. Strong output force so that sufficient pressure can be applied on IV tube.

After comparing between different types of mechanisms, we found leadscrew is an ideal solution which satisfies 1-3.

### 3.2 Leadscrew

### Common Synonym: Power Screw

Leadscrew is a basic mechanical structure and is known to everyone work in mechanical engineering. Please refer to [§8.2, Shigley's Mechanical Engineering Design] for discussion and properties.

The formula of leadscrew from engineering textbook and manuals is a very close approximation of the exact result from calculus, and it is accurate enough for our use.

We have

$$\begin{matrix}\begin{matrix}{T}_{raise} = \frac{{Fd}_{m}}{2} ( \frac{l + πμ sec α {d}_{m}}{π {d}_{m} - μ sec α l} ) \\ = \frac{{Fd}_{m}}{2} tan ( {φ}_{eff} + λ )\end{matrix} & ( 1 ) \\ \begin{matrix}{T}_{lower} = \frac{{Fd}_{m}}{2} ( \frac{πμ sec α {d}_{m} - l}{π {d}_{m} + μ sec α l} ) \\ = \frac{{Fd}_{m}}{2} tan ( {φ}_{eff} - λ )\end{matrix} & ( 2 )\end{matrix}$$

### Where

Tᵣₐᵢₛₑ=raising torque
T_{lower}=lowering torque
F=load on the screw
dₘ=mean diameter of the ring on which screw and nut touch
α=thread angle
l=lead (thread pitch)
λ=lead angle
μ=coefficient of friction between external and inner thread material
φ_{eff}=effective friction angle, defined as φ_{eff} tan⁻¹ (μsecα). For square threads which has
α=0, φ_{eff}=tan⁻¹(μ) as the usually definition of friction angle.
Drawing of a leadscrew annotated with the above symbols is shown in FIG. 3.2-1.

Let's now examine why leadscrew has the three idea properties:

Property I: High Resolution so that the Control can be Accurate.

Lead l is usually very small. Consider one of the most common embodiment containing leadscrew, the linear stepper motor, l could be made as small as 0.5 mm, and each step's rotation could be made to as small as 7.5 so that the stroke of each step is only

$$\frac{0.5 mm}{360 / 7.5} = 0.01042 mm$$

whereas the thickness of an IV tube is usually between 3 mm and 4 mm so theoretically such a distance could be divided into 300˜400 parts if we assume that the tube thickness can be compressed to “zero”. Of course tube thickness cannot be compressed to zero and usually remains 1 mm or more even when fully pressed, the figure above still gives a correct estimate of the precision.

Property II: Self-Locking so that No Energy is Required for Maintaining Control Position.

$$\begin{matrix}{T}_{lower} = \frac{{Fd}_{m}}{2} ( \frac{πμ sec α {d}_{m} - l}{π {d}_{m} + μ sec α l} ) \\ = \frac{{Fd}_{m}}{2} tan ( {φ}_{eff} - λ )\end{matrix} \qquad ( 2 )$$

Please refer to [§8.2, Shigley's Mechanical Engineering Design] for this property. Intuitively, if the friction coefficient between leadscrew and nut surface is extremely large, it would become difficult if we try to make the leadscrew rotate by pushing against its axis; or, if the lead l is zero which means there is no vertical ascending/descending movement, force on axis create no torque so it is also impossible to rotate the leadscrew reversely. Mathematically, if

$$\begin{matrix}{T}_{lower} = \frac{{Fd}_{m}}{2} ( \frac{πμ sec α {d}_{m} - l}{π {d}_{m} + μ sec α l} ) \\ = \frac{{Fd}_{m}}{2} tan ( {φ}_{eff} - λ ) > 0\end{matrix}$$

$$then$$

$${πμsecαd}_{m} - l > 0 ⇒ μ > \frac{l}{π {d}_{m}} \cdot cos α = tan λcosα$$

which actually suggest that no axial force F alone, without external torque, could cause the leadscrew to rotate reversely.

The important consequence of self-locking property is that power-efficient portable IV controller can be built. Torque in motor is created by electromechanical force, and if torque is still needed to maintain a position, then there would be a constant drain of current from the battery, and this current in fact could be very significant so that battery would soon be used out.

One could also use rubber or spring based brakes to maintain position which could also save power, but this would require additional mechanisms which are bulky and costly. In addition, for rubber brakes wastage might cause it to gradually lose its ability.

Requiring only one inequality μ>tan λ cos α to be satisfied, leadscrew provides us the simplest and most reliable solution to the problem.

Property III: Strong Output Force so that Sufficient Pressure can be Applied on IV Tube.

Due to

$$\begin{matrix}{T}_{raise} = \frac{{Fd}_{m}}{2} ( \frac{l + πμ sec α {d}_{m}}{π {d}_{m} - μ sec α l} ) \\ = \frac{{Fd}_{m}}{2} tan ( {φ}_{eff} + λ )\end{matrix} \qquad ( 1 )$$

The force creating the torque

$$\begin{matrix}{F}_{raise} = \frac{{T}_{raise}}{{d}_{m} / 2} \\ = F \cdot tan ( {φ}_{eff} + λ )\end{matrix}$$

$$\frac{{F}_{raise}}{F} = tan ( {φ}_{eff} + λ )$$

Usually ii is small so tan λ≈0,

$$\begin{matrix}\frac{{F}_{raise}}{F} = tan ( {φ}_{eff} + λ ) \\ = \frac{tan {φ}_{eff} + tan λ}{1 - tan {φ}_{eff} tan λ} \\ \approx tan {φ}_{eff} \\ = μ sec α\end{matrix}$$

For materials μ is usually between 0.1 and 0.3, and usually α≦30 so that

$$sec α \leq sec ( 30 ) = 2 / \sqrt{3} = 1.1547 \\ ∴ \\ μsecα \leq 0.3 \times 1.1547 = 0.334641$$

So at most ⅓ of F is sufficient to raise (push) against it. And clearly here we are already calculating the upper bound of the ratio

$$\frac{{F}_{raise}}{F}$$

so that for most metallic material combinations and thread angles the ratio is even smaller.

We have therefore concluded that leadscrew is an ideal mechanical structure for controlling IV dripping speed.

### Comment on Linear Motor:

Almost all types of linear motor use leadscrew as their linear actuator. However, not all linear motor, and not even all linear steppers have properties I, II and III. Some are designed to have low friction coefficient μ and high lead angle λ so that II is not satisfied. In fact, it is not a rule that manufacturer would simultaneously consider these three requirements for generic types of linear motors.

Some people might ask why we choose the term “leadscrew” rather than “linear motor” since most linear motors are based on leadscrews. There are chiefly two reasons for this:
1. A linear motor, or any motor, is an assembly and combination of different components.

In analyzing its mechanical property each components has to be analyzed separately first, and indeed we find that if a linear motor does have property I, II and III, in most cases (except when, say for property II, braking is used, or with other components) it is because its leadscrew has such properties. Being called “linear motor” doesn't guarantee I, II and III. Therefore we find it is more appropriate to refer to the essential element rather than an ensemble with other parts.
2. Leadscrews can be used in many other places besides within linear motor. In fact, as FIG. 3-1 would show, it might appear for one or more times at different places for translating rotary motion into linear. For example, a linear rail/slide could have leadscrew, but it might not use the electrical part of motor at all so that naming it as a “motor” is obviously inappropriate. It is therefore better to use the name “leadscrew” alone to direct our attention to its distinct properties.

### 3.3 Linear Motion Guide

In [§3.1 Tube presser and supporter] we already got many choices of presser/supporter pairs and in [§3.2 Leadscrew] we have investigated property I, II and III of leadscrew. It looks they two alone could already result in a good tube thickness control, so why do we still need linear motion guide?

This is because of the existence of off-axis displacement. In FIG. 3.3-1, the ideal travelling direction of the presser would be in the direction of the two dashed lines drawn parallel. However, due to tolerances in manufacturing, spaces between the screw-nut fit as well as other deviations/displacements such as propagated from the rotary motion of the motor rotor, the off-axis displacement would more or less always exist.

The angles δ₁ and δ₂ in FIG. 3.3-1 are exaggerated. However, the consequence that it cause the tube incapable of being fully closed, or the liquid cannot be cut controlled to drip slow enough, is realistic. In our experiment with a moderate quality linear stepper mounted with very finely manufactured presser of several different shapes, the problem in FIG. 3.3-1 existed and persisted. At the beginning the presser could effectively cut the speed down to a certain level, but after that the presser could no longer go forward, and a closer examination finds that one side of the presser is already touching the tube support while another side is off from it, and in the space between the drips could still flow, albeit slowly.

We want to emphasize that our experiment found that the relationship between tube thickness and drip speed is STRONGLY nonlinear. For example, a common inner thickness of the tube is 3 mm, and typical stepper motor could have strokes as small as 0.0254 mm, so in theory dividing this 3 mm into 3/0.0254=118.11 parts. However, experiments show that in no way is the tube thickness-drip rate relationship linear, and for most of the initial steps, say, might over 80 out of the total 118, the drip rate remain almost unchanged, and the change only happens in the last few dozens of steps, so that each steps alone might results in a perceivable change in dripping speed.

If the off-axis displacement is large like in FIG. 3.3-1, in effect it impedes the position of a number of final steps so speed corresponding to this range is not reachable. This is unacceptable in real applications because:
1. After dripping has finished, the tube has to be cut off to prevent blood from flowing back into the tube. This is a basic requirement for an automatic IV monitoring and control system.
2. Some applications do require low speed control. For example, for newborns the speed requirement could be as low as to 1 drip/every 3 seconds.

So the problem of off-axis displacement must be resolved. There a number of approaches to solve this.

In FIG. 3.3-2, key/keyway combination is used; in FIG. 3.3-3, spline/groove is used. Note that there is no rigid restriction on:

1. Whether key/keyway or spline/groove is on the inside or outside.

2. Whether the spline/groove span the full circle.

And although we have drawn leadscrew as the linear actuator in the two figures, we by no means require that spline/groove or key/keyway must be used on leadscrew driven parts. They can be used to guide linear motion resulted from any component(s).

Yet another way for to guide linear motion is by using bearings. FIG. 3.3-4 shows bearing(s) can be either on the outside or fit within groove/channel/track cut within the moving parts.

All the three methods used here have proven effectiveness. They can be used individually or even in combination to achieve the best result.

So far we have been dealing with actuators (although not assuming the final presser would also be driven by linear actuators). At the final stage where presser presses the tube, we could also use several types of rotational components.

### 3.4 Leadscrew is Only One Type of Linearly Moving Parts

We want to emphasize that there is no restriction that the linear motions guides discussed above apply only to leadscrews. They are generic and apply to all types of linear moving parts regardless of how the linear moving parts are driven. FIG. 3.4-1 show one of the numerous possible ways of creating a linear motion in that a leadscrew first causes the rotation of one side of a lever, the rotation of the other end of the lever then causes the linear movement of a slider/presser. Bearings have been used for both the leadscrew nut and the slider but of course spline/groove and key/keyway can also be used.

Recall that in mechanical system schematic FIG. 3-1, the linear motions guides only follows the block of “linear motion”, not the block of “linear motion after leadscrew”. The example of FIG. 3.4-1 illustrated the difference.

We also note that in the example of FIG. 3.4-1, the use of lever further enhanced the precision of presser movement as well as magnified the force. Of course it can be used a multiple of times in different places so that it contributes to enhanced precision and magnified force for a multiple number of times.

The lever length ratio shown here are only for illustrational purposes. Levers can be classified into three classes according to the relative position of the fulcrum, the load and the force and the type that the load is between the force and the fulcrum can also be used.

And we also emphasize that also we used a groove to connect between lever and linearly moving parts (the nut and the slider/presser here), other ways of connection could also be used. However, none would differ substantially from the leverage principles we illustrated here.

### 3.5 Rotational Presser

### 3.5.1 Pivoted “Nutcracker”

This mechanism is simple, low cost, and has been tested to be very effective in operation.

Recall that the motivation for introducing “linear motion guide” is because of the off-axis displacement. This displacement is very small and in many applications might not matter at all, but causes problem to us due to the small diameter of the tube and the nonlinearity of tube thickness-drip speed relationship.

The principle used by key/keyway, spline/groove and bearing is to prevent off-axis displacement by hold, grip or push firmly against it. The pivoted nutcracker works by absorbing it.

FIG. 3.5.1-1 shows the drawing. The tube's supporter and presser are assembled together at a pivot on which the presser or both the presser and the supporter could turn about. The fit at the connection should not be too tight to prevent the turning.

A linear motion, either guided by {key/keyway, spline/groove, bearing, etc.} or not, now causes the presser arm to rotate about the pivot. The tube back supporter would be fixed and not allowed to move, or it might also be allowed to rotate and be connected to a driving part. The closing of the angle between the presser and tube supporter compresses the tube, and the opening does the reverse.

Since the essential of this machinery is the relative rotational movement of the presser and the supporter, either or both of them can be driven to rotate. For brevity in the following discussion we only describes the construction and the connection of the presser with the driving parts, which are equally applicable to the supporter if the supporter is also allowed to move.

To translate the linear motion into rotary, a groove of uniform width is cut in the presser. The width of the groove is slightly larger than the diameter of a sphere or cylinder mounted at the head of the linear motion part so that when the linear parts moves forward or backward along its axis, the sphere or cylinder could have a relative sliding movement within the groove.

A question is why do we have to use sphere or cylinder shape to fit into the groove? Because when the linear part moves and the presser arm rotates, if we study the relative motion of the presser arm using linear part's head (the contacting part with presser's groove) as the coordinate origin, we found that the presser arm is in fact rotating about the contacting part, along with a radial movement. It is impossible for a part that does not assume a round shape or circular circumference in at least one of its cross-sections to allow something connecting with it to rotate smoothly without repeated colliding. Such a desirable feature is only possessed by shapes having round shape or circular circumference in at least one of its cross-sections, and this is therefore necessary.

The length of the presser arm is usually much larger than then 3 mm-around diameter of the tube, and the sphere/cylinder mounted at the linear motion part touches the groove sides also at a distance from the pivot usually much larger than 3 mm tube diameter. The opening angle between presser arm and the tube supporter, denoted by θ, would be an angle at most times smaller than 15.

It is visually and intuitively clear that when the sphere/cylinder moves, most of its motion will be translated into the rotation of the presser arm. To quantitatively characterize it, see FIG. 3.5.1-2, assume the sphere is pushing the presser forward at present (since its forward and backward contact points with groove are different) and the distance between the touching point and the pivot is R, and the movement of the sphere can be decomposed into two orthogonal components:

1. dy=forward movement

2. dx=off-axis displacement

dx and dy could in turn be decomposed into yet another two orthogonal directions:

(1) The rotational direction

(2) Radial direction

The components on the radial direction would not cause any effect. Let's consider only the rotational direction. From FIG. 3.5.1-2:

$${dy}_{rotation} = dy cos θ , \\ \frac{d {y}_{rotation}}{d y} = cos θ$$

$${dx}_{rotation} = - dx sin θ , \\ \frac{d {x}_{rotation}}{d x} = - sin θ$$

The fact that

$$\frac{d {x}_{rotation}}{d x} = - sin θ$$

tells us that only a very small portion of the off-axis movement would enter into rotational movement. Recall the nonlinearity relationship which means the real critical speed control happens at the last several decades of steps so that θ value corresponding to these critical steps can be even smaller. If θ=10, then |−sin θ|=|sin 10|=0.1736, as much as 82% of the off-axis movement is “absorbed” by the radial direction.

The smaller θ is, the better would this “absorption” be. When the presser and the tube supporter gets close and the tube is almost fully cut, the remaining θ→0, |sin θ|→0, so almost all off-axis displacement are absorbed, and we never get the situation like that the shown in FIG. 3.3-1 at all.

In addition to solving the problem of off-axis displacement, the pivoted arm also enhances the precision by ratio of the horizontal distance D between sphere/cylinder's touching point to the pivot and the horizontal distance d between presser arm and tube's touching point to the pivot. By the principle of lever this also magnifies the force by D/d. Please see FIG. 3.5.1-3 in which this relationship is shown using similar triangle property.

Recall that in [§3.3 Linear Motion Guide], we mentioned 0.0254 mm (0.001 inch) is a common stroke distance for linear stepper motors and it is roughly 1/118 of a 3 mm inner diameter of an IV tube. With the use of this pivoted “nutcracker” presser, this 118 parts division could be further divided by a ratio of D/d which results in even finer precision over the dripping rate control.

We summarize the three key advantages of using the pivoted structure:

1. Absorbing off-axis displacement of linear actuator.

2. Magnify pressing force.

3. Enhance precision.

And we mention possible variation: it is not necessary that the linear actuator pushes/drags the presser; it can push/drag either the presser arm or the tube supporter (when it allowed to move) to create relative movement; there can also be more than one such linear actuators to drive both of them.

And we give the formal characteristics of the pivoted “nutcracker” structure:
1. The presser and tube supporter are connected at one end which allows the relative rotational movement between the two parts.
2. One or more linear actuator(s) that push(es) or drag(s) the presser and/or tube supporter to open or close the angle between them.

The connector between the linear motion part and the arm groove would usually have a sphere or cylindrical shape. By cylindrical shape, a bearing is also allowed. The essential characteristics is that is must have in at least one of the numerous cross-sectional surfaces a circular circumference which would allow it to move smoothly with in the groove. Other variations are possible at the cost of probably additional difficulty.

Amend: Please also note that the linearly moving part can contact the presser at any location in any geometric configuration, not necessarily on approximately the half-line/ray which start from the pivot and pass through the contacting point of the tube with the presser or supporter. An example is shown in FIG. 3.5.1-4.

### 3.5.2 Rotational Pivoted “Nutcracker”

The pivoted “nutcracker” does not necessarily require linear actuator. FIG. 3.5.2-1 shows a variation which is by connecting the shaft of a rotational motor to either of the presser or supporter so that the rotation of the motor could result in the change of angle between the presser arm and supporter. In this configuration spherical/cylindrical shape and groove is not needed.

Of course, it is also possible that presser and supporter are both driven by rotational components, or even in a mixed combination that one part's rotation is driven by a linearly moving part, and another part's rotation is imparted by a rotational component. The essential result (and hence definition) would always be the relative rotation of the two parts.

Nor does the rotation need to be driven directly by a motor. It is perfectly possible that there are other mechanism between the motor and the presser/supporter through which the linear motion is conveyed. For example, one might use gear(s), which also enhance the precision as well as magnifying the force.

There is also no requirement on whether the part imparting rotation to the presser or supporter has a fixed axis of rotation, which means itself is also allowed to move to some extent. The defining characteristic is only the imparting of rotational motion from one part to another (presser/support).

And we give the formal characteristics of the pivoted “nutcracker” structure:
1. The presser and tube supporter are connected at one end which allows the relative rotational movement between the two parts.
2. Rotational actuator(s) connected to presser and/or tube supporter, directly or via other intermediate mechanism, whose rotation(s) result(s) in opening or closing the angle between them.
   would the Tube Slip?

A question is that whether the tube position would slip when the presser presses or release it. As long as the surfaces of the presser and supporter are not extremely slippery, this would not happen. In real implementation there should be fixtures of the tube at a location close the presser/supporter so that tube's position is held.

### 3.6 Cam Embodiment

Cams can also be used to convert a rotary motion into linear. There are numerous types of cams and we have shown in this illustrational embodiment a spiral. There are five positions shown in FIG. 3.6-1 to show how rotation of the cam would drive the linear motion of the presser.

In each of the subfigures in FIG. 3.6-1, the central circle in the front view is the motor shaft. A board is connected to the shaft and a groove is cut on the board. The geometric shape of the groove is the envelope a circle or any shape assuming circular circumference in at least one of its numerous cross-sections, running with its center moved along a spiral curve. If the groove rotates in the clockwise direction, the presser will be pressed to the right through the cylindrical connector that is fitted into the groove, and will be pulled to the left if the groove rotates in the anti-clockwise direction.

A same question as having already been asked in [§3.5.1 Pivoted “nutcracker”] is that why do we have to use the envelope of a circle or shape having at least in one cross-section a circular circumference? If we study the relative motion of the presser or the rod (the part connecting presser with the cam. Not necessarily a rod but called here for convenience) using the rotational center of the cam as the coordinate origin, we found that the rod is in fact rotating about the cam's center while simultaneously having radial movement. It is impossible for a part that does not assume a round shape or circular circumference in at least one of its cross-sections to allow something connecting with it to rotate smoothly without repeated collision. Such a connecting part must be round or having at least one cross-section with circular circumference, and therefore its envelope is the shape the groove needs to take.

For simplicity of discussion in the following we discussion we use Archimedean spiral as illustration, in practice one can use cam of any shape as long as the desired control can be achieved.

If we assume the geometry of Archimedean spiral is used, since spiral's polar equation is:

r=c+αθ

c is always a constant. If we want one full rotation to cause the presser to move a distance of 3 mm, which is the a common inner diameter of an IV tube, then

3 mm=Δr=αΔθ=α·2π

∴α=3 mm/2π

We can in this way calculate parameters of the spiral. For ease of manufacturing such that the groove's two ends would not touch each other, we might also prefer to choose rotation smaller than a full circle.

The relationship between rotary and linear motion translation from a spiral cam is linear. To better accommodate the non-linear relationship between tube-thickness and dripping speed, we could of course design cams of other shapes based on experiments and calculation.

Cams are not self-locking so that a steady current might be needed to maintain its position. To lock the cam without continuous current, one might, in the following steps:
1. Use gear combination to magnify the rotation such that a small rotation would result in a much larger rotation of a plate. The plate has slots or holes evenly or unevenly spanned in different directions.
2. Use an electromagnet to lift a small object connected to a spring or other component(s) of elastic nature. When the electromagnet is off, the spring will push the small object into a hole or slot of on the plate, therefore locking its position; when the electromagnet is on, it will lift the small object up and the plate, consequently the motor shaft and cam, would be allowed to move again.

Using the same electromagnet with rubber-spring combination is also possible. Rather than holes on the plate, friction of the rubber could also prevent the cam and shaft from rotating.

Please also note that, although for better control in FIG. 3.6-1 example we used a cam in conjunction with bearing to guide the linear motion of the presser, a cam structure can also be used alone so that is edge directly touches the IV tube. For the example of Archimedean spiral, the change of θ results in the change of radial length hence can be used to directly press the tube. It is also a possible implementation although issues such as slipping of the tube needs to be properly addressed.

Also, since the nature of cam is for translating rotary motion into linear or vice versa, cam can also be used in other parts of the system without directly driving the presser. It can be used to either translate rotary motion into linear or linear motion into rotary in any parts of the system, which is what it by its nature does.

### 4. Illumination

### 4.1 Good and Bad Illumination

In this section we describe how illumination should be done for the IV monitoring system. Since the dripping speed is monitored by extracting a periodic signal such as the height or size of the drip, it is then critical that the image of the observed area must be clear.

FIG. 4.1-1 shows examples good illumination. LED lights in this example are projected from the top of the chamber through a light director/blocker shown in FIG. 4.10-1. The overhead lighting creates no spurious brighter spots from drip chamber surface's reflection in the image.

FIG. 4.1-2 show three examples of poor illumination where reflections of LED light on the drip chamber surface make video/image processing difficult. In these images the LED are placed on the side so that the dripping mouth and drip, although surrounded in brighter reflections of the chamber, are still visible. If light is projected from front or back of the chamber, the drip mouth and drip could be completely masked out by the brighter area(s) either due to light itself (from back) or its reflection (light in front).

FIG. 4.1-3 explains the reason for the bright reflection points/areas. Denote the distance between an idealized point light source and the drip chamber as D, and a length on the drip chamber surface dx,

$$\begin{matrix}x = D tan θ ⇒ dx \\ = D {sec}^{2} θ d θ\end{matrix}$$

$$\frac{d θ}{d x} = \frac{{cos}^{2} θ}{D}$$

And because the power of a light source at a distance is evenly distributed over a spherical surface with that distance as radius, the light power at dx is inversely proportional to the square of its distance from the point source:

$${P}_{light} ∝ \frac{1}{{( D sec θ )}^{2}} = \frac{{cos}^{2} θ}{{D}^{2}}$$

It follows that the light average light power over dx is proportional to

$$\frac{d θ}{d x} \cdot {P}_{light} = \frac{{cos}^{2} θ}{D} \cdot \frac{{cos}^{2} θ}{D} ∝ {cos}^{4} θ \qquad ( 4.1 \text{-} 1 )$$

This how brighter reflection points/areas result.

The reflection interferes with drip detection for two reasons:
1. A large portion of light is reflected back before they could touch and be reflected by the drip.
2. The area(s) caused by these reflections are usually brighter than reflections from the drip, or overlapped with the drip.

### 4.2 Principles of Reflection/Brightness Contrast Reduction

The analysis on the reason of brighter drip chamber surface reflection spots leads immediately to principles of its elimination/reduction:
1. Increasing the distance between the light source and the drip chamber. This is shown in FIG. 4.2-1. For a given x, larger D→smaller θ→larger cos θ→larger cos⁴ θ, therefore the contrast in brightness between different locations would become smaller.
2. Cancelling the effect in the ensemble effect of multiple light/point sources. Refer to FIG. 4.2-2, if a single point source S₁ projects different area's average light power to points P₁ and P₂, then if another point source S₂ is placed symmetric to S₁ about the parallel line going through the midpoint of P̅₁̅P̅₂̅, then the area's average light power at P₁ and P₂ would be equal due to the contribution of both S₁ and S₂ because the difference resulted from each of them cancelled. The more of point sources there are and the more scattered they are about the drip chamber, the better cancellation would we have.

Yet another way makes no attempt to reduce reflection/brightness contrast; it simply shifts them to another location so that it is would not enter into the view of the image capturing device.
3. Projecting light from a direction so that less reflection/brightness contrast would be seen from the viewpoint of the viewing system.

Most of the methods to reduce reflection below can be classified into the above three classes and we will refer to the two principles when a method makes use of it.

We first define two types of light sources:

Primary light source: A light source where a physical quantity of other form is converted into light. This includes LED light, incandescent light, infrared lights, ultraviolet lights, laser and any other type of light sources.

Secondary light source: A light source whose lights are directed from one or more primary light sources by optical devices. Illumination using optical fiber, light-tube/light-pipe/integrator bar, assembly of mirrors' reflection, reflective surface all belong to this type.

It is clear that although secondary light source offers more flexibility, both types are equally suited for our application. And when we use the word “light source” in following discussion, it refers to both types unless explicit qualification is made.

### 4.3 Multiple Light Sources

As shown in FIG. 4.3-1, by putting multiple lights at different locations around (not necessarily fully around) the drip chamber, the reflection effect can be mitigated or eliminated. In the extreme and idealized case where there are numerous small point sources surrounding the chamber, the “point source effect” would not exist.

Apparently, this method the 2^{nd} principle of “cancellation” for reflection/brightness contrast reduction.

The type of light source here can be either primary or secondary type. The symbol of light source in FIG. 4.3-1 looks like suggesting primary type, which is only for better illustration when comparing with FIG. 4.4-1.

There is also no requirement on how far should each of the multiple light sources be separated. In fact, as we have reasoned in the 2^{nd} principle of “cancellation” and in FIG. 4.2-2, even a second light source as close to the drip chamber as the original light source could effectively cancel a large portion of unevenness in brightness. Therefore, it is perfectly possible to use an array of light sources close to, concentrated or near the original single light source location to cancel the unevenness of each. Such array of light sources can also be manufactured integrated in a package, either LED or other type, which contains an array of light-emitting elements. This should also be considered as an instance of the multiple light sources.

4.4 Multiple Sources from Secondary Light Source

FIG. 4.4-2 illustrates the principle of light tubes. Each light source (whatever type) is in fact composed of numerous point sources. The image of each point source from the lens (or itself directly; the lens makes the illustration clearer, but necessarily required in products) would emit rays that travels through different numbers of reflections before exiting. Upon exiting the light tube, the effect looks like numerous rays are coming from the point source's numerous virtual images so that it no longer behaves like a point source, but in effect similar to a scattered/diffusive light source. Please refer to [p. 105, Smith, Warren J., Practical Optical System Layout and Use of Stock Lenses].

The principle of light tube is unique in itself. Although similar to the 2^{nd} “cancellation” principle of reflection/brightness contrast reduction, it is more appropriate to leave it as a single class alone rather than classified into the cancellation principle.

Note that we use “light-tube” as an umbrella term for

1. Light-tube, light-pipe, integrator bar

2. Optical fiber

3. Bundles of the above

FIG. 4.4-1 show that how a single light source (of any type) can be used to create multiple secondary light sources via light-tube. For thinner types of light-tube such as optical fiber, bundles of them can be used together.

When light tubes are used in this way, they apparently use the 2^{nd} “cancellation” principle of reflection/brightness contrast reduction.

4.5 Light Source from Mirror Reflection

FIG. 4.5-1 shows that assemblies of mirror can also be used to direct light so that multiple light sources can be created from a single one. It can of course be used just to direct a single light without creating a multiplicity of them.

If by mirrors a multiplicity of images are created from a single light source at different locations around the drip chamber, then it uses the 2^{nd} “cancellation” principle of reflection/brightness contrast reduction.

If by mirrors the image of light source is formed at farther from the drip chamber than the original light source itself before it is used to illuminate the drip chamber, then it uses the 1^{st} “increase distance” principle of §4.2 of reflection/brightness contrast reduction.

Any shape of mirrors can be used since it is only used to direct light, not the image. The shape might be arbitrarily curved or assuming particular geometric shapes. It also does not matter whether such mirror of shape, when used in ordinary occasions, might create some “bizarre” effect or not. Any type of mirror could be used as long as it could direct light.

4.6 Magnified Light Source from Lens

Another idea is “magnify” the original light source to reduce or eliminate reflection/brightness contrast. In FIG. 4.1-3 and FIG. 4.2-2, if the light source is of a dimension comparable to that of the illuminated object (drip chamber), then the effect would be like that there are many different small light sources illuminating the drip chamber from different locations, so that much of the uneven illumination of each would be cancelled out in the aggregate effect.

This is illustrated in FIG. 4.6-1. Assuming we are using a thin lens and since

$$\frac{1}{{S}_{object}} + \frac{1}{{S}_{image}} = \frac{1}{f}$$

When f<S_{object}<2f, an inverted and magnified real image will be formed on the other side of the lens.

This apparently uses the 2^{nd} “cancellation” principle of reflection/brightness contrast reduction.

When S_{object}<f, an upright and magnified virtual image will be formed on the same side (with the light source) of the lens.

This uses the 2^{nd} “cancellation”, as well as the 1^{st} “increase distance” principle of reflection/brightness contrast reduction, because the image of the light source is now farther from the drip chamber than the original image source.

In both these cases we get a magnified lighting source by which chamber surface reflection can be reduced.

The case when S_{object}=f which leads to parallel outgoing lights is not listed because real light source has certain dimensions. When S_{object} is close to f, points on it can be any of three cases. The ensemble effect, however, would always be that the chamber surface reflection are reduced.

There are numerous ways of creating lens. For a simple lens, each surface can be either convex, concave, or flat; for thick lens the ability of converging light also depends on its thickness; for combinations of lens the possibilities are impossible to enumerate.

But we do have a common characteristic to indicate the suitability of lens for our application: the focal length, or in lens combinations or thick lens, effective focal length (EFL).

It can be proved that only optical systems (generalizing the concept of single lens) with a positive focal length or EFL could create a magnified image or causes the image to appear farther from an observer at the other side than the original. We therefore conclude that: any optical system with a positive EFL could be used to create magnified image of the light source, either farther from the drip chamber than the original light source or nearer, for our application.

### 4.7 Using Reflective Surface

We might also use a reflective surface to eliminate the chamber surface reflection effect. This method might be regarded as a generalization of the mirror reflection [§4.5 Light source from mirror reflection] in that the surface can be curved rather than being flat.

Certain shapes possess useful geometric properties which we could utilize, see FIG. 4.7-1:
1. Ellipse or ellipsoid: light rays emitting from one focus would all be reflected to the other focus.
   Usefulness: ellipsoid has a large amount of coma that smears out the image of the light source and the many number of small area mirrors sees the light source from different viewpoints so that the final image of the light source is blurred [p. 105, Warren J. Smith, Practical Optical System Layout and Use of Stock Lenses].
   Principle: though bearing some similarities to the 2^{nd} “cancellation” principle of reflection/brightness contrast reduction, it is better to be classified as a class of its own.
2. Parabola or paraboloid: light rays emitting from the focus would be reflected so that all are become parallel with the axis (the symmetric axis of the shape itself).
   Usefulness: the reasoning of FIG. 4.1-3 is immediately invalidated because lights are now like parallel lines coming from infinitely far.
   Principle: better to be classified as a class of its own.
3. Hyperboloid or hyperbola: light ray emitting from one focus would have their backward extension lines converge at the other focus so that it looks like the light is coming from the virtual image at the other source.
   Usefulness: The virtual image of the light source would become farther from the drip chamber than the light source itself, this means that D in FIG. 4.1-3 becomes large, hence θ would become smaller for a certain location x on the chamber surface. Recall that in formula (4.1-1) the average project light power for a certain dx is proportional to cos⁴ θ. The increase of D lowers θ hence increase cos θ and cos⁴ θ so that the brightness contrast would be reduced. If the distance D between the virtual image of the light source and the drip chamber is large enough so that for all points on the drip chamber cos θ's are large enough (say, like 0.9), then the 4^{th} power of cos θ would not be a significant small figure so that the contrast in brightness would not be strong.
   Principle: the 1^{st} “increase distance” principle of reflection/brightness contrast reduction.

Note that by using “ellipsoid”, “paraboloid” and “hyperboloid” I am referring to the three-dimensional shape, rather than the two-dimension curve. For 3D shapes, it would be symmetric about the axis of rotation; for 2D curve, it would be necessary move the curve to create a surface it sweeps. Please see FIG. 4.7-2.

Also note that in both FIG. 4.7-1 and FIG. 4.7-2, light blockers are used to block the direct path between the light source and the drip chamber. This is an essential element or the reflection/brightness contrast would still exist.

The defining characteristics of this class of reflection/brightness contrast reduction are:
1. A light blocker (which can either be made/integrated as part of the light source to prevent it from scattering light to all directions, or separate from the light source) that blocks the direct path between the light source and the drip chamber.
2. A reflective surface whose reflection the light source uses to illuminate the object indirectly.

As long as the above two characteristics are satisfied, there is no substantial difference on whether the surface is very smooth, smooth or rough because inherently we have no strict requirements on the reflective surface itself and is not interested in obtaining its image, either blurred or sharp, but only uses it to redirect the light so that reflection/brightness contrast could be reduced.

In [§4.9 Merging reflective and rough surface definition], we merge the definition so that reflective surface is defined for all levels of smoothness.

### 4.8 Using Rough Surface

We might also reduce or eliminate reflection or brightness contrast using a rough surface. By “rough” I intended to mean having lots of unevenness in the surface such that a ray or a thin bundle of light would be scattered to all directions at the vicinity of a single point. However, it is as difficult to define as to quantitatively define what is “smooth” or “reflective” due to the subjective nature of these adjectives. I define here:

### Definition:

1. “smooth” is equivalent to “reflective” in our terminology
2. There shall be only two types of smoothness: reflective or rough. We classify any surface, or part of a surface, to one and only one class of the two.

A rough surface is shown in FIG. 4.8-1 and it also requires a light blocker to prevent light from illuminating the drip chamber directly.

The defining characteristics of this class of reflection/brightness contrast reduction are:
1. A light blocker (which can either be made/integrated as part of the light source to prevent it from scattering light to all directions, or separate from the light source) that blocks the direct path between the light source and the drip chamber.
2. A rough surface whose scattering the light source uses to illuminate the object indirectly.

The effectiveness of rough surface for reducing reflection/brightness contrast can be confirmed by looking at FIG. 1.1-1A, which was shot in a room environment with walls of rough surface and a fluorescent lamp blocked from illuminating the IV sets directly. There are only weak reflections on the two sides of the drip chamber which does not interfere with the upper central image of the drip(s).

### 4.9 Merging Reflective and Rough Surface Definition

The difficulty in dichotomizing reflective and rough surface can actually be resolved through the following definition merging process:
1. Since for rough surface the shape doesn't matter, it can therefore take any shape including shapes use by reflective surface, for example, conic section surfaces.
2. By combining the two subjective words “reflective” and “rough”, we can simply define “surface of any level of smoothness/roughness”.
3. We therefore concluded that “surface of any level of smoothness/roughness”, assuming proper or arbitrary geometric shape so that its reflection of the original light source, when the original light source is blocked from illuminating the drip chamber directly, illuminates the drip chamber so that there is no or only weak reflection/brightness contrast, can be used for our application.

### 4.10 Avoid Shooting the Reflection/Brightness Contrast

The final method we disclose does not require any of the optical constructs previous described. This uses the 3^{rd} principle “Projecting light from a direction so that less reflection/brightness contrast would be seen from the viewpoint of the viewing system” of §4.2.

FIG. 4.10-1 shows that we could use light director/blocker extending from covering part of the drip chamber to covering part of the light source, on either the top or bottom of the drip chamber. Light will be guided so that so that it comes into the chamber from the top/bottom when the camera (or any lens of the optical system, refer to FIG. 0.1-1) is situated on a horizontal side of the drip chamber.

Under this configuration, light rays incident on the top surface of the drip chamber will partly be reflected and the remaining would enter the chamber. Part of the coming rays might also touch the surface of the drip chamber that is no covered by the light blocker, but would not create brighter spots both due to the limited amount of these rays as well as the small incident angles they could make with the drip chamber surface. The drip(s), on the other hand, generally assume spherical or elongated spherical shape so it could effectively reflect incident rays to other directions for which reason it would become the brighter spot(s) in the view of the camera.

The effect of using director/blocker to guide light source from the top and taking video from the side has already been shown in FIG. 4.1-1 (These images were taken with LED light projected via light director/blocker on the top. Refer to the 2^{nd} paragraph of §4 Illumination). The nice quality of the images is a prerequisite for accurate monitoring.

FIG. 4.10-2 shows variations in which the light director/blocker direct light coming from an oblique or horizontal direction, and the camera would consequently be placed at a location and have an orientation so that it views the drip chamber from a perspective so that less amount of drip chamber reflection is seen, and/or the images of the drip(s) be clearer. There is also no restriction on whether the camera and the light director/blocker should be on the same side of the drip chamber or not. The defining characteristic is always “Projecting light from a direction so that less reflection/brightness contrast would be seen from the viewpoint of the viewing system.”

In FIG. 4.10-3, we show that the light director/blocker also does not have to extend all the way from part of (or near) the drip chamber to part of (or near) the light source. It can be placed close to either side of them, or more than one light directors/blockers be placed both near/around the light source and near/around the drip chamber without being connected together. The light director(s)/blocker(s) can also be integrated:
1. As part of the fixture, chamber, or holder for the drip chamber.
2. With the light, so that it effectively works like a torch in which outgoing rays are already guided.

And just as we have shown in FIG. 4.10-1 and FIG. 4.10-3, for unconnected light director/blocker that does not cover the whole path from the light source to drip chamber, and for light director/blocker integrated with {fixture, chamber, holder} of drip chamber or the light source, there is also no strict requirement on whether the light projects from the top or not. As long as the camera can avoid seeing the reflection while seeing clearly the image of the monitoring area, the configuration would always be valid.

Summary

| | Increasing the | Cancelling the | | |
|---|---|---|---|---|
| | distance between the | effect using | Avoid seeing | |
| | light source and the | multiple light | reflection from the | |
| Method/Principle | drip chamber | sources | viewing system | Other |
| Multiple light sources | | ✓ | | |
| Light tube/optical fiber | | | | of its own |
| Multiple light sources | | ✓ | | |
| via light tube/optical | | | | |
| fiber | | | | |
| Mirror reflection | ✓ | ✓ | | |
| Magnified light source | ✓ | ✓ | | |
| from lens | | | | |
| Reflective Surface | ✓ | ✓ | | parallel rays |
| | | | | (parabola/ |
| | | | | paraboloid) |
| Arrange light | | | ✓ | |
| direction/camera so | | | | |
| reflections are not seen | | | | |

Methods that how reflection/brightness contrast can be reduced or avoided in the image capturing device have been summarized in the above table for reference.

I claim:

1. A device using any video/image processing technique(s) to extract a periodical signal from IV dripping process and any frequency estimation techniques to measure the speed the dripping.

2. A device of claim 1 which uses any image enhancement techniques to enhance the image, which includes but not limited to any of the following methods in any combination for any number of times in any order:
(1) Gray-level transformation, which includes but not limited to:
a. Power-law transformation
b. Exponentiation transformation
c. Piece-wise linear transformation
d. Look-up table
and other methods of gray-level transformation.
(2) Frequency-domain techniques, which includes but not limited to:
a. Frequency domain equivalents of spatial-domain filters.
b. Filters devised directly in the frequency.
(3) Wavelet methods for image enhancement.

3. A device of claim 1 which uses thresholding methods to convert gray-level images into binary images, which includes but not limited to any of the following methods in any combination for any number of times in any order:
(1) Iterative methods
(2) An arbitrarily picked value for thresholding
(3) A manually determined value for thresholding
(4) The average of pixel values of an area for thresholding
(5) The median of pixel values of an area for thresholding.
(6) Other methods for thresholding.

4. A device of claim 1 which uses a frequency estimation technique to determine dripping speed from a signal obtained via image processing, which includes but not limited to any of the following methods in any combination for any number of times in any order:

5. A device of claim 4 which uses non-parametric methods for frequency estimation, which includes but not limited to any of the following methods in any combination for any number of times in any order:
(1) Naïve time-domain methods, which includes but not limited to:
a. Finding and counting value crossing, value thresholding, zero crossing or zero value detection
b. Finding and counting local maxima/minima
(2) Time-domain statistical methods, which includes but not limited to:
a. Biased or unbiased auto-correlation for frequency estimation.
b. Biased or unbiased auto-covariance for frequency estimation.
c. Biased or unbiased Average Magnitude Differential Function (AMDF).
(3) Fourier or Fourier-related methods, which includes but not limited to:
a. Periodogram
b. Bartlett's periodogram averaging
c. Discrete-time Fourier Transform (DTFT)
d. Correlogram or periodogram of auto-correlation
e. DTFT or periodogram of auto-covariance
f. Discrete Cosine Transform (DCT)
g. Discrete Sine Transform (DST)
(4) Wavelet methods

6. A device of claim 4 which uses parametric methods for frequency estimation, which includes but not limited to any of the following methods in any combination for any number of times in any order:
(1) Auto-regressive or Auto-regressive Mean-average Spectrum Estimation, which includes but not limited to:
a. Yule-Walker method
(2) Eigenvector/Subspace method or any method which estimates the frequency from the pseudospectrum of the signal, which includes but not limited to:
a. Pisarenko Harmonic Decomposition method
b. Multiple Emitter Location and Signal Parameter Estimation (MUSIC)

7. A mechanical apparatus which controls the speed of IV dripping by changing the thickness or diameter of the IV tube according to the IV dripping speed measured by a video/image processing based monitoring device.

8. An apparatus of claim 7 which uses a tube presser and supporter combination of any shape and material to compress or release the tube so that its speed can be controlled.

9. An apparatus of claim 7 which uses leadscrew in any part, for any number of times, in any combination with other components or by itself for converting rotary movement into linear.

10. An apparatus of claim 7 which uses component(s) of a single type or combination of component(s) of different types to guide the motion of one or more linearly moving parts. Its purpose might include to prevent, reduce or control off-axis motion of the linearly moving parts. And it might include but not limited to the following parts:
(1) Key/keyway combination.
(2) Spline/groove combination.
(3) Bearing on inner or outside or other places of the linearly part.

11. An apparatus of claim 7 which uses lever in any part, for any number of times, in any combination with other components or by itself for purposes might include but not limited to:
(1) Enhance the precision of movement
(2) Magnify force
(3) translate the motion of one part(s) into motion of another part(s)

12. An apparatus of claim 7 which uses a part or parts having absolute or relative rotational movement considered regarding any reference points, either simultaneously with other movement or not. to compress or release the IV tube.

13. An apparatus of claim 12 which has
(1) A pivoted end about one or more parts can rotate.
(2) An opening area that the part of the IV tube could pass through, and the change of the area due to the sweeping motion caused by the relative movement of one or more moving part(s) in sub-claim a and static part(s) or between moving parts results in the compressing or releasing of the IV tube.

14. An apparatus of claim 13 which has a groove, cut or opening, which may or may not have a uniform width, on one or more of its movable parts, and such groove(s), cut(s) or opening(s) may or may not be connected with a linearly moving part or parts at any location in geometric configuration so that the linearly moving part or parts' rotation might be converted to rotational part or parts' (as defined in claim 13) rotation, and that the apparatus might have at the connecting area of the rotational and linearly parts one or more of:
(1) A sphere or any component of spherical shape connected with the linearly moving parts and fitted into the groove, cut or opening.
(2) A cylinder or any component of cylindrical shape connected with the linearly moving parts and fitted into the groove, cut or opening.
(3) One or more bearings
(4) Any component which has at least one of its numerous cross-sections assuming a rounded shape or having circular circumference.

15. An apparatus of claim 13 in which the rotation of one or more parts is imparted by another component which also rotates, which may or may not have a fixed axis and may or may not simultaneously having another movement, and the apparatus might either or both
(1) Use gear(s) to impart rotation to the pivoted part(s).
(2) Use a rotational motor to impart rotation to the pivoted part(s)

16. An apparatus of claim 7 in which a cam or cams are used in one or more parts of the system to either translate linear motion into rotary or vice versa for other components, or to press the IV tube directly with edge of the cam, and that
(1) The moving-bearing (which connects with a linearly moving part) part of the cam might assume, in some or more parts, the shape of spiral, including but not limited to, Archimedean spiral.
(2) The cam might have a groove, or cut or opening to which the linearly moving part connects with a component, and such a connecting component might assume a shape which has at least in one of its numerous cross-sections a rounded shape or circular circumference and in this case the groove might, but not, to assume the shape of the envelope of such connecting component moving along a certain curve.

17. An illumination system which illuminates the drip chamber so that clear image can be taken for an video/image processing based IV monitoring system. It might uses either or both of two principles
(1) Using one or combinations of optical device to create an effect such that if light were coming from a distance to the drip chamber farther than the original light source.
(2) Using one or combinations of optical device to create an effect such reflection(s) and uneven brightness on the drip chamber are cancelled because light emitting from idealized point sources on the original light source appear to have coming from point sources that are more separate than their actual origins were.
to reduce or eliminate reflection(s)/brightness contrast in the image.

18. An illumination system of claim 17 which uses methods include but not limited to, in single, multiple or combination:
(1) Multiple light sources, either relatively separated, close, or separated, either surrounding or partially surrounding the drip chamber or not, either consist of individual light sources or a packaged light source containing multiple light-emitting elements.
(2) Multiple light sources directed via a single light source, or one or more single containing multiple light-emitting elements, via either light tube(s), light pipe(s), integrator bar(s) or optical fiber(s), or bundle(s) of them.
(3) Mirror, or a combination of mirrors, either flat, arbitrarily curved or assuming particular geometric shape, through it or them light of the original light source(s) is directed.
(4) Lens or lens', whose surfaces can be of any shape, either thin or thick, or a combination of lens constitute an optical system(s), which has a positive focal length (for thin lens) or positive effective focal length (for thick lens or optical system), to create a magnified image or images of the original light source, either farther or nearer from the drip chamber than the original light source.
(5) A light blocker which either can be made/integrated as part of the light source to prevent it from scattering light to all directions, or separate from the light source, and a surface of any level of smoothness which illuminates the drip chamber so that there is no or only weak reflection/brightness contrast. The shape of the surface might include, but not limited to:
a. Ellipse or ellipsoid
b. Parabola or paraboloid
c. Hyperboloid or hyperbola
d. Or a shape formed by a sweeping motion of any of the sub-claims (a), (b) and (c) above.

19. An illumination system of claim 17 arranged with an image capturing device in a configuration such that less reflection/brightness contrast would be seen from the viewpoint of the image capturing device. It might include, in single or multiple, but not limited to, the following:
(1) Light director/blocker extending between the light source and the drip chamber, either covering a part of the light source or drip chamber or not, so that light would illuminate the drip chamber from a direction which would result in less reflection/brightness contrast in an image capturing device.
(2) Light director/blocker does not extend between the light source and the drip chamber, but only extend beyond and/or cover either or both of part(s) of light source or drip chamber, so that light would illuminate the drip chamber from a direction which would result in less reflection/brightness contrast in an image capturing device.
(3) Light director/blocker of sub-claims (1) and (2) that is integrated
a. As part of the fixture, chamber, or holder for the drip chamber.
b. With the light, so that it effectively works like a torch in which outgoing rays are already guided.
